(19) United States
(12) Patent Application Publication
(10) Pub. No.: US 2024/0023760 A1
(43) Pub. Date: Jan. 25, 2024

(54) FRUIT AND VEGETABLE WASHING APPARATUS

(71) Applicant: CIXI BOSHENG PLASTIC CO., LTD., Cixi (CN)

(72) Inventor: Zhiyong HUANG, Cixi (CN)

(73) Assignee: CIXI BOSHENG PLASTIC CO., LTD., Cixi (CN)

(21) Appl. No.: 18/355,624

(22) Filed: Jul. 20, 2023

Related U.S. Application Data
(63) Continuation of application No. PCT/CN2022/086379, filed on Apr. 12, 2022.

(30) Foreign Application Priority Data
Jul. 8, 2021 (CN) 202110773464.6
Jul. 8, 2021 (CN) 202110773466.5
Jul. 8, 2021 (CN) 202121548199.3
Jul. 8, 2021 (CN) 202121548731.1
Jul. 8, 2021 (CN) 202121548738.3
Jul. 8, 2021 (CN) 202121548764.6
Nov. 17, 2021 (CN) 202111364143.7
Nov. 17, 2021 (CN) 202111364840.2
Nov. 17, 2021 (CN) 202122819452.0
Nov. 17, 2021 (CN) 202122819453.5
Nov. 17, 2021 (CN) 202122820583.0
Nov. 17, 2021 (CN) 202122820587.9
Nov. 17, 2021 (CN) 202122820588.3
Jan. 11, 2022 (CN) 202220057192.X
Jan. 11, 2022 (CN) 202220057202.X
Jan. 11, 2022 (CN) 202220057433.0

(51) Int. Cl. A47J 43/24

(52) U.S. Cl. CPC A47J 43/24

(57) ABSTRACT

A fruit and vegetable washing apparatus, including a container, a circulation-driving mechanism, and a scrubber; the container is formed with a circulation passage, the circulation passage including a fruits/vegetables flowing and staging zone and a brush washing zone, where on washing fruits/vegetables, the circulation passage provides a passageway for wash water and the fruits/vegetables to circulate between the fruits/vegetables flowing and staging zone and the brush washing zone; the scrubber is disposed in the brush washing zone, such that on washing the fruits/vegetables, the scrubber brushes the passing fruits/vegetables; the circulation-driving mechanism is configured to provide a driving force which, on washing the fruits/vegetables, drives the wash water and the fruits/vegetables to circulate in the circulation passage, the fruits/vegetables being brushed when sequentially passing through the brush washing zone, with a better cleaning effect achieved.

### FIELD

The disclosure relates to a fruit and vegetable washing apparatus for cleaning fruits and vegetables.

### BACKGROUND

The Chinese Patent No. CN209219203U discloses a household fruit washing apparatus, comprising a washing chamber for holding fruits, where a rotary shaft is transversely arranged in the washing chamber, and a strip brush is provided on the rotary shaft. The washing apparatus is operated by feeding to-be-washed fruits, as well as wash water, into the washing chamber and turning the crank by hand to bring a rotary shaft to rotate, where rotation of the rotary shaft drives a bristle brush which is a brush strip to rotate, causing the fruits to tumble in the water, whereby surfaces of the fruits being brushed by bristles of the brush. This invention has the following drawbacks: when the bristle brush is rotating in the washing chamber, the fruits tend to gather closer to wall surfaces of the washing chamber with water flow due to the action of centrifugal force arising from spinning of the bristle brush, where fruits with a higher density (than water) would sink to bottom edges of the washing chamber, while fruits with a lower density (than water) would float to water surface edges of the washing chamber; as such, most of the fruits would be spun away from the bristle brush and only a small portion of the fruits can access the bristle brush to be brushed; therefore, this household fruit washing apparatus fail to give uniform fruit cleaning; particularly in case of only a small amount of fruits to be washed, even no fruits can access the rotating bristle brush so as be washed, rendering an undesired cleaning effect; in addition, the fruit washing capacity of this household fruit washing apparatus is limited; to wash more fruits, the volume of the washing chamber, as well as the size of the bristle brush, needs to increase accordingly.

The Chinese Patent No. CN104287650A discloses a fruit washing basket, comprising: a loading chamber and a agitating cleaning device, where the agitating brushing device comprises a handle, a U-shaped connecting rod, and a cleaning roller. The washing basket is operated by feeding clean water into the loading chamber, feeding to-be-washed fruits into the loading chamber, and turning the handle such that the cleaning roller can continuously agitate the to-be-washed fruits, whereby the bristles on the upper portion of the cleaning roller can remove the dirt and residual pesticides on the surface of the fruits. The patent has the following drawbacks: in the agitating brushing device, the transversely disposed cleaning roller can only agitate/stir the fruits in its spinning course along an arc trajectory, such that the fruits tend to gather at edges and corners of the agitating brushing device, a consequence of which is that the fruits are cleaned in a chaotic way; in addition, for fruits with a higher density (than water) and a larger size, agitating of the cleaning roller easily causes collision between the fruits, while for fruits with a higher density (than water) and a smaller size, most of the fruits at the bottom of the agitating brushing device cannot be agitated, resulting in a poor cleaning effect. Meanwhile, the amount of fruit that can be held in the agitating brushing device is limited; to wash more fruits, the capacity of the corresponding agitating brushing device, as well as the size of the cleaning roller, needs to increase accordingly.

The Chinese Patent No. CN204104777U discloses a fruit and vegetable cleaning barrel, comprising a washing tub and a rotary cleaning device, where an upward-extending recess is provided in the middle portion of the washing tub along the center line direction of the washing tub; the rotary cleaning device comprises a handle bar, a U-shaped connecting rod, and a longitudinally disposed cleaning roller; the handle bar being disposed above the barrel lid and fixed to one end of the connecting rod, the cleaning roller being fixed to the other end of the connecting rod; the cleaning roller comprises a rolling shaft and a rolling brush. The cleaning barrel is operated by feeding clean water into the washing tub, feeding to-be-washed fruits in the washing tub, and agitating the rotary cleaning device, such that the cleaning roller can continuously agitate the to-be-washed fruits, whereby the bristles on the upper portion of the cleaning roller can remove the dirt and residual pesticides on the surface of the fruits. Compared with the fruit washing basket disclosed by CN104287650A, the '777 patent only solves the drawback that the fruits tend to gather at the edges and corners of the agitating brushing device, but the drawback of brushing the fruits chaotically is still left unsolved; in addition, provision of the recess increases the risk of collision between the fruits; and when cleaning fruits with a relatively large size, the cleaning roller is easily stuck by the fruits.

The Chinese Patent Nos. CN105795492A, CN107280525A, CN108576866A, and CN108813658A all disclose a fruit washing apparatus, comprising a container for holding fruits, and a bristle brush vertically disposed in the container. The fruit washing apparatus is operated by feeding fruits into the container, filling water is into the container, and actuating the bristle brush to auto-rotate or rotate along a circumferential direction of the container (CN108813658A), resulting in a spiraling vortex in the container, where the fruits tumble spirally with the vortex in the container, such that the fruits in relative motion are brushed the bristle brush. These patents have the following drawbacks: since the spiraling vortex is generated by auto-rotation or circumferential rotation of the bristle brush, the fruits in the vortex have a substantially same angular speed as that of rotation of the bristle brush, such that the relative motion between the bristle brush and the fruits is relatively small, and the bristle brush has a very limited effect in fruit cleaning; in other words, the bristle brush, the water, and the fruits will rotate synchronously in the container, such that the bristle brush substantially has no effect in cleaning the fruits. In addition, due to the action of centrifugal force, most of the fruits in the vortex tend to be spun to sidewalls of the container, and only a small portion of the fruits can access the bristle brush so as to be brushed, thereby the cleaning effect is unsatisfactory. In addition, the fruit holding capacity of the container disclosed therein is limited; so, to clean more fruits, the capacity of the container, as well as the size of the bristle brush, needs to increase accordingly.

The Chinese Patent No. CN209058078U discloses a fruit product cleaning apparatus; compared with the patent CN108813658A, the '078 patent can scrub the fruits in relative motion via rotation of a bristle brush-mounted agitating shaft; however, its structure is complex; in addition, it is only power-driven and cannot be manually manipulated; furthermore, fruits are stilled cleaned in a chaotic way.

In view of the above, conventional fruit washing apparatuses have the following drawbacks:
(1) the fruits are cleaned in a non-uniform, chaotic way, such that uniform brushing of the fruits cannot be achieved;
(2) The capacity of the container where the fruits are washed is limited; to wash more fruits, the capacity of the container, as well as the size of the bristle brush or cleaning roller, needs to increase accordingly.

### SUMMARY

To overcome the above and other drawbacks of conventional fruit and vegetable washing apparatuses, the present disclosure provides a fruit and vegetable washing apparatus with a better cleaning effect.

The technical solution adopted for solving the technical problems is summarized below:
A fruit and vegetable washing apparatus, comprising a container, a circulation-driving mechanism, and a scrubber;
wherein the container has a circulation passage formed therein, the circulation passage comprising a fruits/vegetables flowing and staging zone and a brush washing zone, wherein on washing fruits/vegetables, the circulation passage provides a passageway for wash water and the fruits/vegetables to circulate between the fruits/vegetables flowing and staging zone and the brush washing zone;
wherein the scrubber is disposed in the brush washing zone, such that on washing the fruits/vegetables, the scrubber brushes the fruits/vegetables passing through the brush washing zone;
and wherein the circulation-driving mechanism is configured to provide a driving force which, on washing the fruits/vegetables, drives the wash water and the fruits/vegetables to circulate in the circulation passage, whereby the fruits/vegetables are brushed when sequentially passing through the brush washing zone.

Preferably, the fruit and vegetable washing apparatus further comprises a baffle part, wherein the baffle part is disposed in the container, and the circulation passage surrounds the baffle part.

A structural form of the circulation-driving mechanism is such that the circulation-driving mechanism comprises a rotating impeller or a water pump. In this case, the scrubber comprises a brushing element disposed in the container, and a spatial area where the brushing element occupies and a corresponding spatial area in the container constitute the brush washing zone of the container.

A structural form of the circulation-driving mechanism is such that the scrubber is rotatably disposed in the container, the scrubber serving as the circulation-driving mechanism; wherein the scrubber comprises a scrubber rotary shaft and a brushing portion disposed on the scrubber rotary shaft, the brushing portion extending towards a direction away from the scrubber rotary shaft, the scrubber rotary shaft being connected to a drive mechanism driving the scrubber rotary shaft to rotate.

Preferably, the scrubber is proximal to one end or one side of the container so as to facilitate circulation formulation of the wash water and circulation formulation of the fruits/vegetables.

A manner of disposing the scrubber is such that the scrubber is disposed on the container with the scrubber rotary shaft being transversely disposed.

Furthermore, the fruit and vegetable washing apparatus further comprises a baffle part, the baffle part being disposed in the container, the circulation passage surrounding the baffle part; wherein one end of the scrubber rotary shaft is propped up on the baffle part, and the other end of the scrubber rotary shaft is propped up a sidewall of the container.

Another manner of disposing the scrubber is such that the scrubber is disposed on the container with the scrubber rotary shaft being vertically disposed.

Furthermore, a supporting mechanism for supporting the drive mechanism is provided on the container.

Furthermore, the drive mechanism is a crank handle, the crank handle comprising a handle body and a grip disposed on the handle body, a connecting portion being provided on the handle body, the connecting portion being connected to the scrubber rotary shaft, the drive mechanism driving, via the connecting portion on the handle body, the scrubber rotary shaft to rotate.

Furthermore, the scrubber rotary shaft, after being connected to the drive mechanism, is suspended on the supporting mechanism. Or, a support shaft is provided in the container, the scrubber rotary shaft being sleeved outside the support shaft, the scrubber rotary shaft being supported on the support shaft.

Furthermore, a ball body is provided between the support shaft and the scrubber rotary shaft.

Preferably, a gap is formed between a portion of the handle body other than the connecting portion and the supporting mechanism.

The disclosure offers the following benefits: driven by the circulation-driving mechanism, the fruits/vegetables may circulate in the circulation passage comprising the brush washing zone and the fruits/vegetables flowing and staging zone, where the fruits/vegetables enter the brush washing zone from the fruits/vegetables flowing and staging zone sequentially (one by one or batch by batch), such that the scrubber can brush all fruits/vegetables in the circulation passage repeatedly, yielding an orderly, uniform cleaning effect, without unbrushed fruits/vegetables or unthoroughly brushed fruits/vegetables.

### BRIEF DESCRIPTION OF THE DRAWINGS

FIG. 1 is a structural schematic diagram of the disclosure according to a first example embodiment.

FIG. 2 is a structural schematic diagram of the fruit and vegetable washing apparatus in FIG. 1 from another perspective.

FIG. 3 is a structural schematic diagram of another structural form of the disclosure in the first example embodiment.

FIG. 4 is a structural schematic diagram of the fruit and vegetable washing apparatus in FIG. 3 from another perspective.

FIG. 5 is a structural schematic diagram of the disclosure according to a second example embodiment.

FIG. 6 is an internal structure diagram of the disclosure according to the second example embodiment.

FIG. 7 is a structural schematic diagram of a fruit and vegetable washing apparatus, where multiple rows of scrubber rotary shafts are transversely disposed.

FIG. 8 is a schematic diagram of transmission between the multiple rows of scrubbers in FIG. 7.

FIG. 9 is a structural schematic diagram of a fruit and vegetable washing apparatus, where two scrubbers with transversely disposed scrubber rotary shafts are arranged to face each other.

FIG. 10 is a structural schematic diagram of the disclosure, where the scrubber rotary shaft is diagonally disposed.

FIG. 11 is a schematic driving diagram of the scrubber rotary shaft when the scrubber rotary shaft is diagonally disposed.

FIG. 12 is another schematic driving diagram of the scrubber rotary shaft when the scrubber rotary shaft is diagonally disposed.

FIG. 13 is a schematic mounting diagram of the scrubber rotary shaft.

FIG. 14 is a structural schematic diagram after the scrubber of FIG. 13 is removed.

FIG. 15 is an exploded view of a detachable connection manner between a manual drive mechanism and the scrubber rotary shaft.

FIG. 16 is a structural schematic diagram of a gear in FIG. 15.

FIG. 17 is structural schematic diagram of an alternative detachable connection manner between the manual drive mechanism and the scrubber rotary shaft.

FIG. 18 is an exploded view of FIG. 17.

FIG. 19 is an exploded view of FIG. 17 from another perspective.

FIG. 20 is a structural schematic diagram of another detachable connection manner between the manual drive mechanism and the scrubber rotary shaft.

FIG. 21 is a schematic diagram of a connecting manner between the manual drive mechanism and the scrubber rotary shaft in FIG. 20.

FIG. 22 is a structural schematic diagram of the scrubber of one structural form.

FIG. 23 is a structural schematic diagram of the scrubber of another structural form.

FIG. 24 is a structural schematic diagram of the scrubber of a further structural form.

FIG. 25 is a structural schematic diagram of the scrubber of a still further structural form.

FIG. 26 is a structural schematic diagram of the scrubber of a yet further structural form.

FIG. 27 is a distribution diagram of a wiper part.

FIG. 28 is a distribution diagram of an alternative wiper part.

FIG. 29 is a distribution diagram of an alternative wiper part.

FIG. 30 is a distribution diagram of an alternative wiper part.

FIG. 31 is a distribution diagram of an alternative wiper part.

FIG. 32 is a distribution diagram of an alternative wiper part.

FIG. 33 is a distribution diagram of an alternative wiper part.

FIG. 34 is a distribution diagram of an alternative wiper part.

FIG. 35 is a distribution diagram of an alternative wiper part.

FIG. 36 is a distribution diagram of an alternative wiper part.

FIG. 37 is a distribution diagram of an alternative wiper part.

FIG. 38 is a distribution diagram of an alternative wiper part.

FIG. 39 is a sectional view of a container.

FIG. 40 is schematic diagram of a connecting manner between a baffle part and the container.

FIG. 41 is a structural schematic diagram of the baffle part of FIG. 40.

FIG. 42 is a schematic diagram of an alternative connecting manner between the barrier and the container.

FIG. 43 is an exploded view of a connecting manner between the baffle part and the container.

FIG. 44 is a bottom view of FIG. 43.

FIG. 45 is a structural schematic diagram when the baffle part is provided on an anti-splash cover.

FIG. 46 is a structural schematic diagram where one end of the scrubber rotary shaft is not connected to the baffle part.

FIG. 47 is a structural schematic diagram where the anti-splash cover closes the upper end of the container.

FIG. 48 is a sectional view of the container where an anti-splash cover is provided.

FIG. 49 is a structural schematic diagram where a seal ring is provided between the anti-splash cover and the upper end of the container.

FIG. 50 is a structural schematic diagram where a water discharge port is provided on the container.

FIG. 51 is a structural schematic diagram of the disclosure where a drain basket is provided.

FIG. 52 is a mounting schematic diagram of the crank handle and the scrubber.

FIG. 53 is a structural schematic diagram where the shaft sleeve in FIG. 52 is removed.

FIG. 54 is an exploded view of FIG. 53.

FIG. 55 is an exploded view of FIG. 53 from another perspective.

FIG. 56 is a sectional view of the crank handle and the scrubber in FIG. 53.

FIG. 57 is a stereoscopic view of the crank handle and the scrubber in FIG. 53.

FIG. 58 is a stereoscopic view of the crank handle and the brushing when another type of driven gear is adopted.

FIG. 59 is a sectional view of FIG. 58.

FIG. 60 is a structural schematic diagram of the shaft sleeve.

FIG. 61 is a structural schematic diagram where drain holes are provided in the container according to a second example embodiment.

FIG. 62 is a structural schematic diagram of a fruit and vegetable washing apparatus according to a third example embodiment.

FIG. 63 is a sectional view of FIG. 62.

FIG. 64 is an exploded view of FIG. 62.

FIG. 65 is an exploded view of FIG. 62 from another perspective.

FIG. 66 is an exploded view of the scrubber in FIG. 62.

FIG. 67 is an exploded view of the scrubber in FIG. 62 from another perspective.

FIG. 68 is a schematic diagram of an alternative structural form of the fruit and vegetable washing apparatus according to the third example embodiment.

FIG. 69 is a sectional view of FIG. 68.

FIG. 70 is an exploded view of FIG. 68.

FIG. 71 is a schematic diagram of an alternative structural form of the fruit and vegetable washing apparatus according to the third example embodiment.

FIG. 72 is a sectional view of FIG. 71.

FIG. 73 is an exploded view of FIG. 71.

FIG. 74 is a structural schematic diagram of the fruit and vegetable washing apparatus having a baffle part of an alternative form according to the third example embodiment.

FIG. 75 is a schematic diagram of one structural form of a baffle part.

FIG. 76 is a structural schematic diagram where the anti-splash cover closes the container.

FIG. 77 is a structural schematic diagram of an alternative type of scrubber.

FIG. 78 is an internal schematic diagram of the container of the fruit and vegetable washing apparatus having a baffle part according to the third example embodiment.

FIG. 79 is an internal schematic diagram of the container of the fruit and vegetable washing apparatus without a baffle part according to the third example embodiment.

FIG. 80 is an internal schematic diagram of the container of the fruit and vegetable washing apparatus having a wiper part according to the third example embodiment.

FIG. 81 is an internal schematic diagram of the container of the fruit and vegetable washing apparatus having an alternative type of wiper part according to the third example embodiment.

FIG. 82 is a sectional view of the fruit and vegetable washing apparatus provided with a plane bearing according to the third example embodiment.

FIG. 83 is local enlarged view of part A in FIG. 82.

FIG. 84 is a sectional view of the disclosure where two plane bearings are provided.

FIG. 85 is a local enlarged view of part B in FIG. 84.

FIG. 86 is a fitting state diagram between the container and the drain basket of one shape.

FIG. 87 is a fitting state diagram between the container and the drain basket of an alternative shape.

FIG. 88 is a fitting state diagram between the container and the drain basket of an alternative shape.

FIG. 89 is a fitting schematic diagram between a perforated drain basket fitted with a rotary shaft and the container.

FIG. 90 is a fitting schematic diagram between a perforated drain basket not fitted with the rotary shaft or the baffle part and the container.

FIG. 91 is a fitting schematic diagram between a perforated drain basket fitted with the baffle part and the container.

FIG. 92 is a fitting schematic diagram between the perforated drain basket provided with a partition part and the container.

FIG. 93 is a mounting schematic diagram of the wiper part.

FIG. 94 is another mounting schematic diagram of the wiper part.

FIG. 95 is a structural schematic diagram where the rotary shaft is suspended on a supporting mechanism.

FIG. 96 is a connecting structural diagram between the rotary shaft and the supporting member where the rotary shaft is suspended on the bearing mechanism.

FIG. 97 is a bottom view of FIG. 96.

FIG. 98 is another structural schematic diagram of connecting the rotary shaft and the supporting member when the rotary shaft is suspended on the bearing mechanism.

FIG. 99 is a sectional view of the disclosure where the scrubber is adjustably movable away from or closer to a sidewall of the container.

FIG. 100 is a structural schematic diagram of the anti-splash cover in FIG. 99.

FIG. 101 is a schematic diagram of the brush washing zone and an internal circulation region.

FIG. 102 is a status schematic diagram where the anti-splash cover is disposed in the container.

FIG. 103 is a structural schematic diagram where the container of the fruit and vegetable washing apparatus in the third example embodiment of the disclosure is provided with drain holes.

FIG. 104 is a structural schematic diagram of the fruit and vegetable washing apparatus according to a fourth example embodiment.

FIG. 105 is a sectional view of one structure of the fruit and vegetable washing apparatus in the fourth example embodiment.

FIG. 106 is a structural schematic diagram of an alternative structural form of the fruit and vegetable washing apparatus according to the fourth example embodiment.

FIG. 107 is a sectional view of FIG. 106.

FIG. 108 is a structural schematic diagram of an alternative structural form of the fruit and vegetable washing apparatus according to the fourth example embodiment.

FIG. 109 is a sectional view of FIG. 108.

FIG. 110 is a sectional view of an alternative structural form of the fruit and vegetable washing apparatus according to the fourth example embodiment.

FIG. 111 is a mounting schematic diagram of a grip.

FIG. 112 is another mounting schematic diagram of the grip.

FIG. 113 is an exploded view of the fruit and vegetable washing apparatus with the grip mounted in the manner shown in FIG. 112.

FIG. 114 is a mounting schematic diagram of the grip.

FIG. 115 is a mounting schematic diagram of the handle.

FIG. 116 is an exploded view of the fruit and vegetable washing apparatus with the grip mounted in the manner shown in FIG. 115.

FIG. 117 is a mounting schematic diagram of the grip.

FIG. 118 is an exploded view of the fruit and vegetable washing apparatus with the grip mounted in the manner shown in FIG. 117.

FIG. 119 is an exploded view of a scrubber rotary shaft and a crank handle rotary shaft.

FIG. 120 is a structural schematic diagram of a fruit and vegetable washing apparatus according to a fifth example embodiment.

FIG. 121 is an internal structural view of the fruit and vegetable washing apparatus according to the fifth example embodiment.

FIG. 122 is a sectional view of the fruit and vegetable washing apparatus according to the fifth example embodiment.

FIG. 123 is a structural schematic diagram when the rotary shaft is supported by a support shaft.

FIG. 124 is a schematic exploded view of connecting between the rotary shaft and the shaft sleeve.

FIG. 125 is a schematic exploded view of connecting between the rotary shaft and the shaft sleeve from another perspective.

FIG. 126 is a structural schematic diagram where the rotary shaft is suspended on the supporting mechanism.

FIG. 127 is a structural schematic diagram of FIG. 126 from a bottom-view perspective.

FIG. 128 is another structural schematic diagram where the rotary shaft is suspended on the supporting mechanism.

FIG. 129 is a schematic diagram of the brush washing zone and the fruit and vegetable flowing and staging zone.

FIG. 130 is a structural schematic diagram of a container of another shape.

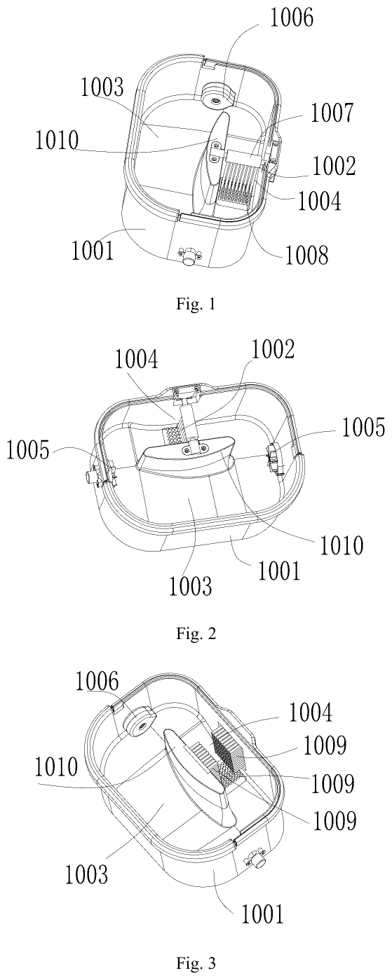

Among the drawings, FIGS. 1 to 4 are schematic diagrams of the first example embodiment, where the reference numerals for respective parts start from “1,” e.g., “1001, 1002 . . . ”;

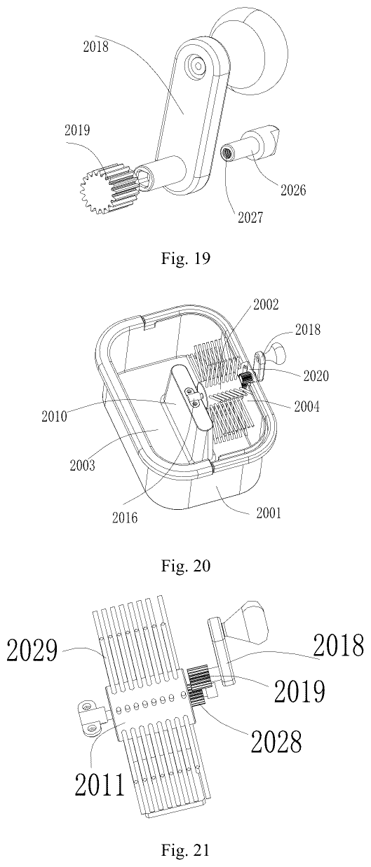

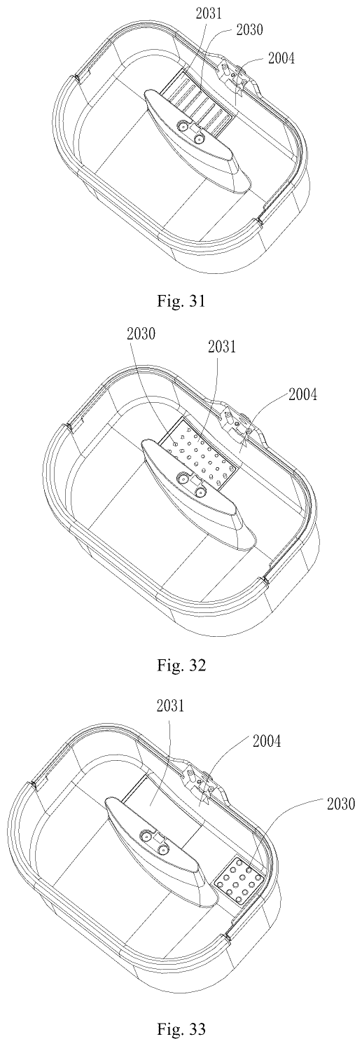

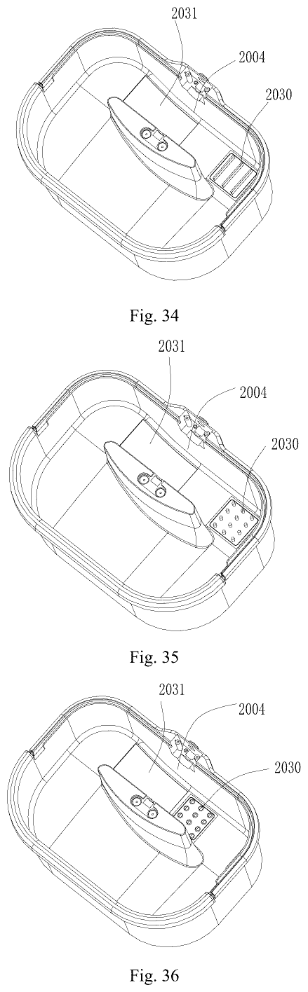

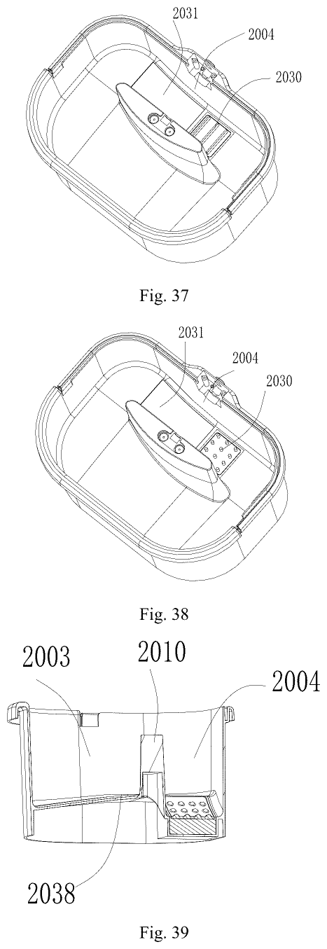

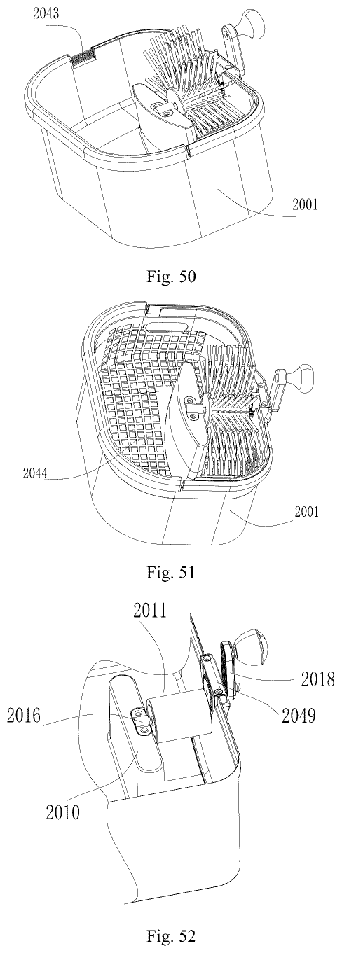

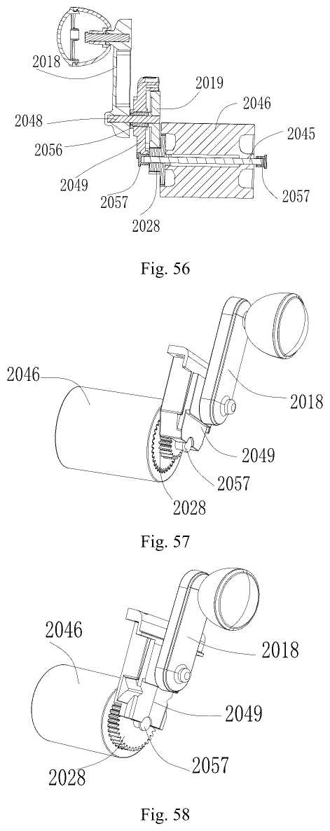

FIGS. 5 to 61 are schematic diagrams of the second example embodiment, where the reference numerals for respective parts start from “2,” e.g., “2001, 2002 . . . ”;

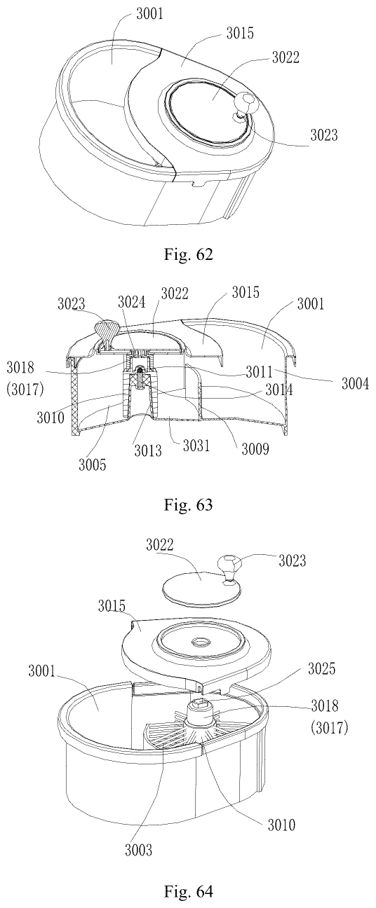

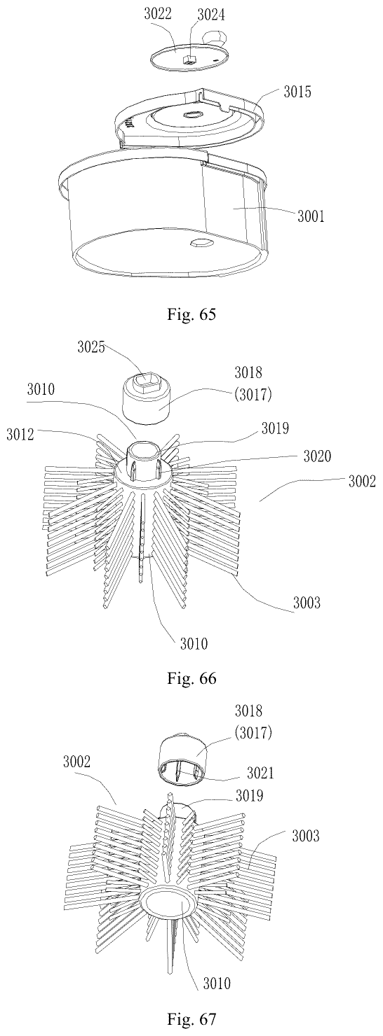

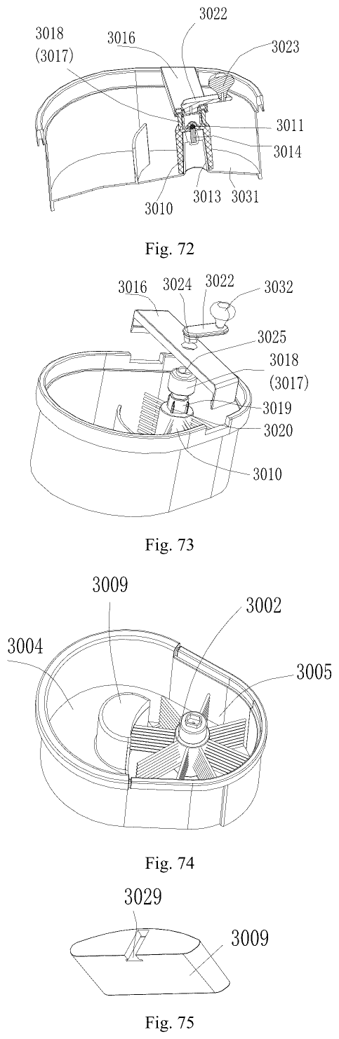

FIGS. 62 to 103 are schematic diagrams of the third example embodiment, where the reference numerals for respective parts start from “3,” e.g., “3001, 3002 . . . ”;

FIGS. 104 to 119 are schematic diagrams of the fourth example embodiment, where the reference numerals for respective parts start from “4,” e.g., “4001, 4002 . . . ”;

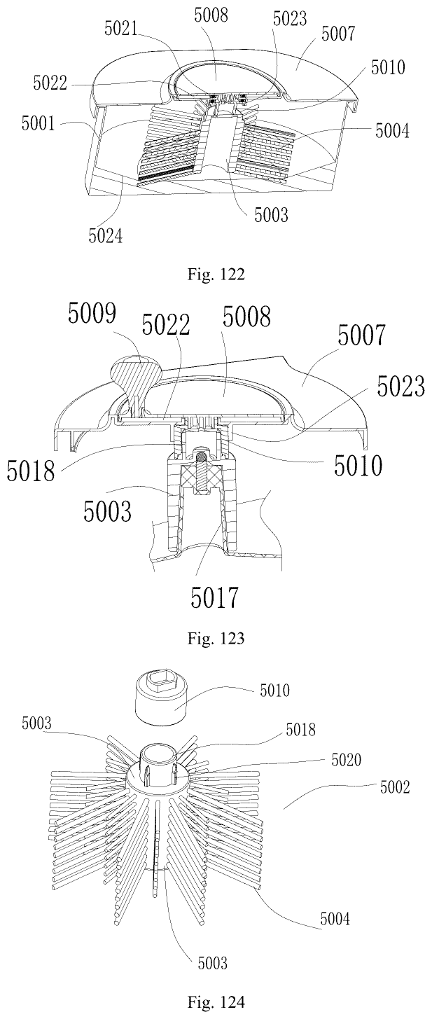

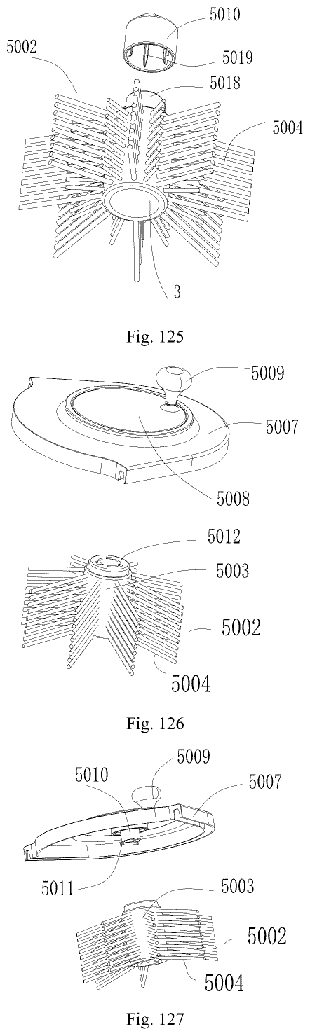

FIGS. 120 to 130 are schematic diagrams of the fifth example embodiment, where the reference numerals for respective parts start from “5,” e.g., “5001, 5002 . . . .”

### DETAILED DESCRIPTION

Embodiments of the disclosure provide a fruit and vegetable washing apparatus comprising a container, a circulation-driving mechanism, and a scrubber.

The container is configured to hold fruits/vegetables, which is generally a plastic ware. The container has a circulation passage formed therein, the circulation passage comprising a fruits/vegetables flowing and staging zone and a brush washing zone, where the scrubber is disposed in the brush washing zone; on washing the fruits/vegetables, the circulation passage can provide a passageway for wash water and the fruits/vegetables to circulate between the fruits/vegetables flowing and staging zone and the brush washing zone. The brush washing zone refers to an area where the fruits/vegetables are brush washed. The fruits/vegetables flowing and staging zone refers to an area for the fruits/vegetables to flow when they are circulating in the circulation passage, where most of cleaned fruits/vegetables are staged; in addition, on feeding the fruits/vegetables, since the scrubber occupies certain space of the brush washing zone, the to-be-washed fruits/vegetables are generally also fed from the fruits/vegetables staging zone.

Since the brush washing zone and the fruits/vegetables flowing and staging zone in the container of the disclosure are in communication, during the washing process, the to-be-washed fruits/vegetables are brush washed by the scrubber in the brush washing zone and flow with the wash water in the fruits/vegetables flowing and staging zone, without fierce agitations or severe collisions between the fruits/vegetables and/or between the fruits/vegetables and the container during the whole process. Since the fruits/vegetables are constantly circulating in the container throughout the whole washing process, the amount of the fruits/vegetables fed into the container should be appropriate based on the capacity of the fruits/vegetables flowing and staging zone, so long as they do not affect cleaning of the fruits/vegetables. In an example embodiment of the fruit and vegetable washing apparatus according to the disclosure, fruits/vegetables are generally fed into the fruits/vegetables flowing and staging zone; of course, it is also allowed to first feed part or all of the to-be-washed fruits/vegetables in the brush washing zone. On washing, the fruits/vegetables are carried by the wash water to flow from the fruits/vegetables flowing and staging zone to the brush washing zone, then return from the brush washing zone back to the fruits/vegetables flowing and staging zone, and again flow from the fruits/vegetables flowing and staging zone to the brush washing zone, whereby a circulation path featuring a journey from the brush washing zone to the fruits/vegetables flowing and staging zone, and then back into the brush washing zone and again to the fruits/vegetables flowing and staging zone is formed in the circulation passage. In an example embodiment of the disclosure, the fruits/vegetables are generally discharged from the fruits/vegetables flowing and staging zone without being obstructed by the scrubber disposed in the brush washing zone. Of course, in some example embodiment of the disclosure, the fruits/vegetables may also be discharged from the brush washing zone.

Optionally, a drain basket is provided in the container. On washing, the fruits/vegetables are held in the drain basket, and after the washing is complete, it is just needed to lift up the drain basket. It is preferable that the bottom of the drain basket substantially fits the bottom of the container to prevent spatial loss of the container. The “substantially fit” means the bottom of the drain basket can completely fit the bottom of the container or the gap therebetween is relatively narrow. To facilitate lifting up the drain basket, a notch is provided on the drain basket, the scrubber being disposed in the notch; in this way, all fruits/vegetables in the container may be substantially extracted. Of course, if the scrubber is detachably provided in the container, the notch is not necessarily provided; in this case, to extract the fruits/vegetables, it is only needed to remove the scrubber first.

The sidewalls and bottom of the drain basket form the outer contour of the circulation passage, ensuring that the resulting circulation passage may facilitate circulation of the wash water and the fruits/vegetables during operation; as such, the shape of the container may be designed flexibly, so long as it can accommodate the drain basket. The container may be designed with a plurality of possible shapes, i.e., the shape of the drain basket may not be adapted to that of the container, in which case the container may be designed with a larger volume to increase the amount of water held in the container. Of course, the shape of the drain basket may also be adapted to that of the container.

Optionally, the drain basket is completely disposed in the container; optionally, the upper edge of the drain basket covers the upper end of the container. Typically, the upper end of the drain basket has a flange, the flange being propped up on the upper end of the container.

Optionally, drain holes may be provided in the bottom and/or sidewalls of the container. In use, the container needs to be placed in a wash water holding receptacle, where the wash water (which may be water or other liquid, or a mixture of other substance and water) is filled into the wash water holding receptacle, the wash water entering the container via the drain holes, whereby the fruits/vegetables are submerged in the wash water. The shape of the wash water holding receptacle may be adapted to the container or not adapted to the container. Optionally, the wash water holding receptacle may be a typical household container such as a sink or a vegetable washing basin. Optionally, the wash water holding receptacle may also be an accessory mated to the container; in this case, the wash water holding receptacle is flexible in designing, i.e., it may be designed into various shapes, providing versatile designs of the fruit and vegetable washing apparatus to meet aesthetic appreciation of different users.

Optionally, no drain holes are provided in wall surfaces of the container. Of course, decorative holes, mounting holes, or a water discharge port, which do not affect the water holding function of the container, may be provided on a wall surface of the container; such holes/ports are also deemed as “no drain holes are provided in wall surfaces of the container.”

The circulation-driving mechanism is configured to provide a driving force which, when washing the fruits/vegetables, drives the wash water and the fruits/vegetables to circulate in the circulation passage, where the fruits/vegetables sequentially pass through the brush washing zone so as to be brushed by the scrubber.

On washing the fruits/vegetables, the fruits/vegetables may pass through the brush washing zone sequentially one by one, or batch by batch, i.e., a plurality of fruits/vegetables may pass together. Those skilled in the art will appreciate that a specific sequential passing manner is dependent on size and quantity of the fruits/vegetable, e.g., if the fruits/vegetables have a relatively large size, it is likely that the fruits/vegetables pass one by one; if the fruits/vegetables have a relatively small size, it is likely that a plurality of items of fruits/vegetables may pass together; of course, in the latter case, the fruits/vegetables may also pass one by one.

Driven by the circulation-driving mechanism, the wash water carries the fruits/vegetables to flow from the fruits/vegetables flowing and staging zone to the brush washing zone and then flow back from the brush washing zone to the fruits/vegetables flowing and staging zone, whereby a circulation path featuring a journey from the fruits/vegetables flowing and staging zone to the brush washing zone and then back from the brush washing zone again to the fruits/vegetables flowing and staging zone is formed in the circulation passage. While the fruits/vegetables carried by the wash water are flowing through the brush washing zone, the scrubber rubs the fruits/vegetables, whereby the fruits/vegetables are brushed; when the fruits/vegetables are submerged in the wash water in both of the brush washing zone and the fruits/vegetables flowing and staging zone, soaking of the fruits/vegetables in the wash water facilitates removal of the dirt on the fruit/vegetable surfaces. In the case that the fruits/vegetables flow at a speed different from that of the wash water, the fruit/vegetable surfaces may be flushed by the wash water. The fruits/vegetables may access the brush washing zone one by one or batch by batch (i.e., sequentially) from the fruits/vegetables flowing and staging zone, such that the scrubber brushes the fruits/vegetables sequentially, yielding a uniform, orderly, effective cleaning. The fruits/vegetables washed in the container experience a repeated, cyclical brushing procedure of first entering the brush washing zone for being brush washed, then flowing into the fruits/vegetable flowing and staging zone for being flushed, and then flowing back into the brush washing zone for being brush washed; during the washing process, brushing and flushing occur alternately such that the fruits/vegetables may not only be brushed, but also be flushed by the wash water. In addition, after being soaked and flushed, the residual dirt on the fruits/vegetables are more easily cleaned by the scrubber in the brush washing zone. The above benefits are achieved through cooperation of the following three features: the container having a fruits/vegetables flowing and staging zone and a brush washing zone which are in communication, the brush washing zone having a scrubber disposed therein, and the circulation-driving mechanism driving the wash water and the fruits/vegetables to flow and circulate in the circulation passage.

Optionally, the volume available for fruits/vegetables in the brush washing zone is smaller than that of the fruits/vegetables flowing and staging zone, such that more fruits/vegetables may be accommodated in the fruits/vegetables flowing and staging zone, and meanwhile the fruits/vegetables in the brush washing zone may also be controlled within a certain extent, which ensures that the fruits/vegetables pass smoothly through the brush washing zone while preventing jam caused by excessive fruits/vegetables passing through the brush washing zone. Of course, the volume available for fruits/vegetables in the brush washing zone may be substantially equal to, or even greater than, that of the fruits/vegetables flowing and staging zone. The “volume available for fruits/vegetables in the brush washing zone” here refers to the volume of fruits/vegetables accommodatable in the brush washing zone under a normal washing circumstance, i.e., the volume of the brush washing zone after deducting the space occupied by the scrubber.

Optionally, the corners of the container are arcuately chamfered. Spiked corners of the container would cause difficulty in cleaning dirt buildup there. In addition, the arcuately chamfered corners unlikely cause damages to the fruits/vegetables flowing with the wash water. Moreover, smooth flowing of the circulating wash water along the arcuately chamfered corners also achieves less loss of kinetic energy.

Optionally, the bottom surface of the fruits/vegetables flowing and staging zone is provided with a slope, such that when the fruits/vegetables flow out of the brush washing zone into the fruits/vegetables flowing and staging zone, they flow from the higher portion of the slope towards the lower portion of the slope, whereby flowing of the fruits/vegetables is accelerated to prevent the fruits/vegetables from being jammed in the fruits/vegetables flowing and staging zone.

Driven by the circulation-driving mechanism, the wash water mainly circulates along wall surfaces of the container; therefore, a dead water zone (where the wash water substantially stands still) likely exists between the parallel arranged brush washing zone and fruits/vegetables flowing and staging zone; once the fruits/vegetables enter the dead water zone, they cannot circulate with the circulating wash water and thus cannot be brushed by the scrubber. To solve this problem, a baffle part is optionally provided in the container, where the circulation passage extends surrounding the baffle part. The baffle part may substantially eliminate the dead water zone; even if the dead water zone is not completely eliminated, the baffle part may at least significantly reduce the extent of the dead water zone. It is preferred that the baffle part has an arc surface facing and protruding above the fruits/vegetables flowing and staging zone, which may not only further reduce the extent of the dead water zone, but also may urge the flowing fruits/vegetables outward to prevent stranding of the fruits/vegetables.

Optionally, the baffle part may be generally provided as a baffle plate with a certain length, which facilitates formation of the circulation passage. Of course, the baffle part may also take on a form such as a baffle post.

Optionally, the baffle part may be separately formed from the container or may be one-piece formed with the container. In the case that the baffle part and the container are separately formed, the baffle part and the container may be secured via a snap. Of course, they may also be secured via a screw; or, a guide rail is provided on the container, such that the baffle part is inserted into the guide rail so as to be fixed. This detachable connection manner enables detachment of the baffle part to increase the capacity inside the container; the container itself may be used as a washing container for other purposes. The detachable connection manner is such that, for example, a slide rail groove is provided at the underside of the baffle part and a slide rail is provided at the bottom surface of the container, where to mount the baffle part, the slide rail simply slides into the slide rail groove. Or, a socket is provided at the lower end of the baffle part, and an insert-fitting column is provided on the bottom surface of the container, such that the insert-fitting column is inserted into the socket. Alternative manners of mounting the baffle part may comprise: providing a clamp protrusion at the lower portion of the baffle part, providing a slot provided in a recessed groove on the bottom surface of the container, providing a slot in the recessed groove, and inserting the clamp protrusion into the slot, whereby the baffle part may be mounted; or, applying a screw rod to connect the baffle part and the container, where the screw rod penetrates into the baffle part from the container, and to achieve this, a penetration may be provided in the baffle part to penetrate into the screw rod. In the case that the baffle part and the container are one-piece formed, a preferred forming manner is such that: a hollow raised portion is formed at the bottom surface of the container, which is easily formed, where the raised portion acts as the baffle part.

Optionally, in the case that a drain basket is provided, the baffle part may be disposed on the drain basket. In the case that a baffle part is provided in the container, a baffle part notch corresponding to the baffle part needs to be provided on the drain basket, a consequence of which is that when the drain basket is lifted up after washing of the fruits/vegetables is complete, some fruits/vegetables would fall out via the baffle part notch. However, if the baffle part is provided on the drain basket, there would be no need to provide a notch at the bottom of the drain basket corresponding to the baffle part, which prevents the fruits/vegetables from falling out.

As noted above, although provision of the baffle part may eliminate the dead water zone to a certain extent, it cannot thoroughly eliminate the impact of dead water zone, or the flow rate of the wash water proximal to the baffle part is still lower than that at the periphery of the container, such that the fruits/vegetables proximal to the baffle part are still likely stranded nearby the baffle part; therefore, a slope may be provided at the interface between the baffle part and the bottom surface of the container, where the slope inclines outwardly from the baffle part from top to down; in this way, the fruits/vegetables at the interface between the baffle part and the container flow outward along the slope and re-enter the wash water with a relatively high flow rate.

In the case that the baffle part is provided, a fruits/vegetables inlet port is formed between the downstream end of the baffle part and a sidewall of the container in the wash water flow direction. To prevent the fruits/vegetables from being jammed at the fruits/vegetables inlet port, an inwardly shrunk guide surface is provided at the downstream end of the baffle part so as to form a relatively wide fruits/vegetables guide opening between the guide surface and the sidewall of the container.

Optionally, a water discharge port is provided on a sidewall of the container, where the level of the wash water in the container does not exceed the position of the water discharge port. After washing of the fruits/vegetables is complete, the wash water may be discharged via the water discharge port, while the fruits/vegetables are retained in the container without falling out via the water discharge port.

The circulation-driving mechanism is configured to provide a driving force, which, on washing the fruits/vegetables, drives the wash water and the fruits/vegetables to circulate in the circulation passage, where the fruits/vegetables sequentially pass through the brush washing zone so as to be brushed.

Optionally, the circulation-driving mechanism refers to a rotating impeller or a water pump.

Optionally, the circulation-driving mechanism adopts a rotating impeller structure, where the rotating impeller rotates to drive the wash water to circulate, whereby the fruits/vegetables are carried to circulate. Of course, an alternative mechanism known to those skilled in the art may also be adopted, so long as it may drive the wash water and the fruits/vegetables to circulate in the circulation passage. The circulation-driving mechanism may be provided on a sidewall of the container, which may be provided on one sidewall, or may be provided on a plurality of sidewalls to facilitate the wash water to flow more smoothly with added energy.

Optionally, a rotating impeller is provided on two adjacent or opposite sidewalls, respectively, or provided on any three sidewalls or provided on each sidewall, respectively; moreover, one or more rotating impellers may be provided at each sidewall. Those skilled in the art will appreciate that the driving forces provided by respective rotating impellers are in the same direction. Of course, in some example embodiments, it is also feasible that the driving force direction of some rotating impeller is different from that of other rotating impellers. To facilitate the wash water to flow more smoothly and forcibly, the rotating impeller may be provided at any two sidewalls of the container.

Optionally, the rotating impeller is provided at two opposite sidewalls of the container, respectively, where the rotating direction of the rotating impeller disposed at one sidewall is reverse to that of the rotating impeller disposed at the opposite sidewall, such that the directions of the driving forces provided by the rotating impellers disposed at respective sidewalls are consistent. Meanwhile, to protect the fruits/vegetables from being hit by the rotating impellers, a protective case may be provided outside each rotating impeller.

Optionally, the rotating impeller or water pump is proximal to the brush washing zone.

Optionally, if the fruit and vegetable washing apparatus is provided with a baffle part, the rotating impeller or water pump may also be provided on the baffle part.

The scrubber is a device configured to brush the fruits/vegetables passing through the brush washing zone.

Optionally, the scrubber is proximal to one end or one side of the container to facilitate circulation formation of the wash water and circulation formation of the fruits/vegetables.

Optionally, the scrubber comprises a backplate and a brushing element disposed on a first surface of the backplate, the brushing element being preferably oriented to face the container. The brushing element may be a plastic flexible cleaning element, or a soft plastic flexible cleaning element, or a fabric strip flexible cleaning element, or other type of flexible brushing parts. In these scenarios, the spatial area where the brushing element is located and the corresponding spatial area of the container are referred to as the brush washing zone of the container.

Optionally, the scrubber itself serves as the circulation-driving mechanism; in this case, the scrubber is rotatably disposed in the container, and on washing the fruits/vegetables, the scrubber is rotating to agitate the water current while brushing the fruits/vegetables. In this case, the scrubber comprises a scrubber rotary shaft and a brushing portion disposed on the scrubber rotary shaft, where the brushing portion extends towards a direction away from the scrubber rotary shaft. The scrubber can be disposed in the container with the scrubber rotary shaft being transversely disposed or with the scrubber rotary shaft being vertically disposed.

In an example embodiment in which the scrubber is rotatably disposed in the container, another measure for preventing jam of the fruits/vegetables is that the scrubber rotary shaft is disposed on the container in a bi-directionally rotatable manner, i.e., the scrubber rotary shaft may rotate clockwise or counterclockwise, a simplest method of implementing which is to penetrate the scrubber rotary shaft through the container or prop up the scrubber rotary shaft on the container, where no unidirectional mechanism is provided between the scrubber rotary shaft and the container. With the bidirectional rotation design of the scrubber rotary shaft, once the fruits/vegetables are jammed in the container, the scrubber rotary shaft may rotate reversely, bringing the scrubber to rotate reversely, whereby the wash water flows reversely to disperse the jammed fruits/vegetables, clearing jam of the fruits/vegetables.

In an example embodiment in which the scrubber is rotatably disposed in the container, the scrubber rotary shaft may take on various forms. Optionally, the scrubber rotary shaft is a monolithic shaft body, or the scrubber rotary shaft comprises a main shaft and a shaft sleeve sleeved over the main shaft, the brushing portion being disposed on the shaft sleeve, where the main shaft and the shaft sleeve may be connected by snap-fitting, threaded-fastening, interference sleeve coupling, or the like. The main shaft is generally made of metal, and the shaft sleeve is generally made of plastics; in this case, the main shaft and the shaft sleeve may also be connected in such a manner: a toothed pattern is provided at an end portion of the main shaft to form a rough portion, and the shaft sleeve is sleeved over the main shaft, whereby the rough portion of the main shaft is tightly fitted with the shaft sleeve such that a portion of the shaft sleeve corresponding to the rough portion of the main shaft has a certain deformation, whereby the main shaft and the shaft sleeve are tightly engaged to form the entire body of the scrubber rotary shaft.

In the example embodiment that the scrubber is rotatably disposed in the container, when the scrubber is rotating, the wash water in the container is likely spun out to cause splash of the wash water. Therefore, an anti-splash cover may be provided to fit over the brush washing zone, preventing the wash water from splashing. In the case that the scrubber rotary shaft is transversely disposed, a typical structure of the anti-splash cover comprises a raised portion corresponding to the scrubber and a connecting portion connected to the container. Generally, the anti-splash cover is made of plastic, preferably transparent plastic so as to observe the washing status in the brush washing zone. The anti-splash cover may only cover the brush washing zone, or may cover an area beyond the brush washing zone so as to close the upper end opening of the container, whereby a better splash-baffling effect is achieved.

In an example embodiment in which the scrubber is rotatably disposed in the container, optionally, the brushing portion comprises a plurality of columns of first flexible cleaning elements distributed along the circumferential direction of the scrubber rotary shaft, where the first flexible cleaning elements are plastic flexible cleaning elements, or soft plastic cleaning elements, or fabric strip flexible cleaning elements. Of course, the first flexible cleaning elements may also be arranged in other irregular or regular distributions. In the radial section of the scrubber, the spacings between two adjacent columns of first flexible cleaning elements are preferably substantially equal. The first flexible cleaning elements are bendable upon touch. A first end of each first flexible cleaning element is disposed on the scrubber rotary shaft, while a second end thereof is a free end. When the fruits/vegetables pass through the brush washing zone, the fruits/vegetables touch the first flexible cleaning elements, causing the first flexible cleaning elements bent, whereby the fruits/vegetables are brushed by the first flexible cleaning elements.

In an example embodiment in which the scrubber is rotatably disposed in the container, optionally, the first flexible cleaning elements are specifically formed as such: each column of the first flexible cleaning elements may be a column of monolithic flexible cleaning element, e.g., a monolithic piece of plastic strip (e.g., nylon strip, TPR strip, etc.), a monolithic piece of soft plastic strip (e.g., silica gel strip, etc.), a monolithic piece of fabric strip, etc. Or, each column of the first flexible cleaning elements may also be formed to comprise a plurality of rows of rod-shaped elements (the cross section of which may be round or square or of other shape), e.g., a plurality of plastic rods (e.g., nylon rods, TPR rods) which are arranged into a column of first flexible cleaning elements; or, a plurality of soft plastic rods (e.g., silica gel rods, etc.) which are arranged into a column of first flexible cleaning elements; or, a plurality of plastic filaments (e.g., nylon filaments, TPR filaments, etc.) form one piece of bristle brush and a plurality of pieces of bristle brushes are arranged into a column of first flexible cleaning elements; or, a plurality of soft plastic filaments (e.g., silica gel filaments, etc.) form one piece of soft bristle brush and a plurality of pieces of soft bristle brushes are arranged into a column of first soft cleaning elements, etc.

Since there exists a gap between two adjacent columns of first flexible cleaning elements, smaller fruits/vegetables easily access between the two adjacent columns of first flexible cleaning elements, a consequence of which is that since the fruits/vegetables are located between two adjacent columns of first flexible cleaning elements, when the scrubber is rotating, the fruits/vegetables held between the two adjacent columns of first flexible cleaning elements are only rotating with the scrubber but cannot get through the first flexible cleaning elements, such that the fruits/vegetables cannot be brushed by the first flexible cleaning elements. Therefore, optionally, the brushing portion may further comprise a plurality of columns of second flexible cleaning elements, the second flexible cleaning elements being disposed between two adjacent columns of first flexible cleaning elements, where the height of the second flexible cleaning elements is lower than that of the first flexible cleaning elements such that smaller fruits/vegetables will not get deeply between the two adjacent columns of first flexible cleaning elements (due to being blocked by the second flexible cleaning elements) and thus can be brushed by the second flexible cleaning elements and/or first flexible cleaning elements with various strengths or contact areas. The material, distribution, and structure of the second flexible cleaning elements may refer to those of the first flexible cleaning elements as described above.

Optionally, one or more columns of the second flexible cleaning elements may be disposed between two adjacent columns of first flexible cleaning elements. In case of disposing one column of the second flexible cleaning elements between two adjacent columns of the first flexible cleaning elements, it is preferably disposed on the radial cross section of the scrubber, where the two adjacent columns of first flexible cleaning elements are equally spaced, and the two adjacent columns of second flexible cleaning elements are equally spaced; this regular arrangement facilitates enhancement of the cleaning effect.

In an example embodiment in which the scrubber is rotatably disposed in the container, with the anti-splash cover provided, the water spun out when the scrubber is rotating will splash to the anti-splash cover, and the water blocked by the anti-splash cover will flush back to the scrubber, forming a resistance to rotation of the scrubber. In order to reduce the resistance as much as possible, optionally, the minimum gap between the anti-splash cover and the outer edge of the scrubber is 2 mm so as to control the impact pressure of the flushing-back water blocked by the anti-splash cover within a relatively small extent.

In an example embodiment in which the scrubber is rotatably disposed in the container, to further suppress splashing of the wash water, a water baffle mechanism may be provided between the anti-splash cover and the container so as to block the water spun out by the brushing portion, thereby preventing the water splash from leaking out of the container. Optionally, the water baffle mechanism comprises an anti-splash groove provided on an upper end surface of the container and an anti-splash rib disposed on the anti-splash cover, such that when the anti-splash cover covers the brush washing zone, the anti-splash rib can be inserted into the anti-splash groove; or, the water baffle mechanism comprises an anti-splash rib disposed on the upper end surface of the container and an anti-splash groove provided on the anti-splash cover, such that when the anti-splash cover covers the brush washing zone, the anti-splash rib can be inserted in the anti-splash groove. The anti-splash rib may baffle the wash water, and the anti-splash groove may receive the baffled wash water.

In an example embodiment in which the scrubber is rotatably disposed in the container, optionally, the water baffle mechanism may take on another specific structural form such that the water baffle mechanism comprises a seal ring disposed between the anti-splash cover and the container, where the seal ring enables water tightness, substantially eliminating splashing of the wash water.

In an example embodiment in which the scrubber is rotatably disposed in the container, optionally, the anti-splash cover is detachably connected to the container, such that removal of the anti-splash cover facilitates cleaning of the brush washing zone and replacement of the scrubber. Usually, the anti-splash cover is just propped up on the container; and to further secure the propping, a detachable connection manner such as snap-fitting or screw-fastening may be adopted between the anti-splash cover and the container.

In an example embodiment in which the scrubber is rotatably disposed in the container, optionally, with the anti-splash cover provided, the “baffle part” may also be disposed on the anti-splash cover, i.e., a baffle plate is disposed on the anti-splash cover; when the anti-splash cover covers the brush washing zone, the baffle plate can project into the container, whereby the circulation passage extends surrounding the baffle plate.

In an example embodiment in which the scrubber is rotatably disposed in the container, optionally, the scrubber is disposed in the container with the scrubber rotary shaft being transversely disposed, where “the scrubber rotary shaft being transversely disposed” means the scrubber rotary shaft is substantially transversely disposed, i.e., the axis of the scrubber rotary shaft is substantially parallel to the horizontal plane; it is noted that even if there exists a certain included angle between the axis of the scrubber rotary shaft and the horizontal plane, it also falls within the extent of the meaning of “the scrubber rotary shaft being transversely disposed” in this example embodiment. In the case that the scrubber is disposed in the container with the scrubber rotary shaft being transversely disposed, the fruits/vegetables circulating in the circulation passage can pass between the scrubber and the bottom surface of the container to be thereby brushed.

In an example embodiment in which the scrubber is disposed on the container with the scrubber rotary shaft being transversely disposed, the space occupied by the scrubber in the container is referred to as the brush washing zone.

In the example embodiment that the scrubber is disposed in the container with the scrubber rotary shaft being transversely disposed, when the scrubber is rotating to bring the wash water to circulate, the wash water is preferably flowing along a sidewall formation direction of the container, such that the flowing wash water will not obliquely impact a sidewall of the container, without loss of dynamic force for moving forward; therefore, the axial direction of the scrubber rotary shaft is preferably substantially vertical to the flow direction of the wash water in the container. The “vertical” here means substantially vertical engineeringly, where a reasonable angle falls within the concept of “vertical,” which does not require being absolutely vertical geometrically. The scrubber rotary shaft is not absolutely vertical to the flow direction of the wash water, and an obliquely oriented scrubber rotary shaft, when rotating, may still bring the wash water in the container to flow in the circulation passage, and the flow direction of the wash water still flows substantially along sidewalls of the container.

In an example embodiment in which the scrubber is disposed on the container with the scrubber rotary shaft being transversely disposed, optionally, after the scrubber is mounted on the container, a spacing between the brushing portion and the bottom surface of the container is preferably 0.5 mm-5 cm; in this case, without contact between the brushing portion and the container, the scrubber rotates more smoothly. Another option is that after the scrubber is mounted, the brushing portion contacts the bottom surface of the container, whereby dirt buildup on the bottom surface of the container may be cleaned, which realizes self-cleaning of the bottom surface of the container. With this option, on one hand, the brushing portion projects deeply in the brush washing zone, offering a more thorough rubbing between the fruits/vegetables and the brushing portion when the fruits/vegetables pass through the brush washing zone, whereby more fruits/vegetables may be rubbed with the brushing portion, yielding a better cleaning effect. On the other hand, the brushing portion projects deeply into the brush washing zone, offering a stronger drive to the wash water, which facilitates forming a fast circulating water current, where the fast circulating water current facilitates bringing the fruits/vegetables to circulate fast, yielding a better cleaning effect.

In an example embodiment in which the scrubber is disposed on the container with the scrubber rotary shaft being transversely disposed, optionally, after the scrubber is mounted, the brushing portion is higher than the container; in this way, when the scrubber is rotating, only part of the brushing portion is submerged in the wash water, and the rotating scrubber experiences less resistance from the wash water, whereby rotation of the scrubber is facilitated.

In an example embodiment in which the scrubber is disposed on the container with the scrubber rotary shaft being transversely disposed, optionally, the brushing portion is substantially uniformly distributed in the transverse width direction of the brush washing zone, such that substantially all fruits/vegetables passing through the brush washing zone can be rubbed with and brushed by the brushing portion, yielding a better cleaning effect.

In an example embodiment in which the scrubber is disposed on the container with the scrubber rotary shaft being transversely disposed, optionally, a wipe part is provided at the bottom and/or an inner sidewall of the container, where the wipe part may take on a form of a flexible cleaning element (e.g., plastic bristles, a plastic brushing column, a soft plastic strip, soft plastic bristles, and a flexible fabric strip, etc.), a protruding bar, or a protruding point, etc. In the flow direction of the wash water, a wipe part may be provided in front of the scrubber, or rear to the scrubber, or below the scrubber; or, a wiper may be provided respectively in front of, rear to, and below the scrubber; or, a wiper is provided at two orientations of in front of, rear to, and below the scrubber. Provision of the wiper part has the following purposes: by providing the wipe part in front of the scrubber, the fruits/vegetables are first wiped by the wipe part before entering the brush washing zone; by providing the wipe part rear to the scrubber, the fruits/vegetables are wiped again by the wipe part when flowing out of the brush washing zone; by providing the wipe part below the scrubber, the fruits/vegetables are simultaneously rubbed with and brushed by the brushing portion and the wipe part when flowing through the brush washing zone. Therefore, with provision of the wipe part, the fruits/vegetables may not only be brushed by the brushing portion, but also may be rubbed with the wipe part, whereby a better cleaning effect is achieved. Of course, the wipe part may also be provided at two or three orientations of in front of, rear to, and below the scrubber, where a wipe part may be preferably disposed at the lower, rear position of the scrubber in the wash water flow direction, at which position the fruits/vegetables will not experience additional resistance when entering the brush washing zone, which facilitates the fruits/vegetables to access the brush washing zone smoothly. In addition, by providing the wipe part at the lower, rear position of the scrubber, no additional resistance will occur to the fruits/vegetables in the brush washing zone, preventing the fruits/vegetables from being stranded in the brush washing zone due to loss of the dynamic force for moving forward in the brush washing zone. In addition, by providing the wipe part at the lower, rear position of the scrubber, the fruits/vegetables, which have been brushed by the brushing portion in the brush washing zone and will immediately break away from the brushing portion, are further pushed by the brushing portion, gaining an added dynamic force to move forward, and in the meanwhile they are wiped by the wipe part, so that a better cleaning effect is achieved.

Optionally, a plurality of wipe parts may be provided. Each wipe part may comprise a mounting plate and a flexible cleaning element provided on the mounting plate. The plurality of wipe parts may be alternatively mounted on the container, i.e., the various wipe parts may be replaced with each other so as to be adapted to various sizes of to-be-washed fruits/vegetables. A specific mounting manner may be described as such: providing a slot on the container, where the mounting plate can be inserted into the slot or exit from the slot.

In an example embodiment in which the scrubber is disposed in the container with the scrubber rotary shaft being transversely disposed, after the fruit and vegetable washing apparatus according to the disclosure serves a certain period of time, dirt washed off would build up at the bottom of the container; if the wipe part is provided at the bottom of the container, the dirt easily adheres to the wipe part. Therefore, a preferable positional relationship between the brushing portion of the scrubber and the wipe part is described as such: an end portion of the brushing portion contacts the wipe part such that the brushing portion can brush and clean the wipe part.

In an example embodiment in which the scrubber is disposed on the container with the scrubber rotary shaft being transversely disposed, optionally, a transitional surface gradually elevated along the flow direction of the wash water is formed on the bottom surface of the brush washing zone or on the bottom surface of the container at the exit side of the brush washing zone, where the fruits/vegetables, which are being brushed in the brush washing zone, climb along the transitional surface, whereby the friction between the brushing portion and the fruits/vegetables increases and thus the cleaning effect is enhanced. The transitional surface is recommended to have a bevel shape or an inwardly recessed curved surface, preferably the inwardly recessed curved surface, where a better cleaning effect is achieved when the fruits/vegetables rise and fall in the inwardly recessed curved surface. Alternatively, the transitional surface may also be formed on the bottom surface of the container at the exit side of the brush washing zone along the flow direction of the wash water; as a result, since the fruits/vegetables need to climb at the exit side of the brush washing zone, the fruits/vegetables stay longer in the brush washing zone, whereby the cleaning effect is improved. In addition, the wipe part noted above may also be provided on the transitional surface to further improve the cleaning effect; it is recommended to dispose the wipe part at the downstream side of the transitional surface in the flow direction of the wash water, i.e., the wipe part is disposed at a higher point of the transitional surface where the spacing between the brushing portion and the wipe part is minimized, or the brushing portion and the wipe part are intersected; in this way, the fruits/vegetables may get more rubbed to achieve a better cleaning effect.

In an example embodiment in which the scrubber is disposed on the container with the scrubber rotary shaft being transversely disposed, optionally, there may be provided only one scrubber; or a plurality of scrubbers are arranged in juxtaposition, where the plurality of scrubbers are linked such that they may rotate synchronously. A linking mechanism between the plurality of scrubbers may include, but is not limited to, a gear transmission mechanism, a chain transmission mechanism, or a belt transmission mechanism. Optionally, the linking mechanism is a gear transmission mechanism where a driven gear is provided on the scrubber rotary shaft of two scrubbers, respectively, and a transitional gear is provided between the two driven gears, such that under the action of the transitional gear, the scrubber rotary shafts of the two scrubbers rotate synchronously; to rotate the two scrubbers, the transitional gear, which may be actuated by another drive mechanism, is rotated to drive the two scrubber rotary shafts to rotate synchronously. In the case that a plurality of the scrubbers are arranged in juxtaposition, the space occupied by the scrubbers in the container is referred to as the brush washing zone.

In an example embodiment in which the scrubber is disposed on the container with the scrubber rotary shaft being transversely disposed, optionally, the scrubbers may also be configured such that the scrubbers comprise a first scrubber and a second scrubber which are oriented to face each other, thereby forming two brush washing zones facing each other, which enhances the cleaning efficiency. It is preferable that the first scrubber and the second scrubber are connected via a reversing mechanism such that the first scrubber and the second scrubber have opposite rotating directions, whereby the wash water smoothly circulates in the circulation passage. The reversing mechanism may adopt a typical reversing mechanism, e.g., the scrubber rotary shaft of the first scrubber is provided with a first duplex gear, and the scrubber rotary shaft of the second scrubber is provided with a second duplex gear, the first duplex gear and the second duplex gear being engaged.

In an example embodiment in which the scrubber is disposed on the container with the scrubber rotary shaft being transversely disposed, optionally, the scrubber is preferably detachably provided on the container to facilitate replacing the scrubber or removing the scrubber for cleaning purpose. The detachable connection between the scrubber and the container may be such that a stopper block is provided at the upper edge of the container and the scrubber rotary shaft of the scrubber is propped up between the stopper block and the upper edge of the container, where the stopper block and the container are screw-fastened therebetween, and by unscrewing the screw, the scrubber may be removed. The detachable connection between the scrubber and the container may also be such that the scrubber rotary shaft of the scrubber is directly propped up on the upper end of the container, and in case of a need to dismount, it is only needed to lift it up. The detachable connection between the scrubber and the container may further be such that a baffle part is provided in the container, and the terminal end of the scrubber rotary shaft of the scrubber may be attached on the baffle part, where to make the scrubber detachable, the terminal end of the scrubber rotary shaft may be directly propped up on the baffle part; or, a second stopper block is provided on the upper edge of the baffle part, and the scrubber rotary shaft of the scrubber is propped up between the second stopper block and the upper edge of the baffle part, the second stopper block and the baffle part being screw-fastened, where to remove the scrubber, it is only needed to unscrew the screw. Of course, other detachable connections may also be adopted between the scrubber and the container, e.g., providing a positioning block on the scrubber rotary shaft, where snap-fitting or screw-fastening is applied between the positioning block and the container.

In an example embodiment in which the scrubber is disposed on the container with the scrubber rotary shaft being transversely disposed, the scrubber rotary shaft or the scrubber may be gripped by hand to rotate, whereby the scrubber is actuated to rotate. Optionally, the scrubber rotary shaft is connected to a drive mechanism driving it to rotate, such that the drive mechanism drives the scrubber rotary shaft to rotate, thereby bringing the scrubber to rotate. The drive mechanism may be an electric drive mechanism or a manual drive mechanism. The drive mechanism is generally disposed outside the container so as to facilitate manipulation. Optionally, the electric drive mechanism adopts an electric motor, where the output end of the electric motor is connected to the scrubber rotary shaft. Optionally, the manual drive mechanism adopts a crank handle, where the output end of the crank handle is connected to the scrubber rotary shaft; the distance between the lowest posture of the crank handle and a desktop is preferably controlled between 1.5 cm and 8 cm such that a space for accommodating hand is reserved between the lowest posture of the crank handle and the desktop, whereby the hand gripping the crank handle will not hit the desktop when turning the crank handle. The crank handle and the scrubber rotary shaft may be directly connected or may be connected via a connection mechanism, e.g., a gear transmission mechanism. In the case that the scrubber rotary shaft is disposed relatively obliquely, the scrubber rotary shaft and the crank handle may be connected in the following two manners: in one manner, a bevel gear is provided at the output end of the crank handle, a driven gear is provided on the scrubber rotary shaft, and the bevel gear and the driven gear are engaged, such that by turning the crank handle, the scrubber is brought to rotate, in which case the rotation axis of the output end of the crank handle is parallel to the horizontal plane, offering a comfort manipulation when turning the crank handle; in the other manner, the crank handle is directly connected to the scrubber rotary shaft, in which case the rotation axis of the output end of the crank handle is co-axial with the scrubber rotary shaft, offering an easy installation but a somewhat inconvenient manipulation.

Optionally, the drive mechanism is detachably connected on the container, which facilitates packaging by removing the drive mechanism together with the scrubber, thereby reducing the packaging size. In the case that the drive mechanism is an electric drive mechanism, the electric drive mechanism and the container are detachably connected by snap-fitting or screw-fastening or the like; or, a slide groove is provided on the container and a slide fin is provided on the drive mechanism, such that the slide fin slides into the slide groove. In the case that the drive mechanism is a manual drive mechanism, the detachable connection structure between the drive mechanism and the container may be snap-fitting or screw-fastening or the like; or a slide groove is provided on the container and a slide fin is provided on the drive mechanism, such that the slide fin slides into the slide groove. A further detachable connection manner between the drive mechanism and the container just requires detachable connection between the scrubber rotary shaft and the container since the drive mechanism is connected to the scrubber rotary shaft, where the detachable connection manner between the scrubber rotary shaft and the container is just as described above.

Optionally, the detachable connection between the drive mechanism and the scrubber rotary shaft enables separate removal of the drive mechanism. A simplest detachable connection manner between the drive mechanism and the scrubber rotary shaft is such that the terminal end of the scrubber rotary shaft has a polygonal cross section, and a sleeve with a shape adapted to the shape of the terminal end of the scrubber rotary shaft is provided at the output end of the drive mechanism; in this way, the detachable connection between the scrubber rotary shaft and the drive mechanism is simply implemented by inserting the terminal end of the scrubber rotary shaft into the socket, whereby the drive mechanism may smoothly drive the scrubber rotary shaft to rotate.

Optionally, the detachable connection manner between the scrubber rotary shaft and the drive mechanism may also include, but is not limited to, threaded-fitting, screw-fastening, and gear-engaging between the scrubber rotary shaft and the output end of the drive mechanism.

Optionally, the detachable connection manner between the scrubber rotary shaft and the drive mechanism may also be such that a driven gear is provided on the scrubber rotary shaft, a driving gear is provided at the output end of the crank handle, the driving gear is engaged with the driven gear on the scrubber rotary shaft, and a gear chamber is provided at the upper end of the container, where the driving gear and the driven gear on the scrubber rotary shaft are disposed (completely or partially) in the gear chamber while the output shaft of the crank handle may be directly propped up on the container; in this way, by removing the crank handle, the drive mechanism and then the scrubber rotary shaft may be disassembled. A stopper block may be further provided to fit over the gear chamber, such that by removing the stopper block, the drive mechanism is removed. Furthermore, detachment between the drive mechanism and the scrubber rotary shaft may also be implemented by the detachable connection between the driving gear and the crank handle; optionally, the detachable connection manner between the driving gear and the crank handle may be such that the driving gear has a disassembly cavity in which a stop rib is provided, and a protrusion rib is provided at the terminal end of the crank handle, where the terminal end of the crank handle is inserted into the disassembly cavity, and by turning the crank handle, the protrusion rib and the stop rib abut against each other, whereby the crank handle drives the driving gear to rotate; in this way, by just pulling the crank handle out of the gear chamber, the crank handle is removed. Optionally, the detachable connection manner between the driving gear and the crank handle may also be such that the driving gear has a cavity in which a screw rod is provided, the screw rod is inserted into the crank handle, and meanwhile a locking rod also penetrates through the crank handle into the cavity of the driving gear, where the locking rod has a threaded cavity, and the screw rod is screwed into the threaded cavity, the terminal end of the locking rod being locked on the crank handle; in this way, connection between the crank handle and the driving gear is realized, and to remove the crank handle, it is only needed to unscrew the locking rod.

Optionally, a further detachable connection mechanism between the drive mechanism and the scrubber rotary shaft may be such that the scrubber rotary shaft comprises a main shaft and a shaft sleeve sleeved over the main shaft, a driven gear being provided on the main shaft of the scrubber rotary shaft, where the driven gear is disposed at the outer end of the main shaft, and the toothed pattern on the main shaft is provided at the inner end of the main shaft. The crank handle as the drive mechanism is provided with a drive shaft at one end thereof, a driving gear is provided on the drive shaft, and the drive shaft penetrates through a drive fixed block to enable the drive shaft to be rotatable, where the driving gear is engaged with the driven gear, and by turning the crank handle, the driven gear is driven by the driving gear, whereby the scrubber rotary shaft is driven to rotate. In this example embodiment, the driven gear may be a typical gear only having one circle of toothed surface; in this case, the driving gear drives the driven gear and further drives the main shaft of scrubber rotary shaft to rotate, whereby the scrubber rotary shaft may be rotated as a whole; meanwhile, a geared ring may be further provided at the inner side of the shaft sleeve, where a portion of the driven gear is engaged with the driving gear, and a portion of the driven gear is further meshed with the geared ring of the shaft sleeve. The driven gear may also be a duplex gear, where a first stage of the duplex gear is engaged with the driving gear, a geared ring being provided at the inner side of the shaft sleeve; and a second stage of the duplex gear is engaged with the geared ring; when this example mechanism is adopted, one end of the shaft sleeve is tightly fitted with the main shaft via the toothed pattern, while the other end of the sleeve shaft is meshed with the driven gear; in this way, both ends of the shaft sleeve are positioned, rendering the shaft sleeve more stable during rotating. A gear chamber is provided at the upper end of the sidewall of the container, the driving gear and the driven gear are both located in the gear chamber (the driven gear is completely or partially disposed in the gear chamber), and the drive fixed block is detachably mounted in the gear chamber; in this way, the drive fixed block, the driving gear, and the drive shaft form an assembly that is detachable in its entirety, i.e., in case of disassembly, it is only needed to remove the drive fixed block; the installation is also very convenient, where it is only needed to install the drive fixed block into the gear chamber. The detachable connection of the drive fixed block may take on various forms, e.g., providing a positioning rib in the gear chamber, and providing a positioning groove on the drive fixed block, where the positioning rib is inserted into the positioning groove to position the drive fixed block; or, the drive fixed block is connected to a sidewall of the container via a screw rod, the screw rod preferably penetrating through from the upper end of the drive fixed block; or, snap-fitting is applied between the drive fixed block and a chamber wall of the gear chamber.

Optionally, the main shaft of the scrubber rotary shaft may penetrate into a sidewall of the container. Optionally, the main shaft of the scrubber rotary shaft may be positioned in a such manner that a lower main shaft recessed groove is provided at the bottom surface of the gear chamber, one end of the main shaft being supported in the lower main shaft recessed groove, and an upper main shaft recessed groove is provided at the lower end of the drive fixed block, such that when the drive fixed block is mounted in the gear chamber, the upper main shaft recessed groove is pressed on the main shaft; in this case, a shaft hole surrounding the main shaft is enclosed by the upper main shaft recessed groove and the lower main shaft recessed groove. The other end of the main shaft may be suspended in the air. If a baffle part is provided, one end of the scrubber rotary shaft may be supported on the container, while the other end thereof is supported on the baffle part or penetrates into the baffle part; in this way, the installation of the scrubber rotary shaft is not only simplified but also secured. Optionally, a lower main shaft secondary recessed groove is provided on the upper end surface of the baffle plate, the other end of the main shaft is propped up in the lower main shaft second recessed groove, and meanwhile a second stopper block may be provided at the upper end of the baffle plate, an upper main shaft secondary recessed groove is provided on the second stopper block; likewise, after the second stopper block is mounted on the baffle part, a shaft hole surrounding the main shaft is enclosed between the lower main shaft secondary recessed groove and the upper main shaft secondary recessed groove. With this mounting manner, the drive shaft penetrates through the drive fixed block, and the main shaft of the scrubber rotary shaft is pressed between the drive fixed block and the gear chamber; therefore, no hole is provided in a sidewall of the container corresponding to the main shaft, which increases the volume of the liquid held in the container and eliminates the risk of liquid leakage due to directly making a hole in the sidewall corresponding to the main shaft. Meanwhile, the drive shaft is generally disposed above the main shaft of the scrubber rotary shaft, and the crank handle connected to the drive shaft is at a relatively high position so as to facilitate rotation of the crank handle, avoiding the hand gripping the crank handle from hitting the desktop when turning the crank handle due to a lower position of the crank handle.

Optionally, a wear-resisting mechanism is sleeved over the drive shaft. The wear-resisting mechanism may adopt a drive shaft protective sleeve (usually a rubber sleeve) disposed between the drive shaft and the drive fixed block so as to reduce friction between the drive shaft and the drive fixed block during rotating. Or, a wear-resisting mechanism is provided to sleeve each of both ends of the main shaft of the scrubber rotary shaft, respectively; this wear-resisting mechanism may adopt a scrubber rotary shaft protective sleeve (generally a rubber sleeve), where the scrubber rotary shaft protective sleeve is disposed in the shaft hole to reduce friction between the main shaft of the scrubber rotary shaft and the shaft hole during rotating.

Optionally, a speed regulating mechanism is disposed between the drive mechanism and the scrubber rotary shaft. The speed regulating mechanism may be a speed-up mechanism (e.g., a gear train speed-up mechanism). In the case that the speed regulating mechanism is a speed-up mechanism, the rotational speed of the scrubber rotary shaft may increase to enhance brushing efficiency. The speed regulating mechanism may be a speed reduction mechanism (e.g., a gear train speed reduction mechanism), in which case the rotational speed of the scrubber rotary shaft may be decelerated to facilitate rotation of the scrubber. The speed regulating mechanism may be a gearbox (i.e., a shift gearbox, which enables speed regulation by shifting gears to yield different gear outputs), in which case speed increase or speed reduction of the scrubber rotary shaft is performed dependent on actual use.

In an example embodiment in which the scrubber is rotatably disposed in the container, optionally, the scrubber is disposed in the container with the scrubber rotary shaft being vertically disposed, where “the scrubber rotary shaft being vertically disposed” refers to the scrubber rotary shaft being substantially vertically disposed, i.e., the axis of the scrubber rotary shaft is substantially vertical to the horizontal plane; even if the axis of the scrubber rotary shaft is not absolutely vertical to the horizontal plane, it also falls within the scope of the meaning of “the scrubber rotary shaft being vertically disposed” referred to in this example embodiment. In the case that the scrubber is disposed in the container with the scrubber rotary shaft being vertically disposed, the brushing portion extends toward a side surface direction of the container, such that the fruits/vegetables, when circulating in the circulation passage, can pass between the scrubber and the side surface of the container so as to be brushed.

In an example embodiment in which the scrubber is provided in the container with the scrubber rotary shaft being vertically disposed, the position where the fruits/vegetables access the brush washing zone from between the brushing portion and a side surface of the container is referred to a fruits/vegetables inlet port; the fruits/vegetables, after entering the brush washing zone via the fruits/vegetables inlet port, sequentially pass through the brush washing zone and then flow out of the brush washing zone from between the brushing portion and the side surface of the container; the position where the fruits/vegetables flowing out of the brush washing zone from between the brushing portion and a side surface of the container is referred to as a fruits/vegetables outlet port. Therefore, the space corresponding to the scrubber between the fruits/vegetables inlet port and the fruits/vegetables outlet port in the container is referred to as the brush washing zone, while the opposite side of the container unoccupied by the scrubber is referred to as fruits/vegetables staging zone. In addition, in an exceptional circumstance, there are always a few fruits/vegetables failing to access the brush washing zone, but access the space outside the brush washing zone occupied by the scrubber; this part of space may be referred to as an internal circulation zone, where after the fruits/vegetables enter the internal circulation zone, most of them would be pushed by the rotating scrubber again towards the fruits/vegetables inlet port from which they re-enter the brush washing zone to be brushed.

When the scrubber is rotating to bring the wash water to circulate, the wash water preferably flows along a sidewall formation direction of the container such that the flowing wash water does not obliquely impact sidewalls of the container, without causing dynamic loss of forward movement. Therefore, optionally, the axial direction of the scrubber rotary shaft is preferably substantially vertical to the horizontal plane. The “vertical” here refers to substantially vertical engineeringly, not absolutely vertical in the geometric sense; a reasonable angle falls within the concept of “vertical.” The scrubber rotary shaft is not absolutely vertical to the horizontal plane, and the rotating scrubber rotary shaft obliquely oriented may still bring the wash water in the container to flow in the circulation passage, with the flow direction of the wash water substantially along the sidewalls of the container. In the case that the scrubber rotary shaft is not absolutely vertical to the horizontal plane, the scrubber rotary shaft and the crank handle may be connected in the following two manners: in one manner, a bevel gear is provided at an output end of the crank handle, a driven gear is provided on the scrubber rotary shaft, and the bevel gear is engaged with the driven gear, such that turning of the crank handle brings the scrubber to rotate, in which case the rotation axis of the output end of the crank handle is still parallel to the horizontal plane, offering a comfort manipulation when turning the crank handle; in the other manner, the crank handle is directly connected to the scrubber rotary shaft, in which case the rotation axis of the output end of the crank handle is coaxial with the scrubber rotary shaft, offering a simple and convenient installation but a somewhat inconvenient manipulation.

In an example embodiment in which the scrubber is provided in the container with the scrubber rotary shaft being vertically disposed, optionally, a wipe part may be provided on an internal side surface of the container. The wipe part may be a flexible cleaning element (e.g., plastic bristles, a plastic brushing column, a soft plastic strip, soft plastic bristles, and a flexible fabric strip, etc.), a protruding bar, or a protruding point, etc. In the flow direction of the wash water, a wipe part may be provided in front of the scrubber, or rear to the scrubber, or directly facing the scrubber, or a wiper may be provided respectively in front of the scrubber, rear to the scrubber, and directly facing the scrubber, or a wiper may be provided respectively at any two orientations of in front of the scrubber, rear to the scrubber, and directly facing the scrubber. Provision of the wiper part has the following purposes: if the wipe part is provided in front of the scrubber, the fruits/vegetables will be first wiped by the wipe part before entering the brush washing zone; if the wipe part is provided rear to the scrubber, the fruits/vegetables are wiped again by the wipe part when flowing out of the brush washing zone; if the wipe part is provided directly facing the scrubber, the fruits/vegetables are simultaneously rubbed with and brushed by the brushing portion 3 and the wipe part. Therefore, with provision of the wipe part, the fruits/vegetables may not only be brushed by the brushing portion, but also may be rubbed by the wipe part, whereby a better cleaning effect is achieved. Of course, the wipe part may also be provided respectively at any two or three orientations of in front of the scrubber, rear to the scrubber, and directly facing the scrubber.

In an example embodiment in which the scrubber is provided in the container with the scrubber rotary shaft being vertically disposed, optionally, the brushing portion extends obliquely downward so as to have a better contact with the to-be-washed fruits/vegetables upon brushing; in addition, the water splash arising from agitation of the rotating brush will be suppressed by the obliquely, downwardly extending brushing portion, thereby suppressing water splashing.

In an example embodiment in which the scrubber is provided in the container with the scrubber rotary shaft being vertically disposed, optionally, a frustum is formed on the bottom surface of the container corresponding to the scrubber, such that during the washing process, the fruits/vegetables at the bottom will flow outward along the frustum, thereby preventing the fruits/vegetables from being jammed at the bottom of the container.

In an example embodiment in which the scrubber is provided in the container with the scrubber rotary shaft being vertically disposed, optionally, the scrubber is detachably provided on the container so as to facilitate replacement of the scrubber or removal of the scrubber for cleaning.

In an example embodiment in which the scrubber is provided in the container with the scrubber rotary shaft being vertically disposed, optionally, there may only be one scrubber provided.

In an example embodiment in which the scrubber is provided in the container with the scrubber rotary shaft being vertically disposed, optionally, there may be a plurality of scrubbers provided, where the brush washing zones are formed to correspond to the scrubbers. The plurality of scrubbers may be linked so as to rotate synchronously. A linking mechanism between the plurality of scrubbers may refer to, but is not limited to, a gear transmission mechanism, a chain transmission mechanism, or a belt transmission mechanism.

In an example embodiment in which the scrubber is provided in the container with the scrubber rotary shaft being vertically disposed, optionally, the scrubber rotary shaft is provided in such a manner that a lower end of the scrubber rotary shaft directly abuts against the bottom surface of the container, where the scrubber rotary shaft rotates with its lower end as the fulcrum; to facilitate a stable rotating effect, the lower end of the scrubber rotary shaft is generally insertable into the bottom surface of the container so as to be axially limited, such that it can only rotate without up-down play. For example, a snap spring may be adopted to axially position the scrubber rotary shaft; or, a protrusion rib is provided on the scrubber rotary shaft while a recessed ring is provided on the container such that the protrusion rib is disposed in the recessed ring. To improve rotating smoothness of the scrubber rotary shaft, a ball may be provided between the lower end of the scrubber rotary shaft and the bottom surface of the container, where the ball may be provided at the lower end of the scrubber rotary shaft, or may be disposed in the container, or may be a separate part disposed between the lower end of the scrubber rotary shaft and the container.

In an example embodiment in which the scrubber is provided in the container with the scrubber rotary shaft being vertically disposed, optionally, an alternative manner of providing the scrubber rotary shaft is such that a support shaft is provided on the bottom surface of the container and the scrubber rotary shaft is sleeved outside the support shaft, whereby the scrubber rotary shaft is supported on the support shaft, in which case the scrubber rotary shaft is detachable, and in case of disassembly, it is simply needed to remove the scrubber rotary shaft. To improve rotating smoothness of the scrubber rotary shaft, a first ball body may be provided between the support shaft and the scrubber rotary shaft, where the first ball body may be disposed at the upper end of the support shaft, and the scrubber rotary shaft is provided with an abutting base, such that the first ball body is urged against the abutting base. Of course, the first ball body may optionally be provided in the scrubber rotary shaft, where the first ball body is pressed on the upper end of the support shaft. To facilitate support and formation of the support shaft, the support shaft comprises a shaft seat, where the shaft seat is most preferably one-piece formed with the container.

Optionally, to enhance stability of the ball body, a ball groove corresponding to the first ball body may be provided on the abutting base, where the first ball body is partially disposed in the ball groove, whereby the ball body is positioned more securely.

Optionally, an extending post is provided at the upper end of the support shaft, the extending post projecting into the abutting base, the first ball body being disposed between the upper end of the extending post and the abutting base. When the extending post projects into the abutting base and the first ball body is disposed at the upper end of the extending post, the first ball body is urged more deeply into the abutting base, such that the first body does not easily fall off.

In an example embodiment in which the scrubber is provided in the container with the scrubber rotary shaft being vertically disposed, optionally, an alternative manner of providing the scrubber rotary shaft is such that if an anti-splash cover is provided on the container, the upper end of the scrubber rotary shaft is attached onto the anti-splash cover.

In an example embodiment in which the scrubber is provided in the container with the scrubber rotary shaft being vertically disposed, to enable rotation of the scrubber, optionally, the scrubber rotary shaft or the scrubber may be gripped and turned by hand, whereby the scrubber is actuated to rotate.

In an example embodiment in which the scrubber is provided in the container with the scrubber rotary shaft being vertically disposed, to enable rotation of the scrubber, optionally, the scrubber rotary shaft is connected to the drive mechanism driving it to rotate, i.e., the scrubber rotary shaft is in drive-enabled connection to the output end of the drive mechanism (the drive-enabled connection means the output end of the drive mechanism may drive the scrubber rotary shaft to rotate), whereby the drive mechanism drives the scrubber rotary shaft to rotate to further bring the scrubber to rotate. The drive mechanism may refer to an electric drive mechanism or a manual drive mechanism.

Optionally, the electric drive mechanism refers to an electric motor, the output end of which is connected to the scrubber rotary shaft.

Optionally, the manual drive mechanism is a crank handle, an output end of which is connected to the scrubber rotary shaft. A specific structure of the crank handle may comprise: a handle body and a grip disposed on the handle body, where the handle body may have a disc shape, or have a strip or plate shape; the handle body has a connecting portion, the connecting portion of the handle body being attached to the scrubber rotary shaft.

Optionally, the grip is rotatably disposed above the handle body, offering a smoother manipulation when the grip is gripped by hand to rotate the handle body.

Optionally, a grip rotary shaft is provided on the grip, the grip rotary shaft penetrating into the handle body, such that the grip can rotate about the grip rotary shaft as the axis. The grip rotary shaft is parallel to a crank handle rotary shaft, the grip rotary shaft and the crank handle rotary shaft being disposed on the handle body with an interval.

Optionally, the grip rotary shaft is fixed with the handle body, and the grip rotary shaft and the grip are rotatable relative to each other.

Optionally, a second ball body is provided between the upper end of the grip rotary shaft and the grip, such that the grip rotates more smoothly.

Optionally, another manner of positioning the grip rotary shaft is such that the grip rotary shaft is fixed with the grip, and the grip rotary shaft and the handle body are rotatable relative to each other.

Optionally, a second ball body is provided between the lower end of the grip rotary shaft and the handle body, whereby the grip rotates more smoothly.

In an example embodiment in which the scrubber is provided in the container with the scrubber rotary shaft being vertically disposed, optionally, the drive mechanism is detachably connected onto the container, such that when packaging, the drive mechanism and the scrubber are disassembled together to package, whereby packaging space is saved.

In an example embodiment in which the scrubber is provided in the container with the scrubber rotary shaft being vertically disposed and the drive mechanism is an electric drive mechanism, optionally, the detachable connection manner between the electric drive mechanism and the container may include, but is not limited to, snap-fitting, or screw-fastening; or, a slide groove is provided on the container, and a slide fin is provided on the drive mechanism, the slide fin sliding into the slide groove.

In an example embodiment in which the scrubber is provided in the container with the scrubber rotary shaft being vertically disposed, optionally, to support the drive mechanism, a supporting mechanism may be provided on the container, the drive mechanism being supported on the supporting mechanism. The supporting mechanism may take on a form of support plate. If an anti-splash cover is provided on the container, the anti-splash cover may form the supporting mechanism. The output end of the drive mechanism is connected to the scrubber rotary shaft, in which case the scrubber rotary shaft may penetrate into the supporting mechanism or may not penetrate into the supporting mechanism.

Optionally, the anti-splash cover is detachably connected to the container, in which case the anti-splash cover may be shaped such that after being disassembled, it may be placed into the container so as to reduce the packaging size. Particularly, since the crank handle is supported on the anti-splash cover and the grip protrudes on the anti-splash cover, the removed anti-splash cover is placed into the container in such a manner that the backside of the anti-splash cover faces upward; in this way, the grip can be accommodated in the container, which further reduces the packaging size and also prevents the grip from being broken during transportation.

Optionally, a supporting mechanism may not be provided; instead, the drive mechanism is directly connected to the scrubber rotary shaft.

In an example embodiment in which the scrubber is provided in the container with the scrubber rotary shaft being vertically disposed and the drive mechanism is a manual drive mechanism, the detachable structure between the drive mechanism and the container may be snap-fitting or screw-fastening or the like; or, a slide groove may be provided on the container, and a slide fin is provided on the drive mechanism, where the slide fin slides into the slide groove.

In an example embodiment in which the scrubber is provided in the container with the scrubber rotary shaft being vertically disposed, optionally, the drive mechanism and the scrubber rotary shaft may be detachably connected, which enables separate removal of the drive mechanism. A simplest detachable connection manner between the drive mechanism and the scrubber rotary shaft is such that the cross section of the terminal end of the scrubber rotary shaft is polygonal, and a drive block is provided at an output end of the drive mechanism, where the drive block is a sleeve with a shape adapted to the terminal end of the scrubber rotary shaft, and by inserting the terminal end of the scrubber rotary shaft into the drive block, detachable connection between the scrubber rotary shaft and the drive mechanism is realized; in addition, the drive mechanism may smoothly drive the scrubber rotary shaft to rotate.

In an example embodiment in which the scrubber is provided in the container with the scrubber rotary shaft being vertically disposed, optionally, alternative connection mechanisms between the drive mechanism and the scrubber rotary shaft may include, but are not limited to, screw-fastening, snap-fitting, tight sleeve joint, etc.

In an example embodiment in which the scrubber is provided in the container with the scrubber rotary shaft being vertically disposed and a drive mechanism is provided, the drive mechanism and the scrubber rotary shaft may be set as follows therebetween:

Optionally, in an example embodiment in which the scrubber is provided in the container with the scrubber rotary shaft being vertically disposed, a drive mechanism is provided, and a supporting mechanism is provided on the container, an alternative manner of setting the scrubber rotary shaft is such that: no support shaft is provided on the bottom surface of the container, where the scrubber rotary shaft is connected to the drive mechanism and then suspended on the supporting mechanism.

In the example embodiment in which the drive mechanism is a manual drive mechanism in a crank handle form, optionally, a specific structure of suspending the scrubber rotary shaft on the supporting mechanism is such that the connecting portion on the handle body and the scrubber rotary shaft are integrally connected to implement suspension of the scrubber rotary shaft; the scrubber rotary shaft and the connecting portion on the handle body may be connected via a screw or other type of fastening elements; or, the scrubber rotary shaft and the connecting portion may be detachably connected, for example: a snap hook is provided on the connecting portion, and a mount is provided on the upper end of the scrubber rotary shaft, where the snap hook is snapped into the mount; the mount has a wide portion and a narrow portion, where the snap hook first enters via the wide portion of the mount, and after rotating a certain angle, the snap hook is positioned below the narrow portion of the mount, whereby the positioning is achieved; or, an insert-fitting stud is provided on the upper end of the scrubber rotary shaft, the connecting portion is an insert-fitting sleeve, a slot is provided on the insert-fitting stud, an insert-fitting block is provided in the insert-fitting sleeve, and a slide-in opening is provided on the insert-fitting sleeve, such that the insert-fitting stud slides into the insert-fitting sleeve via the slide-in opening and meanwhile the insert-fitting block slides into the insert-fitting sleeve, thereby realizing tight fitting.

Optionally, when the scrubber rotary shaft is suspended on the supporting mechanism, the scrubber may be set as such: the scrubber is adjustably distant from or closer to a sidewall of the container so as to be adapted to different sizes of fruits/vegetables, where for fruits/vegetables of smaller sizes, the scrubber is adjusted to be closer to the sidewall of the container; while for fruits/vegetables of larger sizes, the scrubber is adjusted to be distant from the sidewall of the container. A specific structural form to perform such adjustments may be: providing a strip-shaped slide groove on the supporting mechanism, the connecting portion on the handle body of the crank handle is snapped into the slide groove so as to slide reciprocally; therefore, the scrubber may slide at least closer to or away from the sidewall of the container.

In an example embodiment in which the scrubber is provided in the container with the scrubber rotary shaft being vertically disposed and the drive mechanism is a crank handle, optionally, another connecting manner between the connecting portion of the crank handle and the scrubber rotary shaft is such that a shaft stud is provided at an upper end of the scrubber rotary shaft and a connecting portion is provided on the handle body, where the connecting portion is connected to the shaft stud, whereby the drive mechanism brings the shaft stud to rotate via the connecting portion, thereby driving the scrubber rotary shaft to rotate.

Optionally, the connecting portion takes on a form of a shaft sleeve, which is generally disposed on the backside of the handle body and sleeved over the shaft stud.

Optionally, the shaft sleeve brings the shaft stud to rotate in such a manner that: a driven protrusion rib is provided at an outer sidewall of the shaft stud and a driving protrusion rib is provided on an inner sidewall of the shaft sleeve, where the shaft sleeve, after having been sleeved over the shaft stud, rotates till the driving protrusion rib engages the driven protrusion rib; in this way, the shaft stud may be brought to rotate, thereby driving the scrubber rotary shaft to rotate. Of course, the shaft sleeve and the shaft stud may also be connected in other manners such that the shaft sleeve drives the shaft stud to further drive the scrubber rotary shaft to rotate, e.g., screw-fastening therebetween.

Optionally, the shaft sleeve and the handle body may be connected by a screw or other fixing elements; or, a drive block is provided on the handle body, and a drive groove is provided on the shaft sleeve, such that by inserting the drive block into the drive groove, the crank handle may drive the shaft sleeve to rotate and further drive the entire scrubber rotary shaft to rotate; of course, the drive groove cannot take on a round form, but can take on a runway form or a square form; the form of the drive block is adapted to the drive groove. In this example embodiment, a screw may be additionally provided, which penetrates through the drive block and the drive groove to realize further secure connection.

Optionally, the shaft sleeve and the handle body may be one-piece formed.

Optionally, a shaft sleeve may be provided at the upper portion of the scrubber rotary shaft, and the connecting portion is a shaft stud, where the shaft sleeve is sleeved over the shaft stud; a driving protrusion rib is provided at an outer sidewall of the shaft stud, and a driven protrusion rib is provided at the inner sidewall of the shaft sleeve, such that by rotating the shaft sleeve, the driving protrusion rib abuts against the driven protrusion rib.

In an example embodiment in which the scrubber is provided in the container with the scrubber rotary shaft being vertically disposed and the drive mechanism is a crank handle, optionally, the connecting portion of the handle crank and the scrubber rotary shaft are connected in another manner such that the connecting portion of the handle body is connected to the crank handle rotary shaft, and the crank handle rotary shaft is in drive-enabled connection with the scrubber rotary shaft of the scrubber (where the drive-enabled connection means the crank handle rotary shaft may drive the scrubber rotary shaft to rotate).

Optionally, the scrubber rotary shaft and the crank handle rotary shaft are of an integral structure; or, the scrubber rotary shaft and the crank handle rotary shaft are standalone from each other.

In the case that the scrubber rotary shaft and the crank handle rotary shaft are standalone from each other, optionally, the crank handle rotary shaft abuts against the upper end of the scrubber rotary shaft.

Optionally, the crank handle rotary shaft abuts against the scrubber rotary shaft in such a manner that an abutting portion is provided at a lower end of the crank handle rotary shaft, the abutting portion abutting against an upper end surface of the scrubber rotary shaft.

Optionally, the abutting portion may refer to a lower end surface of the crank handle rotary shaft; in this case, the abutting portion may be formed as the lower end surface of the crank handle rotary shaft itself, where the lower end surface of the crank handle rotary shaft itself abuts against the upper end surface of the scrubber rotary shaft, whereby the scrubber rotary shaft is driven, via the crank handle rotary shaft, to rotate.

Optionally, the abutting portion may also protrude from a side portion of the crank handle rotary shaft; in this case, the side protrusion of the crank handle rotary shaft itself forms an abutting portion, where the side protrusion of the crank handle rotary shaft itself abuts against the upper portion of the scrubber rotary shaft, whereby the scrubber rotary shaft is driven, via the crank handle rotary shaft, to rotate. To enable the crank handle rotary shaft to drive the scrubber rotary shaft, a driving protrusion rib may be provided at a lower surface of the abutting portion, and a driven protrusion rib may be provided on an upper end surface of the scrubber rotary shaft, where the crank handle rotates to bring the driving protrusion rib to abut against the driven protrusion rib, thereby bringing the scrubber rotary shaft to rotate.

Optionally, the abutting portion may also be formed in a such manner that a connecting sleeve is sleeved at the lower end of the crank handle rotary shaft, where the lower end of the connecting sleeve may form the abutting portion. To achieve a more effective abutting, a ring-shaped protrusion may be provided at a lower end of the connecting sleeve, where the ring-shaped protrusion acts as the abutting portion to abut against the upper end of the scrubber rotary shaft.

Optionally, the lower end of the crank handle rotary shaft abuts against the upper end of the scrubber rotary shaft in another manner such that a recessed groove is provided at the upper end of the scrubber rotary shaft, and a connecting head is provided at the lower end of the crank handle rotary shaft, where the connecting head projects into the recessed groove to abut against a wall surface of the recessed groove. To facilitate the crank handle rotary shaft to drive the scrubber rotary shaft, a driving protrusion rib is provided on the connecting head, and a driven protrusion rib is provided in the recessed groove, where the crank handle rotates to cause the driving protrusion rib to abut against the driven protrusion rib, thereby bringing the scrubber rotary shaft to rotate; the driving protrusion rib is generally provided on a sidewall of the connecting head, and the driven protrusion rib is generally provided on an inner sidewall of the recessed groove. Of course, the driving protrusion rib may also be provided on the underside of the connecting head, in which case the driven protrusion rib is provided on the bottom surface of the recessed groove.

In an example embodiment in which the scrubber is provided in the container with the scrubber rotary shaft being vertically disposed and the drive mechanism is a crank handle supported on the supporting mechanism, optionally, a friction reducing mechanism may be provided between the handle body of the crank handle and the supporting mechanism to reduce friction therebetween. The friction reducing mechanism may be a rolling mechanism (e.g., a rolling body) or a lubricating mechanism (e.g., lubricating grease), etc., preferably the rolling mechanism, where a plane bearing is preferably adopted in the rolling mechanism. Of course, a rolling mechanism such as a ball may also be adopted. In the case that the supporting mechanism is an anti-splash cover, the friction reducing mechanism is disposed between the anti-splash cover and the front surface of the handle body; in the case that the friction reducing mechanism selects the plane bearing, a receiving groove is provided on the anti-splash cover, and the plane bearing is disposed in the receiving groove; this avoids displacement of the plane bearing, and meanwhile the handle body may also be disposed in the receiving groove so as to keep in flush with the anti-splash cover.

In an example embodiment in which the scrubber is provided in the container with the scrubber rotary shaft being vertically disposed and the drive mechanism is a crank handle supported on the supporting mechanism, in order to reduce friction between the crank handle and the supporting mechanism, optionally, the crank handle is disposed over the supporting mechanism, and a gap is formed between the portion of the handle body other than its connecting portion and the supporting mechanism. The gap between the portion of the handle body other than its connecting portion and the supporting mechanism is formed in two possible ways: firstly, a gap is formed between the entirety of the handle body and the supporting mechanism, and secondly, the connecting portion of the handle body contacts the supporting mechanism, such that a gap is present between the portion of the handle body other than the connecting portion and the supporting mechanism.

Optionally, a structural form of the gap between the entirety of the handle body and the supporting mechanism is such that the scrubber rotary shaft is rotatably supported in the container; as noted above, the scrubber rotary shaft is sleeved outside the support shaft, or the scrubber rotary shaft is supported on the support shaft; in this case, under support of the support shaft, the scrubber may be propped up; meanwhile, since the scrubber rotary shaft of the scrubber is connected to the output end of the handle body, the handle body is also propped up (if the scrubber rotary shaft and the crank handle rotary shaft are separately provided, a usual case is that the scrubber rotary shaft of the scrubber abuts against or is connected to the crank handle rotary shaft of the handle body, whereby the crank handle rotary shaft of the handle body is propped up; if the scrubber rotary shaft and the crank handle rotary shaft are one-piece formed, the scrubber rotary shaft naturally props up the crank handle rotary shaft), whereby a gap is formed between the entirety of the handle body and the supporting mechanism; in this case, since the handle body is provided on the supporting mechanism, the supporting mechanism plays a role of supporting the handle body; however, on washing the fruits/vegetables, the handle body is actually supported by the scrubber.

Optionally, the connecting portion of the handle body contacts the supporting mechanism, and a gap is formed between the portion of the handle body other than the connecting portion and the supporting mechanism: since the connecting portion of the handle body abuts against the supporting mechanism, the handle body is supported on the supporting mechanism. Optionally, the handle body protrudes downward to form the connecting portion or, a boss protruding upward is provided on the supporting mechanism, the boss being urged against the connecting portion of the handle body, whereby a gap is naturally formed between the portion of the handle body other than the connecting portion and the supporting mechanism.

In an example embodiment in which the scrubber is provided in the container with the scrubber rotary shaft being vertically disposed, when the grip of the crank handle is gripped by hand to turn, the crank handle likely sways. To prevent sway of the crank handle, a limiting mechanism for limiting sway of the handle crank may be provided on the supporting mechanism.

Optionally, the limiting mechanism refers to a stop sleeve disposed on the supporting mechanism, the connecting portion of the handle body being adapted to the stop sleeve, the stop sleeve being sleeved outside the connecting portion to thereby limit the connecting portion; in the case that the connecting portion is a shaft sleeve, the stop sleeve may be respectively provided at the front surface and the back surface of the anti-splash cover so as to limit the connecting portion, whereby sway of the crank handle is better prevented.

Optionally, the limiting mechanism refers to a stop sleeve disposed on the supporting mechanism, and the crank handle rotary shaft and/or scrubber rotary shaft can be at least partially accommodated in the stop sleeve.

In the specification, terms such as “example embodiment” and “example” intend to express that a specific feature, structure, material or characteristic described in an example embodiment or example is included in at least one example embodiment or example of the disclosure. In the specification, the illustrative description of such terms does not refer to the same example embodiment or example. Moreover, the specific features, structures, materials or characteristics as described may be combined appropriately in any one or more example embodiments or examples.

The implementation manners of the disclosure have been illustrated above. However, the disclosure is not limited to the implementations above. Any modifications, equivalent substitutions, and improvements made within the spirits and principle of the disclosure shall all fall within the protection scope of the disclosure.

### Example Embodiment 1

Referring to FIGS. 1, 2, 3, and 4, a fruit and vegetable washing apparatus comprising a container 1001, a circulation-driving mechanism, and a scrubber 1002.

A circulation passage is formed in the container 1001, the circulation passage comprising a fruits/vegetables flowing and staging zone 1003 and a brush washing zone 1004, where on washing the fruits/vegetables, the circulation passage can provide a passageway for wash water and the fruits/vegetables to circulate between the fruits/vegetables flowing and staging zone 1003 and the brush washing zone 1004.

The scrubber 1002 is disposed in the brush washing zone 10044, such that on washing the fruits/vegetables, the scrubber 1002 can brush the fruits/vegetables passing thereby.

The circulation-driving mechanism is configured to provide a driving force to drive the wash water and the fruits/vegetables to circulate in the circulation passage when washing the fruits/vegetables, such that the fruits/vegetables pass through the brush washing zone sequentially so as to be brushed. The sequentially passing may refer to individual fruits/vegetables passing one by one or a plurality of fruits/vegetables passing together. Those skilled in the art will appreciate that on washing the fruits/vegetables, a specific sequential passing manner is dependent on size and quantity of the fruits/vegetable, e.g., if the fruits/vegetables have a relatively large size, it is likely that the fruits/vegetables pass one by one; if the fruits/vegetables have a relatively small size, a plurality of items of fruits/vegetables may pass together; of course, in the latter case, the fruits/vegetables may also pass individually.

When the wash water is driven by the circulation-driving mechanism to circulate, the wash water mainly circulates along a wall surface of the container 1001, such that a dead water zone (where the wash water substantially stands still) likely exists between the parallel arranged brush washing zone 1004 and fruits/vegetables flowing and staging zone 1003; once the fruits/vegetables enter the dead water zone, they cannot circulate with the circulating wash water and thus cannot be brushed by the scrubber 1002. To solve this problem, a baffle part 1010 may be provided in the container 1001, where the circulation passage extends surrounding the baffle part 1010. The baffle part 1010 may substantially eliminate the dead water zone; even not completely eliminating the dead water zone, the baffle part 1010 may at least significantly reduce the extent of the dead water zone.

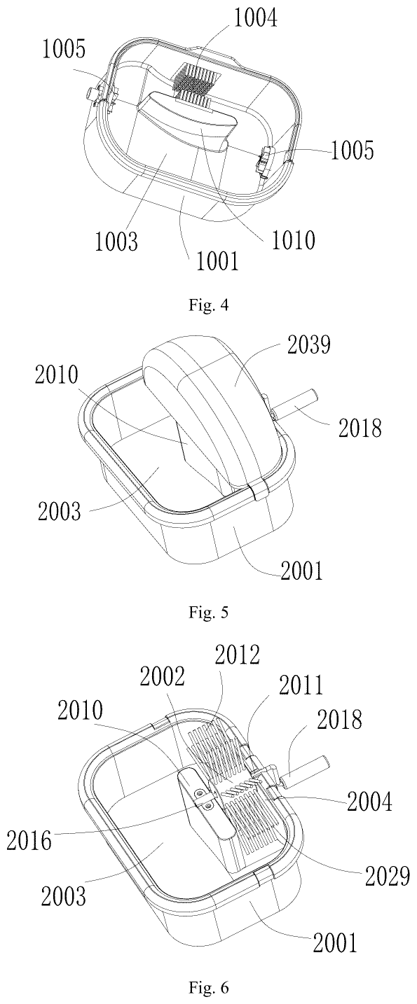

In this example embodiment, the circulation-driving mechanism may adopt a structure of rotating impeller 1005, where the wash water is driven to circulate by rotation of the rotating impeller 1005, thereby carrying the fruits/vegetables to circulate. Of course, an alternative mechanism known to those skilled in the art, e.g., a water pump, may also be adopted, so long as it may drive the wash water and the fruits/vegetables to circulate in the circulation passage. The circulation-driving mechanism may be provided on a sidewall of the container 1001, which may be provided on one sidewall, or may be provided on a plurality of sidewalls to facilitate the wash water to flow more smoothly with added energy. Furthermore, the circulation-driving mechanism may be provided on two adjacent or opposite sidewalls, respectively, or provided on any three sidewalls or even on each sidewall, respectively; moreover, one or more rotating impellers 1005 may be provided at respective sidewalls. Those skilled in the art will appreciate that the driving forces provided by respective rotating impellers 1005 are in the same direction. Of course, in some example embodiments, it is also feasible that the driving force direction of some rotating impeller 1005 is different from that of other rotating impellers 1005. In the example embodiment illustrated in FIGS. 1 and 2, or in the example illustrated in FIGS. 3 and 4, the circulation-driving mechanism adopts the rotating impeller 1005. To facilitate the wash water to flow more smoothly and forcibly, the rotating impeller 1005 may be provided at any two sidewalls of the container 1001. In an example implementation, as illustrated in FIGS. 1 and 2 or as illustrated in FIGS. 3 and 4, the rotating impeller 1005 may be provided at two opposite sidewalls of the container, where the rotating direction of the rotating impeller 1005 provided at one sidewall is reverse to that of the rotating impeller provided at the opposite sidewall, such that the directions of the driving forces provided by the rotating impellers 1005 disposed at respective sidewalls are consistent. Meanwhile, to protect the fruits/vegetables from being hit by the rotating impellers 1005, a protective case 1006 may be provided outside each rotating impeller.

In this example embodiment, the scrubber takes on such a form that: as illustrated in FIG. 1 and FIG. 2, the scrubber comprises a backplate 1007, and a brushing element 1008 disposed on a first surface of the backplate 1007, where the brushing element 1008 is oriented to face the inside of the container 1. The brushing element 1008 may be a plastic flexible cleaning element, or a soft plastic flexible cleaning element, or a fabric strip flexible cleaning element, or other type of flexible brushing parts. To enhance the brushing effect, the brushing element 1008 is also disposed on the bottom surface of the brush washing zone 1004 of the container. In this example, the brushing element 1008 on the first surface of the backplate 1007 contacts the brushing element 1008 on the bottom surface of the brush washing zone 1004, or a gap is present therebetween.

In another example embodiment, the scrubber takes on such a form that: as illustrated in FIG. 3 and FIG. 4, the scrubber refers to a cleaning element 1009 provided on a side surface and/or a bottom surface of the container 1001. The cleaning element 1009 may be a plastic flexible cleaning element, or a soft plastic brushing element, or a fabric strip flexible cleaning element, or other flexible brushing parts. In the case that a baffle part 1010 is provided in the container, the cleaning element 1009 may also be provided on the baffle part 1010.

### Example Embodiment 2

Referring to FIGS. 5-61, a fruit and vegetable washing apparatus comprises a container 2001, a circulation-driving mechanism, and a scrubber 2002.

A circulation passage is formed in the container 2001, the circulation passage comprising a fruits/vegetables flowing and staging zone 2003 and a brush washing zone 2004, where on washing the fruits/vegetables, the circulation passage can provide a passageway for wash water and the fruits/vegetables to circulate between the fruits/vegetables flowing and staging zone 2003 and the brush washing zone 2004.

The scrubber 2002 is disposed in the brush washing zone 2004, such that on washing the fruits/vegetables, the scrubber 2002 can brush the fruits/vegetables passing thereby. In this example embodiment, the scrubber 2002 is disposed on the container 2001 with a scrubber rotary shaft being transversely disposed, where the space occupied by the scrubber 2002 in the container is referred to as the brush washing zone 2004. The scrubber 2002 comprises a scrubber rotary shaft 2011 and a brushing portion 2012 disposed on the scrubber rotary shaft 2011, the brushing portion 2012 extending towards a direction away from the scrubber rotary shaft 2011 such that when circulating in the circulation passage, the fruits/vegetables can pass between the scrubber 2002 and the bottom surface of the container 2001 to be thereby brushed. With the scrubber rotary shaft 2011 provided, the scrubber 2002 of this structural form may rotate with the scrubber rotary shaft 2011 as the central axis; therefore, the scrubber 2002 may constitute the circulation-driving mechanism, where on washing the fruits/vegetables, the scrubber 2002 can be rotated to provide a driving force for driving the wash water and the fruits/vegetables to circulate in the circulation passage.

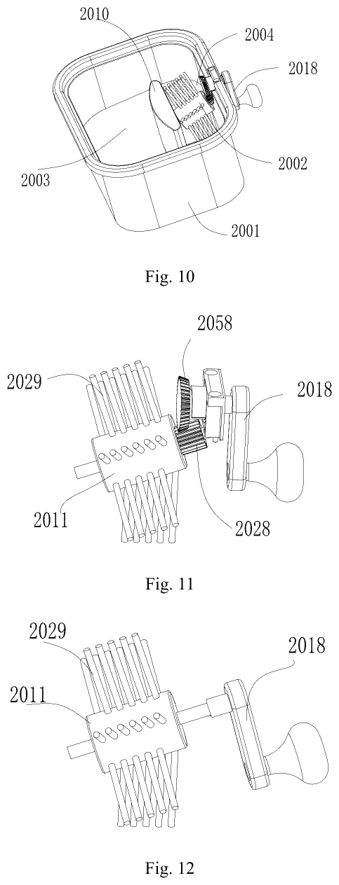

When the scrubber 2002 is rotating to bring the wash water to circulate, the wash water preferably flows along a sidewall formation direction of the container 2001, and the wash water flowing in such a manner will not obliquely impact the sidewalls of the container 2001, such that the dynamic force of flowing forward will not be lost. Therefore, the axial direction of the scrubber rotary shaft 2011 is preferably substantially vertical to the flow direction of the wash water in the container 2001, i.e., the axis of the scrubber rotary shaft 2011 is substantially parallel to the horizontal plane, i.e., “the scrubber rotary shaft being vertically arranged” as noted above. Here, the “substantially vertical” between the axis of the scrubber rotary shaft 2011 and the flow direction of the wash water in the container 2001 refers to substantially vertical engineeringly, and a reasonable angle falls within the concept of vertical, which does not require “absolutely vertical” geometrically. Even if there exists a certain included angle between the axis of the scrubber rotary shaft 2011 and the horizontal plane, it also falls within the extent of the meaning of “the scrubber rotary shaft being vertically disposed” in this example embodiment. As illustrated in FIGS. 10, 11, and 12, the scrubber rotary shaft 2011 is not absolutely vertical to the flow direction of the wash water, while the obliquely oriented scrubber rotary shaft 2011, when rotating, may still bring the wash water in the container 2001 to circulate in the circulation passage, and the flow direction of the wash water also flows substantially along the sidewalls of the container. In FIGS. 10, 11, and 12, the scrubber rotary shaft 2011 is driven by a crank handle 2018, where the scrubber rotary shaft 2011 and the crank handle 2018 may be connected in two manners: one manner is illustrated in FIGS. 10 and 11, where a bevel gear 2058 is provided at an output end of the crank handle 2018, a driven gear 2028 is provided on the scrubber rotary shaft 2011, and the bevel gear 2058 and the driven gear 2028 are engaged, such that by turning the crank handle 2018, the scrubber 2002 is brought to rotate, in which case the rotation axis of the output end of the crank handle 2018 is still parallel to the horizontal plane, offering a comfort manipulation when turning the crank handle 2018; the other manner is illustrated in FIG. 12, where the crank handle 2018 is directly connected to the rotary shaft 2011, in which case the rotation axis of the output end of the crank handle 2018 is co-axial with the scrubber rotary shaft 2011, offering an easy installation but a somewhat inconvenient manipulation.

The circulation-driving mechanism is configured to provide a driving force which drives the wash water and the fruits/vegetables to circulate in the circulation passage when washing the fruits/vegetables, such that the fruits/vegetables pass through the brush washing zone sequentially so as to be brushed. The sequentially passing may refer to individual fruits/vegetables passing one by one or a plurality of fruits/vegetables passing together. Those skilled in the art will appreciate that on washing the fruits/vegetables, a specific sequential passing manner is dependent on size and quantity of the fruits/vegetable, e.g., if the fruits/vegetables have a relatively large size, it is likely that the fruits/vegetables pass one by one; if the fruits/vegetables have a relatively small size, a plurality of items of fruits/vegetables may pass together; of course, in the latter case, the fruits/vegetables may also pass individually.

Upon operation, the fruits or vegetables are fed in the container 2001. Generally, since the scrubber 2002 disposed in the brush washing zone 2004 will occupy the accommodation space in the brush washing zone 2004, the to-be-washed fruits/vegetables are usually first placed in the fruits/vegetables circulating and staging zone 2003. When the wash water (which may be water or other liquid, or a mixture of other substance and water) is filled in the container 2001, under the action of the rotating scrubber, the wash water carries the fruits/vegetables to flow from the fruits/vegetables circulating and staging zone 2003 to the brush washing zone 2004 and then flows back from the brushing zone 2004 to the fruits/vegetables circulating and staging zone 2003, whereby a circulation path featuring a journey from the fruits/vegetables flowing and staging zone 2003 to the brush washing zone 2004 and then back to the fruits/vegetables flowing and staging zone 2003 is formed in the circulation passage. While the fruits/vegetables carried by the wash water are flowing through the brush washing zone 2004, the scrubber 2002 rubs the fruits/vegetables, whereby the fruits/vegetables are brushed. When the fruits/vegetables are located in the wash water, soaking of the fruits/vegetables in the wash water facilitates cleaning of the dirt on the fruit/vegetable surfaces. In the case that the fruits/vegetables flow at a speed different from that of the wash water, the wash water may flush fruit/vegetable surfaces. When the fruits/vegetables enter the brush washing zone 2004 from the fruits/vegetables flowing and staging zone 2003, they may access the brush washing zone one by one or batch by batch (i.e., sequentially), such that the scrubber 2002 brushes the fruits/vegetables sequentially, yielding a homogeneous, orderly, effective cleaning. The fruits/vegetables washed in the container 2001 experience a repeated, cyclical brushing procedure of first entering the brush washing zone 2004 for being brush washed, then flowing into the fruits/vegetable flowing and staging zone 2003 for being flushed, and then flowing back into the brush washing zone 2004 for being brush washed; during the washing process, brushing and flushing occur alternately such that the fruits/vegetables may not only be brushed, but also be flushed by the wash water. In addition, after being soaked and flushed, the residual dirt on the fruits/vegetables are more easily removed by the scrubber 2002 in the brush washing zone 2004. The above benefits are achieved through cooperation of the following three features: the container 2001 having a fruits/vegetables flowing and staging zone 2003 and a brush washing zone 2004 which are in communication, the brush washing zone 2004 having a scrubber 2002 disposed therein, and the circulation-driving mechanism driving the wash water and the fruits/vegetables to flow and circulate in the circulation passage.

Meanwhile, since the brush washing zone 2001 and the fruits/vegetables flowing and staging zone 2003 in the container 2001 of the disclosure are in communication, during the washing process, the to-be-washed fruits/vegetables are brush washed by the scrubber 2002 in the brush washing zone 2004 and flow with the wash water in the fruits/vegetables flowing and staging zone 2003, without fierce agitations and severe collisions between the fruits/vegetables and/or between the fruits/vegetables and the container during the whole process. Since the fruits/vegetables circulate in the container 2001 throughout the washing process, the amount of the fruits/vegetables fed into the container 2001 should be appropriate based on the capacity of the fruits/vegetables flowing and staging zone 2003, so long as they do not affect washing of the fruits/vegetables. To feed the fruits/vegetables in the fruit and vegetable washing apparatus, the fruits/vegetables are usually fed into the fruits/vegetables flowing and staging zone 2003. The example of first feeding the to-be-washed fruits/vegetables in the fruits/vegetables flowing and staging zone 2003 has been illustrated above; of course, it is also allowed to first feed part or all of the to-be-washed fruits/vegetables in the brush washing zone 2004. Discharging of the fruits/vegetables generally occurs in the fruits/vegetables flowing and staging zone 2003 so as to avoid obstruction by the scrubber 2002 disposed in the brush washing zone 2004. Of course, in some example embodiment of the disclosure, the fruits/vegetables may also be discharged from the brush washing zone 2004.

As to the volume relationship between the brush washing zone 2004 and the fruits/vegetables flowing and staging zone 2003, it is preferable that the volume available for fruits/vegetables of the brush washing zone 4 is smaller than that of the fruits/vegetables flowing and staging zone 3, such that more fruits/vegetables may be placed in the fruits/vegetables flowing and staging zone 3, and meanwhile the fruits/vegetables in the brush washing zone 4 may also be controlled within a certain extent, which ensures that the fruits/vegetables pass smoothly through the brush washing zone 4 while preventing jam caused by excessive fruits/vegetables passing through the brush washing zone 4. The “volume available for fruits/vegetables of the brush washing zone” here refers to the volume of fruits/vegetables accommodatable in the brush washing zone 4 under a normal washing circumstance, i.e., the volume of the brush washing zone 4 after deducting the space occupied by the scrubber 2.

The scrubber rotary shaft 2011 may take on various forms, e.g., a monolithic shaft body, or the scrubber rotary shaft 2011 comprising a main shaft 2045 and a shaft sleeve 2046 sleeved over the main shaft 2045, the brushing portion 2012 being disposed on the shaft sleeve 2046, where the main shaft 2045 and the shaft sleeve 2046 may be connected by snap-fitting, threaded-fastening, interference sleeve coupling, or the like. The main shaft 2045 is generally made of metal, and the shaft sleeve 2046 is generally made of plastics; in this case, the main shaft 2045 and the shaft sleeve 2046 may also be connected in such a manner: a toothed pattern 2047 is provided at an end portion of the main shaft 2045 to form a rough portion, the shaft sleeve 2046 is sleeved over the main shaft 2045, and the rough portion of the main shaft 2045 is tightly fitted with the shaft sleeve 2046 such that a portion of the shaft sleeve 2046 corresponding to the rough portion of the main shaft 2045 has a certain deformation, whereby the main shaft 2045 and the shaft sleeve 2046 are tightly engaged to form the entire body of the rotary shaft.

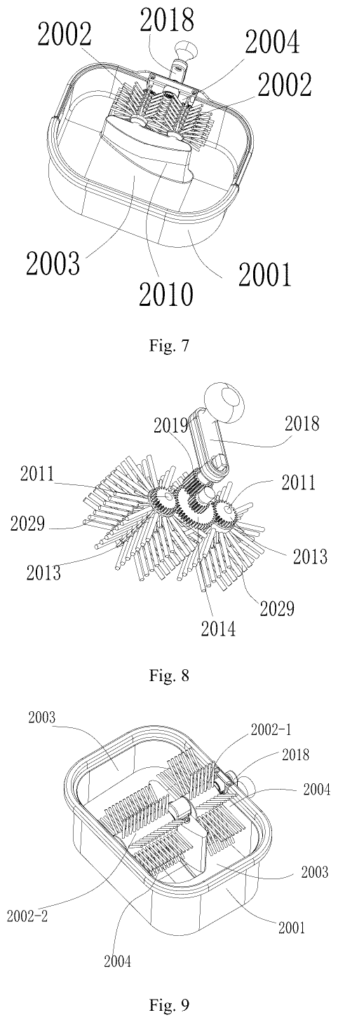

There may be provided only one scrubber 2002; or a plurality of scrubbers 2002 are arranged in juxtaposition, where the brush washing zones 2004 are formed to correspond to the scrubber 2002. As illustrated in FIGS. 7 and 8, the plurality of scrubbers 2002 may be linked such that the plurality of scrubbers 2002 may rotate synchronously. A linking mechanism between the plurality of scrubbers may include, but is not limited to, a gear transmission mechanism, a chain transmission mechanism, or a belt transmission mechanism. The linking mechanism illustrated in FIGS. 7 and 8 is a gear transmission mechanism. In FIGS. 7 and 8, there are illustrated two scrubbers 2002, where a driven gear 2013 is provided on the scrubber rotary shaft of the two scrubbers 2003, respectively, and a transitional gear 2014 is provided between the two driven gears 2013, such that under the action of the transitional gear 2014, the scrubber rotary shafts 2011 on the two scrubbers rotate synchronously; to rotate the two scrubbers 2002, the transitional gear 2014 is rotated to drive the two scrubber rotary shafts 2011 to rotate synchronously, where the transitional gear 2014 may be driven by the drive mechanism as will be described later. In the case that a plurality of the scrubbers 2002 are provided, the brush washing zones are arranged in one-to-one correspondence with the scrubbers, where the brush washing zones are arranged in continuity or with an interval. Or, one or more brush washing zone are provided, and one or more scrubbers are arranged in each brush washing zone.

The scrubbers 2002 may also be configured such that the scrubbers 2002 comprise a first scrubber 2002-1 and a second scrubber 2002-2 which are oriented to face each other, as illustrated in FIG. 9, thereby forming two brush washing zones 2004 facing each other, which enhances the cleaning efficiency. It is preferable that the first scrubber 2002-1 and the second scrubber 2002-2 are connected via a reversing mechanism such that the first scrubber 2002-1 and the second scrubber 2002-2 have opposite rotating directions, which forms a smooth circulation of the wash water in the circulation passage. The reversing mechanism may adopt a typical reversing mechanism, e.g., the rotary shaft of the first scrubber 2002-1 is provided with a first duplex gear, and the rotary shaft of the second scrubber 2002-2 is provided with a second duplex gear, the first duplex gear and the second duplex gear being engaged.

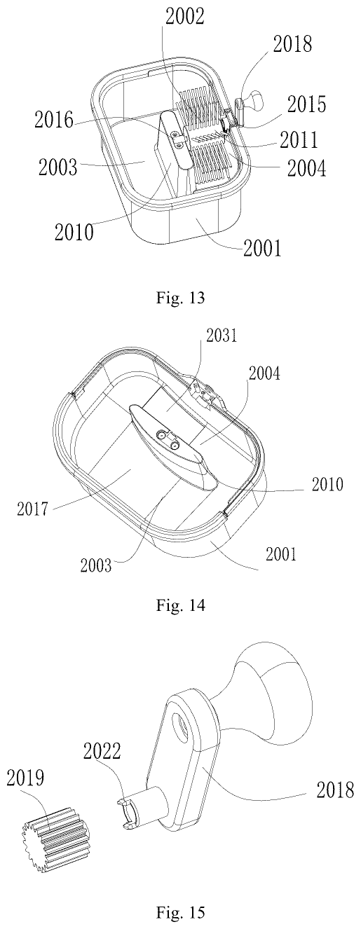

The scrubber 2002 is preferably detachably provided on the container 2001 so as to facilitate replacing the scrubber 2002 or removing the scrubber 2002 for cleaning purpose. The detachable connection manner between the scrubber 2002 and the container 2001 may be such that a stopper block 2015 is provided at the upper edge of the container 2001, where the scrubber rotary shaft 2011 of the scrubber is propped up between the stopper block 2015 and the upper edge of the container 2001, as illustrated in FIGS. 13 and 14, where the stopper block 2015 and the container 2001 are screw-fastened therebetween, and by unscrewing the screw, the scrubber 2002 may be removed. Or, as illustrated in FIG. 6, the scrubber rotary shaft 2011 of the scrubber is directly propped up on the upper end of the container, such that in case of a need to dismount, it is only needed to lift it up. As will be described later, if the baffle part 2010 is provided in the container 2001, the terminal end of the scrubber rotary shaft 2011 of the scrubber may be attached onto the baffle part 2010, where to make the scrubber detachable, the terminal end of the scrubber rotary shaft 2011 may be directly propped up on the baffle part 2010, or a second stopper block 2016 is provided on the upper edge of the baffle part 2010, and the scrubber rotary shaft 11 of the scrubber is propped up between the second stopper block 2016 and the upper edge of the baffle part 2010, the second stopper block 2016 and the baffle part 2010 being screw-fastened, where to remove the scrubber, it is only needed to unscrew the screw. Of course, other detachable connections may also be adopted between the scrubber and the container, e.g., a positioning block is provided on the scrubber rotary shaft, where the positioning block and the container are snap-fitted or screw-fastened.

The corners of the container 2001 are arcuately chamfered. Spiked corners of the container 2001 would cause difficulty in cleaning dirt buildup in corners of the container 2001. In addition, the arcuately chamfered corners of the container 2001 unlikely cause damages to the fruits/vegetables flowing with the wash water. Moreover, smooth flowing of the circulating wash water along the arcuately chamfered corners also achieves less loss of kinetic energy at the corners of the container 2001.

As a preferable design, the bottom surface of the fruits/vegetables flowing and staging zone 2003 is provided with a slope 2017, such that when the fruits/vegetables flow out of the brush washing zone 2004 into the fruits/vegetables flowing and staging zone 2003, they flow from the higher portion of the slope 2017 towards the lower portion of the slope 2017, whereby flowing of the fruits/vegetables is accelerated to prevent jam of the fruits/vegetables in the fruits/vegetables flowing and staging zone 2003.

The scrubber rotary shaft 2001 may be gripped by hand to actuate the scrubber 2002 to rotate. Of course, it is preferable that the scrubber rotary shaft 2011 is connected to a drive mechanism driving it to rotate, where the drive mechanism drives the scrubber rotary shaft 2011 to rotate, thereby bringing the scrubber 2002 to rotate. The drive mechanism may be an electric drive mechanism or a manual drive mechanism. The drive mechanism is generally disposed outside the container so as to facilitate manipulation. The electric drive mechanism adopts, for example, an electric motor, where an output end of the electric motor is connected to the rotary shaft. The manual drive mechanism adopts, for example, a crank handle 2018, where an output end of the crank handle 2018 is connected to the scrubber rotary shaft 2011; the distance between the lowest posture of the crank handle 2018 and the bottom surface of the container 2001 is preferably controlled between 1.5 cm and 8 cm such that a space for accommodating hand is reserved between the lowest posture of the crank handle and the desktop, whereby the hand gripping the crank handle 2018 will not hit the desktop when turning the crank handle 2018.

The crank handle 2018 and the rotary shaft 2011 may be directly connected or may be connected via a connection structure, e.g., a gear transmission mechanism.

The drive mechanism is best detachably connected onto the container 2001, such that when packaging, the drive mechanism and the scrubber 2002 are disassembled together to package, whereby packaging space is saved.

In the case that the drive mechanism is an electric drive mechanism, the detachable connection manner between the electric drive mechanism and the container may include, but is not limited to, snap-fitting, or screw-fastening; or, a slide groove is provided on the container, and a slide fin is provided on the drive mechanism, the slide fin sliding into the slide groove.

In the case that the drive mechanism is a manual drive mechanism, the detachable structure between the drive mechanism and the container may be snap-fitting or screw-fastening or the like; or, a slide groove may be provided on the container, and a slide fin is provided on the drive mechanism, where the slide fin slides into the slide groove.

An alternative detachable connection manner between the drive mechanism and the container just requires detachable connection between the scrubber rotary shaft 2011 and the container 2001 since the drive mechanism is connected to the scrubber rotary shaft 2011, where the detachable connection manner between the scrubber rotary shaft 2011 and the container 2001 is just as described above.

The detachable connection may also be applied between the drive mechanism and the scrubber rotary shaft 2011, which enables separate removal of the drive mechanism. A simplest detachable connection manner between the drive mechanism and the scrubber rotary shaft 2011 is such that the terminal end of the scrubber rotary shaft 2011 has a polygonal cross section, and a shaft sleeve is provided at the output end of the drive mechanism, where the shaft sleeve is a sleeve with a shape adapted to the shape of the terminal end of the scrubber rotary shaft 2011; in this way, the detachable connection between the rotary shaft and the drive mechanism is simply implemented by inserting the terminal end of the scrubber rotary shaft 2011 into the shaft sleeve, whereby the drive mechanism may smoothly drive the scrubber rotary shaft to rotate.

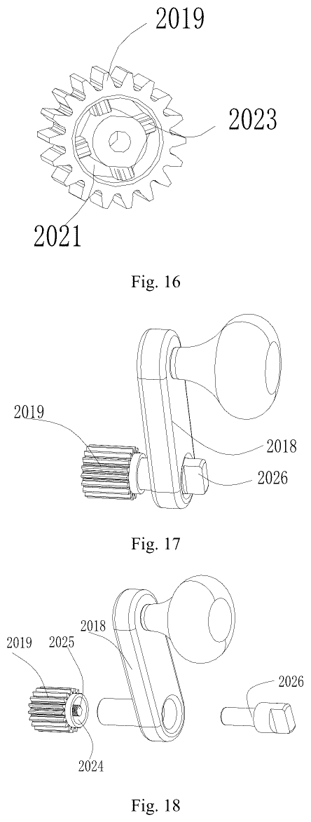

Further alternative detachable connection manners may also be applied between the drive mechanism and the scrubber rotary shaft 2011. For example, as illustrated in FIGS. 15-21, a driven gear 2028 is provided on the scrubber rotary shaft 2011, a driving gear 2019 is provided at the output end of the crank handle 2018, the driving gear 2019 is engaged with the driven gear 2028 provided on the scrubber rotary shaft 2011, and a gear chamber 2020 is provided at the upper end of the container 2011, where the driving gear 2019 and the driven gear 2028 on the scrubber rotary shaft 2011 are disposed (completely or partially) in the gear chamber 2020, whereby the driving gear 2019 and the crank handle 2018 are detachably connected. FIGS. 15 and 16 illustrate a detachable connection manner between the driving gear 2019 and the crank handle 2018, where the driving gear 2019 has a disassembly cavity 2021 in which a stop rib 2023 is provided, and a protrusion rib 2022 is provided at the terminal end of the crank handle 2018, where the terminal end of the crank handle 2018 is inserted into the disassembly cavity 2021, and by turning the crank handle 2018, the protrusion rib 2022 and the stop rib 2023 abut against each other, whereby the crank handle 2018 drives the driving gear 2019 to rotate; in this way, by just pulling the crank handle 2018 out of the gear chamber 2020, the crank handle 2018 is removed. In FIGS. 17, 18, and 19, the detachable connection manner between the driving gear 2019 and the crank handle 2018 may also be such that the driving gear 2019 has a cavity 2024 in which a screw rod 2025 is provided, the screw rod 2025 is inserted into the crank handle 2018, and meanwhile a locking rod 2026 also penetrates through the crank handle 2018 into the cavity of the driving gear 2019, where the locking rod 2026 has a threaded cavity 2027, and the screw rod 2025 is screwed into the threaded cavity 2027, the terminal end of the locking rod 2026 being locked on the crank handle 2018; in this way, connection between the crank handle 2018 and the driving gear 2019 is realized, and to remove the crank handle 2018, it is only needed to unscrew the locking rod 2026.

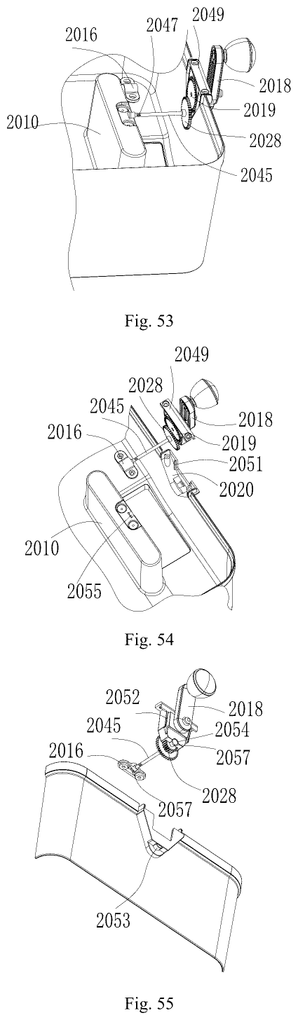

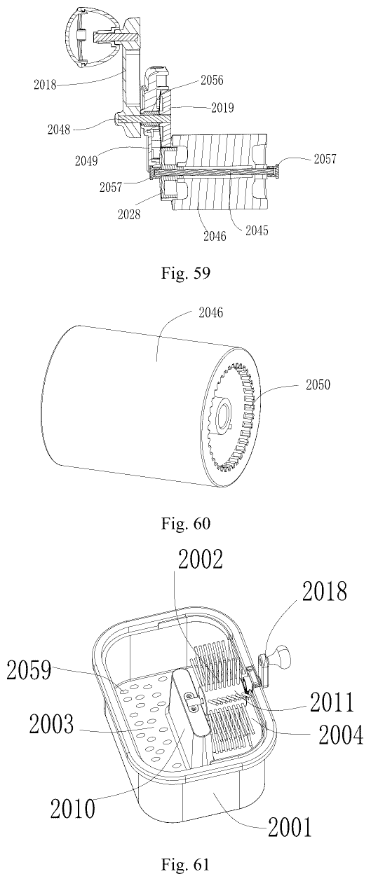

A further detachable connection mechanism may be applied between the drive mechanism and the scrubber rotary shaft 2011, for example, as illustrated in FIGS. 52-60, where the scrubber rotary shaft 2011 comprises a main shaft 2045 and a shaft sleeve 2046 sleeved over the main shaft 2045, a driven gear 2028 being provided on the main shaft 2045 of the scrubber rotary shaft 2011, where the driven gear 2028 is disposed at the outer end of the main shaft 2045 and the toothed pattern 2047 on the main shaft 2045 is provided at the inner end of the main shaft 2045. The crank handle 2018 as the drive mechanism is provided with a drive shaft 2048 at one end thereof, a driving gear 2019 is provided on the drive shaft 2048, and the drive shaft 2048 penetrates through a drive fixed block 2049 to enable the drive shaft 2048 to be rotatable, where the driving gear 2019 is engaged with the driven gear 2028, and by turning the crank handle 2018, the driven gear 2028 may be driven by the driving gear 2019, whereby the scrubber rotary shaft 2011 is driven to rotate. As illustrated in FIGS. 58 and 59, the driven gear 2028 may be a typical gear only having one circle of toothed surface; in this case, the driving gear 2019 drives the driven gear 2028 and further drives the main shaft 2045 of the scrubber rotary shaft 2011 to rotate, whereby the scrubber rotary shaft 2011 may be rotated in its entirety; meanwhile, a geared ring 2050 may be further provided at the inner side of the shaft sleeve 2046, where a portion of the driven gear 2028 is engaged with the driving gear 2019, and a portion of the driven gear 2028 is further meshed with the geared ring 2050 of the shaft sleeve 2046. As illustrated in FIGS. 53-59, the driven gear 28 may also be a duplex gear, where a first stage of the duplex gear is engaged with the driving gear 19, a geared ring 2050 being provided at the inner side of the shaft sleeve 2046; and a second stage of the duplex gear is engaged with the geared ring 2050; when this example mechanism is adopted, one end of the shaft sleeve 2046 and the main shaft 2045 are tightly fitted via the toothed pattern 2047, while the other end of the sleeve shaft 2046 is meshed with the driven gear 2028; in this way, both ends of the shaft sleeve 2046 are positioned, rendering the sleeve shaft 2046 more stable during rotating. A gear chamber 2020 is provided at the upper end of the sidewall of the container 2001, the driving gear 2019 and the driven gear 2028 are both located in the gear chamber 2020 (the driven gear 2028 may be completely or partially disposed in the gear chamber 2020), and the drive fixed block 2049 is detachably mounted in the gear chamber 2020; in this way, the drive fixed block 2049, the driving gear 2019, and the drive shaft 2048 form an assembly that is detachable in its entirety, i.e., in case of disassembly, it is only needed to remove the drive fixed block 2049; and the installation is also very convenient, where it is only needed to install the drive fixed block 2049 into the gear chamber 2020. The detachable connection manner of the drive fixed block 2049 may take on various forms, e.g., providing a positioning rib 2051 in the gear chamber 2020, and a positioning groove 2052 is provided on the drive fixed block 2049, where the positioning rib 2051 is inserted into the positioning groove 2052 to position the drive fixed block 2049; or, the drive fixed block 2049 is connected to a sidewall of the container via a screw rod, the screw rod preferably penetrating through from the upper end of the drive fixed block 2049; or, snap-fitting is applied between the drive fixed block and the chamber wall of the gear chamber 2020.

The main shaft 2045 of the scrubber rotary shaft 2011 may penetrate into the sidewall of the container. The main shaft 2045 of the scrubber rotary shaft 2011 may be positioned in a such manner that a lower main shaft recessed groove 2053 is provided at the bottom surface of the gear chamber 2020, one end of the main shaft 2045 being supported in the lower main shaft recessed groove 2053, and an upper main shaft recessed groove 2054 is provided at the lower end of the drive fixed block 2049, such that when the drive fixed block 2049 is mounted in the gear chamber 2020, the upper main shaft recessed groove 2054 is pressed on the main shaft 2045; in this case, a shaft hole surrounding the main shaft 2045 is enclosed by the upper main shaft recessed groove 2054 and the lower main shaft recessed groove 2053. The other end of the main shaft 2045 may be suspended in the air. If a baffle part 2010, as will be described later, is provided, a lower main shaft secondary recessed groove 2055 is provided on the upper end surface of the baffle plate 2010, the other end of the main shaft 2045 is propped up in the lower main shaft second recessed groove 2055, and meanwhile a second stopper block 2016 may be provided at the upper end of the baffle plate 2010, an upper main shaft secondary recessed groove is provided on the second stopper block 2016; likewise, after the second stopper block 2016 is mounted on the baffle part 2010, a shaft hole surrounding the main shaft 2045 is enclosed between the lower main shaft secondary recessed groove and the upper main shaft secondary recessed groove. With this mounting manner, the drive shaft 2048 penetrates through the drive fixed block 2049, and the main shaft 2045 of the rotary shaft is pressed between the drive fixed block 2049 and the gear chamber 2020; therefore, no hole is provided on a sidewall of the container 2001 corresponding to the main shaft 2045, which increases the volume of the liquid held in the container 2001 and eliminates the risk of liquid leakage due to directly making a hole in the sidewall corresponding to the main shaft 2045. Meanwhile, the drive shaft 2048 is generally disposed above the main shaft 2045 of the scrubber rotary shaft 2011, and the crank handle 2018 connected to the drive shaft 2048 is at a relatively high position so as to facilitate rotation of the crank handle 2018, avoiding the hand gripping the crank handle 2018 from hitting the desktop when turning the crank handle 2018 due to a lower position of the crank handle 2018.

In addition, a wear-resisting mechanism is sleeved over the drive shaft 2048. The wear-resisting mechanism may adopt a drive shaft protective sleeve 2056 (usually a rubber sleeve), the drive shaft protective sleeve 2056 being disposed between the drive shaft 2048 and the drive fixed block 2049 so as to reduce friction between the drive shaft 2048 and the drive fixed block 2049 during rotating. Or, a wear-resisting mechanism is provided to sleeve each of both ends of the main shaft 2045 of the rotary shaft, respectively; this wear-resisting mechanism may adopt a rotary shaft protective sleeve 2057 (generally a rubber sleeve), where the rotary shaft protective sleeve 2057 is disposed in the shaft hole to reduce friction between the main shaft 2045 of the rotary shaft and the shaft hole during rotating.

Of course, the detachable connection manner between the rotary shaft and the drive mechanism may also include, but is not limited to, threaded-fitting, screw-fastening, and gear-engaging between the rotary shaft and the output end of the drive mechanism.

A speed regulating mechanism may be disposed between the drive mechanism and the scrubber rotary shaft 2011. The speed regulating mechanism may be a speed-up mechanism (e.g., a gear train speed-up mechanism, as shown in FIGS. 20 and 21). In the case that the speed regulating mechanism is a speed-up mechanism, the rotational speed of the scrubber rotary shaft may increase to enhance brushing efficiency.

The speed regulating mechanism may be a speed reduction mechanism (e.g., a gear train speed reduction mechanism), in which case the rotational speed of the scrubber rotary shaft may be decelerated to facilitate rotation of the scrubber.

The speed regulating mechanism may be a gearbox (i.e., a conventional shift gearbox, which enables speed regulation by shifting gears to yield different gear outputs, thereby achieving the objective of speed regulation), in which case speed increase or speed reduction of the rotary shaft is performed dependent on actual use.

The brushing portion 2012 comprises a plurality of columns of first flexible cleaning elements 2029 distributed along the circumferential direction of the scrubber rotary shaft 11, where the first flexible cleaning elements 2029 are plastic flexible cleaning elements, or soft plastic brushing elements, or fabric strip flexible cleaning elements. Of course, the first flexible cleaning elements 2029 may also be arranged in other irregular or regular distributions. In the radial section of the scrubber 2029, the spacings between two adjacent columns of first flexible cleaning elements 2029 are preferably substantially equal.

The first flexible cleaning elements 2029 are bendable upon touch. A first end of each first flexible cleaning element 2029 is disposed on the scrubber rotary shaft 11, while a second end thereof is a free end. When the fruits/vegetables pass through the brush washing zone 2004, the fruits/vegetables touch the first flexible cleaning elements 2029, causing the first flexible cleaning elements 2029 bent, whereby the fruits/vegetables are brushed by the first flexible cleaning elements 2029.

The first flexible cleaning elements 2029 may be specifically formed as such: each column of the first flexible cleaning elements 2029 may be a column of monolithic flexible cleaning element, as illustrated in FIG. 24, e.g., a monolithic piece of plastic strip (e.g., nylon strip, TPR strip, etc.), a monolithic piece of soft plastic strip (e.g., silica gel strip, etc.), a monolithic piece of fabric strip, etc.

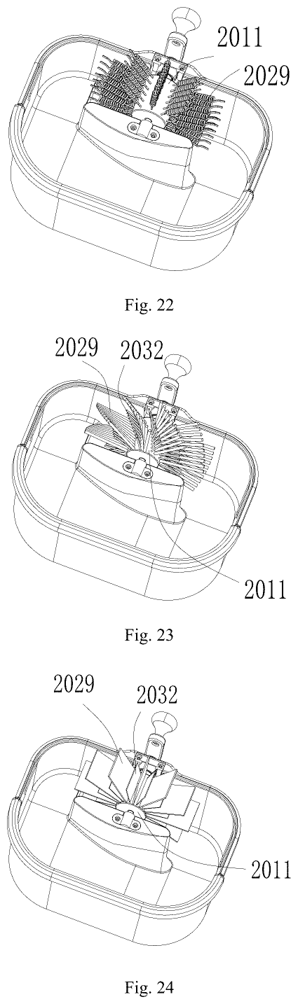

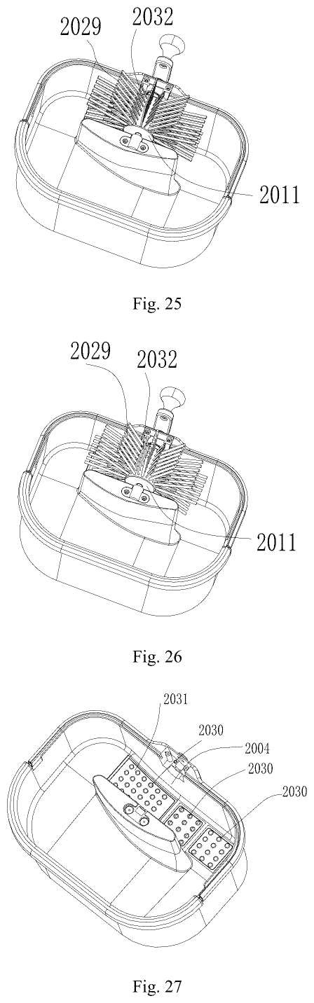

Each column of first flexible cleaning elements 2029 may also be formed to comprise a plurality of rows of rod-shaped elements (the cross section of which may be round or square or of other shape), as illustrated in FIGS. 22, 23, and 25, e.g., a plurality of plastic rods (e.g., nylon rods, TPR rods) which are arranged into a column of first flexible cleaning elements 2029; or, a plurality of soft plastic rods (e.g., silica gel rods, etc.) which are arranged into a column of first flexible cleaning elements 2029; or, a plurality of plastic filaments (e.g., nylon filaments, TPR filaments, etc.) form one piece of bristle brush and a plurality of pieces of bristle brushes are arranged into a column of first flexible cleaning elements 2029; or, a plurality of soft plastic filaments (e.g., silica gel filaments, etc.) form one piece of soft bristle brush and a plurality of pieces of soft bristle brushes are arranged into a column of first soft cleaning elements 2029, etc. FIG. 23 illustrates a circumstance of ten rows of rod-shaped elements; and FIGS. 25 and 26 illustrate a circumstance of seven rows of rod-shaped elements. The rod-shaped elements may also be replaced by stripes or other shapes, for example, the strip shape illustrated in FIGS. 23, 25, and 26, and the spiral shape illustrated in FIG. 22.

Since there exists a gap between two adjacent columns of first flexible cleaning elements 2029, smaller fruits/vegetables easily access between the two adjacent columns of first flexible cleaning elements 2029, a consequence of which is that since the fruits/vegetables are located between two adjacent columns of first flexible cleaning elements 2029, when the scrubber 2022 is rotating, the fruits/vegetables held between the two adjacent columns of first flexible cleaning elements 2029 are only rotating with the scrubber 2002 but cannot get through the first flexible cleaning elements 2029, such that the fruits/vegetables cannot be brushed by the first flexible cleaning elements 2029. Therefore, optionally, the brushing portion may further comprise a plurality of columns of second flexible cleaning elements 2032, the second flexible cleaning elements 2032 being disposed between two adjacent columns of first flexible cleaning elements 2029, where the height of the second flexible cleaning elements 2032 is lower than that of the first flexible cleaning elements 2029 such that smaller fruits/vegetables will not get deeply between the two adjacent columns of first flexible cleaning elements 2029 (due to being blocked by the second flexible cleaning elements 2032) and thus can be brushed by the second flexible cleaning elements 2032 and/or first flexible cleaning elements 2029 with various strengths or contact areas. The material, distribution, and structure of the second flexible cleaning elements 2032 may refer to those of the first flexible cleaning elements 2029 as described above.

After the scrubber 2002 is mounted on the container 2001, a spacing between the brushing portion 2012 and the bottom surface of the container 2001 is preferably 0.5 mm-5 cm; in this case, without contact between the brushing portion 2012 and the container 2001, the scrubber 2012 rotates more smoothly. Another option is that after the scrubber 2002 is mounted, the brushing portion 2012 contacts the bottom surface of the container 2001, whereby dirt buildup on the bottom surface of the container 2001 may be cleaned, which realizes self-cleaning of the bottom surface of the container 2001. With this option, on one hand, the brushing portion 2012 projects deeply in the brush washing zone 2004, offering a more thorough abrasion between the fruits/vegetables and the brushing portion when the fruits/vegetables pass through the brush washing zone 2004, whereby more fruits/vegetables may be wiped by the brushing portion 2012, yielding a better cleaning effect. On the other hand, the brushing portion 2012 projects deeply into the brush washing zone 2004, offering a stronger drive to the wash water, which facilitates forming a fast circulating water current, where the fast circulating water current facilitates bringing the fruits/vegetables to circulate fast, yielding a better cleaning effect.

After the scrubber 2002 is mounted, the brushing portion 2012 is preferably higher than the container 2001; in this way, when the scrubber 2002 is rotating, only part of the brushing portion 2012 is submerged in the wash water, and thus the rotating scrubber 2002 experiences less resistance from the wash water, which eases rotation of the scrubber 2002.

As to distribution of the brushing portions 2012, a preferable option is that the brushing portions 2012 are substantially uniformly distributed in the transverse width direction of the brush washing zone 2004, such that substantially all fruits/vegetables passing through the brush washing zone 2004 can be rubbed with and brushed by the brushing portions 2012, yielding a better cleaning effect.

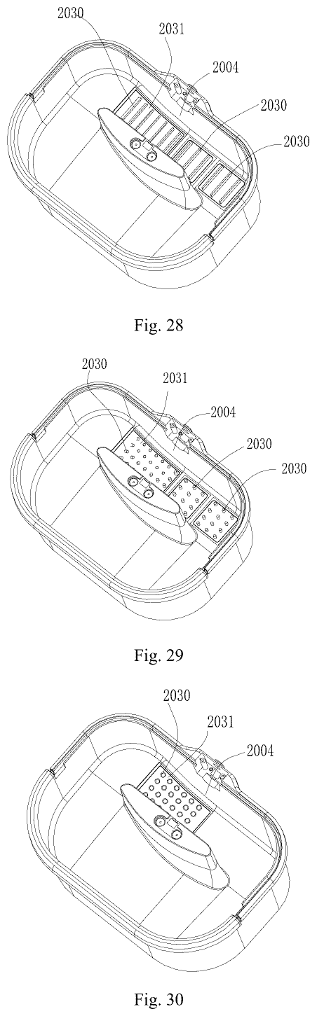

As a more preferable setting, a wipe part 2030 is provided at the bottom of the container 2001, where the wipe part 2030 may take on a form of a flexible cleaning element (e.g., plastic bristles, a plastic brushing column, a soft plastic strip, soft plastic bristles, and a flexible fabric strip, etc.), a protruding bar, or a protruding point, etc. In the flow direction of the wash water, a wipe part 2030 may be provided in front of the scrubber 2002, or rear to the scrubber 2002, or below the scrubber 2002; or, a wiper may be provided respectively in front of, rear to, and below the scrubber 2002; or, a wiper is provided at two orientations of in front of, rear to, and below the scrubber 2002. Provision of the wiper part has the following purposes: by providing the wipe part 2030 in front of the scrubber 2002, the fruits/vegetables are first wiped by the wipe part 2030 before entering the brush washing zone 2004; by providing the wipe part 2030 rear to the scrubber 2002, the fruits/vegetables are wiped again by the wipe part 2030 when flowing out of the brush washing zone 2004; by providing the wipe part 2030 below the scrubber 2002, the fruits/vegetables are rubbed with and brushed by both of the brushing portion 2012 and the wipe part 2030 when flowing through the brush washing zone 2004. Therefore, with provision of the wipe part 2030, the fruits/vegetables may not only be brushed by the brushing portion 2012, but also may be wiped by the wipe part 2030, whereby a better cleaning effect is achieved. Of course, the wipe part 3030 may also be provided at two or three orientations of in front of, rear to, and below the scrubber 2002. In FIGS. 27, 28, and 29, the wipe part 2030 is provided in front of, rear to, and below the scrubber 2002, respectively; in FIGS. 30, 21, and 32, the wipe part 2030 is provided rear to the scrubber 2002; in FIGS. 36, 37, and 38, the wipe part 2030 is provided below the scrubber 2002. In FIGS. 27, 30, 33, and 36, the wipe part 2030 is a protrusion point; in FIGS. 28, 31, 34, and 37, the wipe part 2030 is a soft plastic strip; and in FIGS. 29, 32, 35, and 38, the wipe part 2030 is short bristles.

In this example embodiment, a most preferable manner of setting the wipe part 2030 is such that the wipe part is disposed at the lower, rear position of the scrubber 2002 in the wash water flow direction, at which position the fruits/vegetables will not experience additional resistance when entering the brush washing zone 2004, which facilitates the fruits/vegetables to enter the brush washing zone 2004 smoothly. In addition, by providing the wipe part 2030 at the lower, rear position of the scrubber 2002, no additional resistance will occur to the fruits/vegetables in the brush washing zone 2004, preventing the fruits/vegetables from being stranded in the brush washing zone 2004 due to loss of the dynamic force for moving forward in the brush washing zone 2004. In addition, by providing the wipe part 2030 at the lower, rear position of the scrubber 2002, the fruits/vegetables, which have been brushed by the brushing portion 2012 in the brush washing zone 2004 and will immediately break away from the brushing portion 2012, are further pushed by the brushing portion 2012, and in the meanwhile they are wiped by the wipe part 2030, so that a better cleaning effect is achieved.

After the fruit and vegetable washing apparatus serves a certain period of time, dirt washed off would build up at the bottom of the container; if the wipe part 2030 is provided at the bottom of the container, the dirt easily adheres to the wipe part 2030. Therefore, a preferable positional relationship between the first flexible cleaning element 2029 and the wipe part 2030 is such that: an end portion of the first flexible cleaning element 2029 contacts the wipe part 2030, thereby enabling the first flexible cleaning element 2029 to access the wipe part 2030 so as to clean the wipe part.

To enhance the cleaning effect, a transitional surface 2031 gradually elevated along the flow direction of the wash water is formed on the bottom surface of the brush washing zone 2004 or on the bottom surface of the container at the exit side of the brush washing zone, where the fruits/vegetables, which are being brushed in the brush washing zone 2004, climb along the transitional surface 2031, whereby the friction between the brushing portion 2012 and the fruits/vegetables increases and thus the cleaning effect is enhanced. The transitional surface 2031 is recommended to have a bevel shape or an inwardly recessed curved surface, preferably the inwardly recessed curved surface, where a better cleaning effect is achieved when the fruits/vegetables rise and fall in the inwardly recessed curved surface. Alternatively, the transitional surface may also be formed on the bottom surface of the container at the exit side of the brush washing zone 2004 along the flow direction of the wash water; as a result, since the fruits/vegetables need to climb at the exit side of the brush washing zone, the fruits/vegetables stay longer in the brush washing zone 2004, whereby the cleaning effect is improved. In addition, the wipe part 2030 noted above may also be provided on the transition surface 2021 to further improve the cleaning effect; it is recommended to dispose the wipe part at the downstream side of the transitional surface 2031 in the flow direction of the wash water, i.e., the wipe part 2030 is disposed at a higher point of the transitional surface 2031 where the spacing between the brushing portion 2012 and the wipe part 2030 is minimized or they are intersected; in this way, the fruits/vegetables may get more wiped to achieve a better cleaning effect.

Driven by the circulation-driving mechanism, the wash water mainly circulates along wall surfaces of the container 1; therefore, a dead water zone (where the wash water substantially stands still) likely occurs between the parallel arranged brush washing zone 2004 and fruits/vegetables flowing and staging zone 2003; once the fruits/vegetables enter the dead water zone, they cannot circulate with the circulating wash water and thus cannot be brushed by the scrubber 2002. To solve this problem, a baffle part 2010 is optionally provided in the container 2001, where the circulation passage extends surrounding the baffle part 2010. The baffle part 2010 substantially eliminates the dead water zone; even not completely eliminating the dead water zone, the baffle part 2010 may at least significantly reduce the extent of the dead water zone. It is preferred that the baffle part 2010 has an arc surface facing and protruding above the fruits/vegetables flowing and staging zone, which may not only further reduce the extent of the dead water zone, but also may urge the flowing fruits/vegetables outward to prevent stranding of the fruits/vegetables.

With provision of the baffle part 2010, one end of the rotary shaft 2011 may be supported on the container 2001, while the other end thereof is supported on the baffle part 2010 or penetrates into the baffle part 2010; in this way, the installation of the scrubber rotary shaft 2011 is not only simplified but also secured. As noted above, the other end of the scrubber rotary shaft 2011 is preferably detachably connected to the baffle plate 2010 so as to facilitate removal of the scrubber 2002.

The baffle part 2010 may be generally provided as a baffle plate with a certain length, which facilitates formation of the circulation passage. Of course, the baffle part 2010 may also take on a form such as a baffle post.

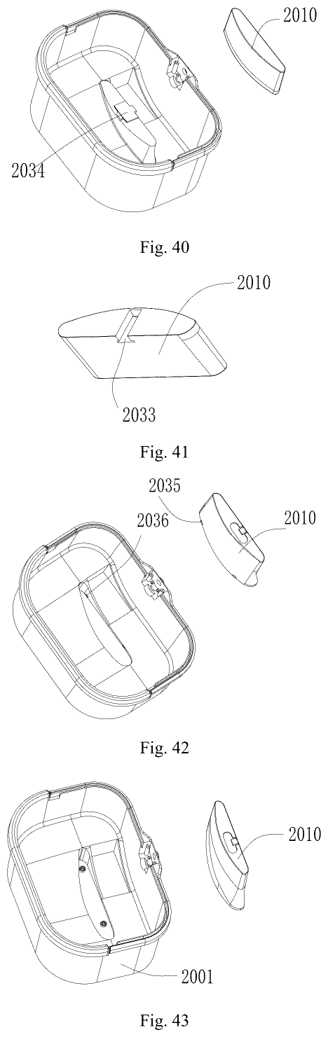

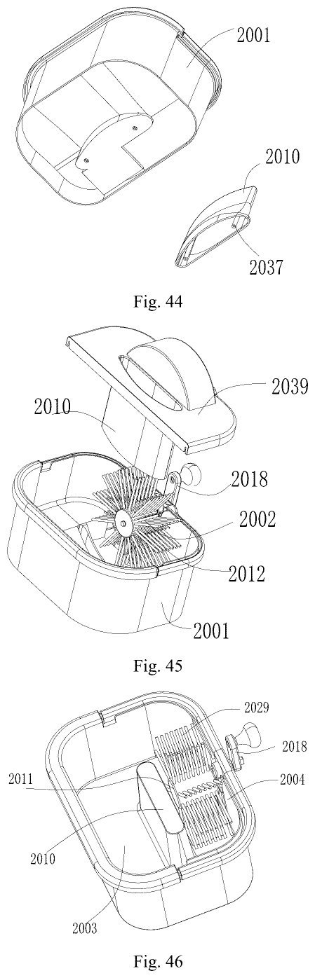

The baffle part 2010 may be separately formed from the container 2001 or may be one-piece formed with the container 2001. In the case that the baffle part 2010 and the container 2001 are separately formed, the baffle part 2010 and the container 2001 may be secured via a snap. Of course, they may also be secured via a screw; or, a guide rail is provided on the container, such that the baffle part is inserted into the guide rail so as to be fixed. In FIGS. 40 and 41, a slide rail groove 2033 is provided at the underside of the baffle part 2010 and a slide rail 2034 is provided at the bottom of the container 2001, where to mount the baffle part 2010, the slide rail 2034 simply slides into the slide rail groove 2033. In FIG. 42, a clamp protrusion 2035 is provided at the lower portion of the baffle part, a recessed groove on the bottom of the container 2001, a slot 2036 is provided in the recessed groove, and by snapping the clamp protrusion 2035 into the slot 2036, the baffle part 2010 is mounted. In FIGS. 43 and 44, a screw rod is applied to connect the baffle part 2010 and the container 2001, where the screw rod penetrates into the baffle part 2010 through the container 2001, and to achieve this, a penetration 2037 may be provided in the baffle part 2010 to penetrate into the screw rod. In the case that the baffle part 2010 and the container 2001 are one-piece formed, a preferred forming manner comprises: forming a hollow raised portion at the bottom surface of the container 2001, which is easily formed, where the raised portion acts as the baffle part 2010.

As noted above, although provision of the baffle part 2010 may eliminate the dead water zone to a certain extent, it cannot thoroughly eliminate the impact of dead water zone, or the flow rate of the wash water proximal to the baffle part 2010 is still lower than that in the periphery of the container, such that the fruits/vegetables proximal to the baffle part 2010 are still likely stranded around the baffle part 2010; therefore, a slope 2038 may be provided at the interface between the baffle part 2010 and the bottom surface of the container 2001, where the slope 2038 tilts outwardly from the baffle part 2010 from top to down; in this way, the fruits/vegetables at the interface between the baffle part 2010 and the container 2001 flow outward along the slope 2038 and re-enter the wash water with a relatively high flow rate.

In the case that the baffle part 2010 is provided, a fruits/vegetables inlet port is formed between the downstream end of the baffle part 2010 and a sidewall of the container 2001 in the wash water flow direction. To prevent jam of the fruits/vegetables at the fruits/vegetables inlet port, an inwardly shrunk guide surface is provided at the downstream end of the baffle part 2010 so as to form a relatively wide fruits/vegetables guide opening between the guide surface and the sidewall of the container.

Another measure for preventing jam of the fruits/vegetables is that the scrubber rotary shaft 11 is disposed on the container in a bi-directionally rotatable manner, i.e., the scrubber rotary shaft 11 may rotate clockwise or counterclockwise, a simplest method of implementing which is to penetrate the scrubber rotary shaft 11 through the container 2001 or prop up the scrubber rotary shaft 11 on the container 2001, where no unidirectional mechanism is provided between the scrubber rotary shaft 11 and the container 2001. With the bidirectional rotation design of the scrubber rotary shaft 2011, once the fruits/vegetables are jammed in the container 2001, the rotary shaft may rotate reversely, bringing the scrubber 2002 to rotate reversely, whereby the wash water flows reversely to disperse the jammed fruits/vegetables, clearing jam of the fruits/vegetables.

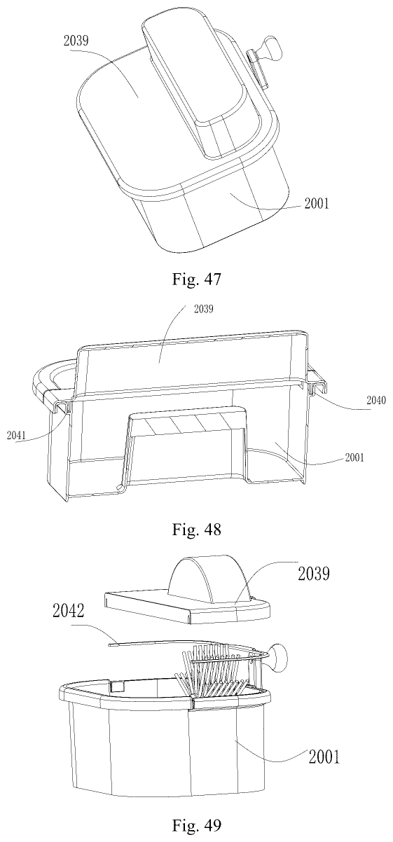

Since the scrubber 2002 is rotatably disposed in the container with the scrubber rotary shaft 11 being transversely arranged, when the scrubber 2002 is rotating, the wash water in the container 2001 is likely spun out to cause splash of the wash water. Therefore, an anti-splash cover 2039 may be provided to fit over the brush washing zone 2002, preventing the wash water from splashing. A typical structure of the anti-splash cover 2039 comprises a raised portion corresponding to the scrubber 2002 and a connecting portion connected to the container. Generally, the anti-splash cover 2039 is made of plastic, preferably transparent plastic so as to observe the washing status in the brush washing zone 2004. The anti-splash cover 2039 may only cover the brush washing zone 2004, or may cover an area beyond the brush washing zone 2004 so as to close the upper end opening of the container, as illustrated in FIG. 47, whereby a better splash-baffling effect is achieved.

With the anti-splash cover 2039 provided, the water spun out when the scrubber 2002 is rotating will splash to the anti-splash cover 2039, and the water blocked by the anti-splash cover 2039 will flush back to the scrubber 2002, generating a resistance to rotation of the scrubber 2002. In order to reduce the resistance as much as possible, optionally, the minimum gap between the anti-splash cover 2039 and the outer edge of the scrubber 2002 is 2 mm so as to control the impact pressure of the water blocked by the anti-splash cover 2039 and flushing back within a relatively small extent.

To further suppress splashing of the wash water, a water baffle mechanism may be provided between the anti-splash cover 2039 and the container 2001 so as to block the water spun out by the brushing portion 2012, thereby preventing the water spun out by the brushing portion 2012 from leaking out of the container. A specific structural form of the water baffle mechanism may comprise an anti-splash groove 2040 provided on an upper end surface of the container and an anti-splash rib 2041 disposed on the anti-splash cover, such that when the anti-splash cover 2039 covers the brush washing zone, the anti-splash rib 2041 can be inserted into the anti-splash groove 2040; or, the water baffle mechanism comprises an anti-splash rib disposed on the upper end surface of the container and an anti-splash groove provided on the anti-splash cover, such that when the anti-splash cover covers the brush washing zone, the anti-splash rib can be inserted in the anti-splash groove. The anti-splash rib may baffle the wash water, and the anti-splash groove may receive the baffled wash water.

The water baffle mechanism may take on another specific structural form such that the water baffle mechanism comprises a seal ring 2042 disposed between the anti-splash cover 2039 and the container 2001, where the seal ring 2042 enables water tightness, substantially eliminating splashing of the wash water.

The anti-splash cover 2039 is generally detachably connected to the container 2001, such that removal of the anti-splash cover 2039 facilitates cleaning of the brush washing zone 2004 and replacement of the scrubber. Usually, the anti-splash cover 2039 is just propped up on the container 2001; to further secure the propping, a detachable connection manner such as snap-fitting or screw-fastening may be adopted between the anti-splash cover 2039 and the container 2001.

With the anti-splash cover 2039 provided, the “baffle part 2010” may also be disposed on the anti-splash cover 2039, i.e., a baffle plate is disposed on the anti-splash cover 2039; when the anti-splash cover 2039 covers the brush washing zone, the baffle plate can project into the container 2001, whereby the circulation passage extends surrounding the baffle plate.

As a preferable structure, a water discharge port 2043 may be provided on a sidewall of the container 2001, where the level of the wash water in the container 2001 does not exceed the position of the water discharge port. After washing of the fruits/vegetables is complete, the wash water may be drained via the water discharge port 2043, while the fruits/vegetables are retained in the container 2001 without falling out from the water discharge port.

As a preferrable solution, a drain basket 2044 is provided in the container 2001. On washing, the fruits/vegetables are held in the drain basket 2044, and after the washing is complete, it is just needed to lift up the drain basket 2044. It is preferable that the bottom of the drain basket 2044 substantially fits the bottom of the container 1 to prevent spatial loss of the container 1. The “substantially fit” means the bottom of the drain basket 2044 can completely fit the bottom of the container 1 or the gap therebetween is very narrow. To facilitate lifting up the drain basket 44, a notch is provided on the drain basket 44, the scrubber 2022 being disposed in the notch; in this way, all fruits/vegetables in the container 2001 may be substantially taken out. Of course, if the scrubber 2002 is detachably provided in the container 2001, the notch corresponding to the scrubber 2002 may not be provided on the drain basket 2044, and in this case, to take out the fruits/vegetables, it is only needed to remove the scrubber 2002 first and then lift up the drain basket 2044.

With the drain basket 2044 provided, the baffle part 2010 may be provided on the drain basket 2044, which eliminates a need to provide a notch corresponding to the baffle part 2010 on the drain basket 2044.

FIG. 61 illustrates another form of the container 2001, where drain holes 2059 may be provided in the bottom wall or sidewalls of the container 2001, or drain holes 2059 may be provided in the bottom wall and sidewalls of the container 2001. In use, the container 2001 needs to be placed in wash water holding receptacle, and meanwhile wash water is filled into the wash water holding receptacle, where the wash water enters the container 2001 via the drain holes 2059 such that the fruits/vegetables are soaked in the wash water. The shape of the wash water holding receptacle may be adapted to the container 2001 or not adapted to the container 2001. Optionally, the wash water holding receptacle may be a common household container such as a sink or a basin. Optionally, the wash water holding receptacle may also be an accessory mated to the container; in this case, the wash water holding receptacle is flexible in designing, i.e., it may be designed into various shapes, providing versatile designs of the fruit and vegetable washing apparatus to meet aesthetic appreciation of different users.

### Example Embodiment 3

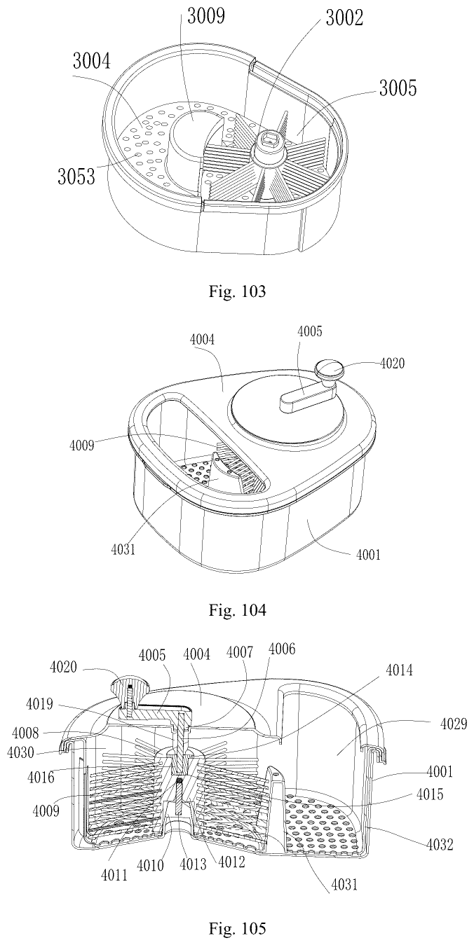

FIGS. 62-103 illustrate a fruit and vegetable washing apparatus according to an example embodiment, comprising a container 3001 for holding fruits/vegetables and wash water, a circulation-driving mechanism, and a scrubber 3002, where the scrubber 3002 has a brushing portion 3003 extending towards a side surface of the container 3001. The container 3001 is configured to hold the fruits/vegetables and the wash water, i.e., no drain holes are provided in the sidewalls or bottom of the container 3001, such that in use, the wash water may be filled and held therein. Of course, decorative holes, mounting holes, or a water discharge port, which do not affect the water holding function of the container 3001, may be provided on an upper edge of a sidewall of the container 3001; such holes/ports are also deemed as “no drain holes are provided in the sidewalls or bottom of the container 3001.” Of course, as illustrated in FIG. 103, the drain holes 3053 may be provided in the bottom wall or sidewalls of the container 3001, or drain holes 3053 may be provided in the bottom wall and sidewalls of the container 3001. In use, the container 3001 needs to be placed in wash water holding receptacle, and meanwhile the wash water is filled into the wash water holding receptacle, where the wash water enters the container 3001 via the drain holes 3053 such that the fruits/vegetables are soaked in the wash water. The shape of the wash water holding receptacle may be adapted to the container 3001 or not adapted to the container 3001. Optionally, the wash water holding receptacle may be a common household container such as a sink or a basin. Optionally, the wash water holding receptacle may also be an accessory mated to the container; in this case, the wash water holding receptacle is flexible in designing, i.e., it may be designed into various shapes, providing versatile designs of the fruit and vegetable washing apparatus to meet aesthetic appreciation of different users.

The container 3001 has a circulation passage formed therein, the circulation passage comprising a fruits/vegetables flowing and staging zone 3004 and a brush washing zone 3005, where the scrubber 3002 is disposed in the brush washing zone 3005.

On washing the fruits/vegetables, the circulation passage can provide a passageway for the wash water and the fruits/vegetables to circulate between the fruits/vegetables flowing and staging zone 3004 and the brush washing zone 3005.

The circulation-driving mechanism is configured to provide a driving force to drive the wash water to flow during washing of the fruits/vegetables, where the flowing wash water carries the fruits/vegetables to circulate in the circulation passage, where the fruits/vegetables sequentially pass through the brush washing zone 3005 between the brushing portion 3003 and side surfaces of the container 3001 and are thus brushed by the scrubber 3003.

In use, the fruits/vegetables are placed in the container 3001. Driven by the circulation-driving mechanism, the wash water flows from the brush washing zone 3005 to the fruits/vegetables flowing and staging zone 3004 and then flows back from the fruits/vegetables flowing and staging zone 3004 to the brush washing zone 3005, whereby a circulation featuring a journey from the brush washing zone 3005 to the fruits/vegetables flowing and staging zone 3004 and then back to the brush washing zone 3005 is formed in the circulation passage, while circulation of the wash water brings the fruits/vegetables to flow. When the fruits/vegetables are flowing through the brush washing zone 3005, the brushing portion 3003 rubs the fruits/vegetables, whereby the fruits/vegetables are cleaned. The fruits/vegetables access the brush washing zone 3005 sequentially (i.e., one by one or batch by batch) from the fruits/vegetables flowing and staging zone 3004, such that the scrubber 3003 brushes the fruits/vegetables sequentially, yielding a homogeneous, orderly, effective cleaning. The fruits/vegetables washed in the container 3001 experience a cyclical brushing procedure of first entering the brush washing zone 3005 for being brush washed, then flowing into the fruits/vegetable flowing and staging zone 3004 for being soaked and flushed, and then flowing back into the brush washing zone 3005 for being brush washed; during the washing process, brushing and flushing occur alternately such that the fruits/vegetables may not only be brushed, but also be flushed by the wash water. In addition, after being soaked and flushed, the residual dirt on the fruits/vegetables are more easily brushed off by the scrubber in the brush washing zone. The above benefits are achieved through cooperation of the following three features: the container having a fruits/vegetables flowing and staging zone 3004 and a brush washing zone 3005 which are in communication, the brush washing zone 3005 having a scrubber 2 disposed therein, and the circulation-driving mechanism driving the wash water and the fruits/vegetables to flow and circulate in the circulation passage.

Since the brush washing zone 3005 and the fruits/vegetables flowing and staging zone 3004 in the container 3001 are in communication, during the washing process, the fruits/vegetables are brush washed by the scrubber in the brush washing zone 3005 and flow with the wash water in the fruits/vegetables flowing and staging zone 3004, without fierce agitations and severe collisions between fruits/vegetables and/or between fruits/vegetables and the container 3001 during the whole process. Since the fruits/vegetables circulate in the container 3001 throughout the whole washing process, the amount of the fruits/vegetables fed into the container 3001 should be appropriate based on the volume of the fruits/vegetables flowing and staging zone. Charging and discharging of the fruits in the fruit and vegetable washing apparatus generally occur in the fruits/vegetables flowing and staging zone 3004.

In this example embodiment, the scrubber 3002 comprises a scrubber rotary shaft 3010 and a brushing portion 3003 disposed on the scrubber rotary shaft 3010, where the brushing portion 3003 extends towards a side surface of the container. The scrubber can be disposed in the container with the scrubber rotary shaft 3010 being vertically disposed, such that the fruits/vegetables circulating in the container 3001 can pass between the brushing portion 3002 and the side surface of the container 3001 to be thereby brushed, where “the scrubber rotary shaft being vertically disposed” refers to the scrubber rotary shaft 3010 being substantially vertically disposed, i.e., substantially vertical to the horizontal plane; even if there exists certain included angle between the scrubber rotary shaft 3010 and the horizontal plane, it also falls within the scope of “the scrubber rotary shaft being vertically disposed,” so long as the fruits/vegetables circulating in the container 3001 can pass between the brushing portion 3002 and a side surface of the container 3001. With the scrubber rotary shaft 3010, the scrubber 3002 of this structural form rotates about the central axis of the scrubber rotary shaft 3010; in this way, the scrubber 3002 amounts to the circulation-driving mechanism, such that when washing the fruits/vegetables, the scrubber 3002 can be rotated to provide a driving force for driving the wash water and the fruits/vegetables being washed to circulate in the circulation passage. In this case, a frustum 3031 may be formed on the bottom surface of the container 3001 corresponding to the scrubber; as such, during the washing process, the fruits/vegetables at the bottom will flow outward along the frustum 3031, thereby preventing the fruits/vegetables from jam at the bottom of the container 3001.

The scrubber rotary shaft 3010 may be mounted in a plurality of manners, several of which will be described below:

(1) A lower end of the scrubber rotary shaft 3010 directly abuts against the bottom surface of the container 3001, where the scrubber rotary shaft 3010 rotates with its lower end as the fulcrum; to facilitate a stable rotating effect, the lower end of the scrubber rotary shaft 3010 may be generally insertable into the bottom surface of the container 3001 so as to be axially limited, such that it can only rotate without up-down play. For example, a snap spring may be adopted to axially position the scrubber rotary shaft 3010, or a protrusion rib is provided on the scrubber rotary shaft 3010 while a recessed ring is provided on the container such that the protrusion rib is disposed in the recessed ring. To improve rotating smoothness of the scrubber rotary shaft 3010, a ball may be provided between the lower end of the scrubber rotary shaft 3010 and the bottom surface of the container 3001, where the ball may be provided at the lower end of the scrubber rotary shaft 3010, or may be disposed in the container 3001, or may be a separate part disposed between the lower end of the scrubber rotary shaft and the container.

(2) A supporting arrangement may be provided on the container 3001, where the upper end of the scrubber rotary shaft 3010 is propped up on the supporting arrangement. The supporting arrangement may take on a form of support plate or the like. The connection relationship between the scrubber rotary shaft 3010 and the support plate may refer to the manner described in (1) above.

(3) As illustrated in FIGS. 63-67, a support shaft is provided on the bottom surface of the container 3001 and the scrubber rotary shaft 3010 is sleeved outside the support shaft, whereby the scrubber rotary shaft 3010 is supported on the support shaft, in which case the scrubber rotary shaft 3010 is detachable, and in case of disassembly, it is simply needed to remove the scrubber rotary shaft 3010. To improve rotating smoothness of the scrubber rotary shaft 3010, a first ball body 3011 may be provided between the support shaft and the scrubber rotary shaft 3010, where the first ball body 3011 may be disposed at the upper end of the support shaft; the scrubber rotary shaft 3010 is provided with a top plate 3012, the first ball body 3011 is urged against the top plate 3012. Of course, the first ball body 3011 may optionally be provided in the scrubber rotary shaft, where the first ball body 3011 is pressed on the upper end of the support shaft. To facilitate support and formation of the support shaft, as illustrated in FIGS. 63-67, the support shaft comprises a shaft seat 3013. The shaft seat 3013 is preferably formed integrally with the container 3001. A top shaft 3014 is provided above the shaft seat 3013, the first ball body 3011 being disposed between the upper end of the top shaft 3014 and the top plate 3012. To make the first ball body 3011 more stable, a ball groove corresponding to the first ball body 3011 may be further provided on the top plate 3012, where the first ball body 3011 is partially disposed in the ball groove, thereby being positioned more securely.

There may be provided only one scrubber 3002; or there may be provided a plurality of scrubbers 3002, where the brush washing zones are formed in correspondence to the scrubbers. The plurality of scrubbers are linked such that they may rotate synchronously. A linking mechanism between the plurality of scrubbers may include, but is not limited to, a gear transmission mechanism, a chain transmission mechanism, or a belt transmission mechanism.

The scrubber 3002 is preferably detachably provided on the container so as to facilitate replacement of the scrubber 3002 or removal of the scrubber 3002 for cleaning purpose. The mounting manners (1), (2), and (3) of the rotary shaft, as described above, may realize detachability of the scrubber 3002.

The corners of the container 3001 are arcuately chamfered. Spiked corners of the container 3001 would cause difficulty in cleaning dirt buildup there. In addition, the arcuately chamfered corners of the container 3001 unlikely cause damages to the fruits/vegetables flowing with the wash water. Moreover, smooth flowing of the circulating wash water along the arcuately chamfered corners of the container 3001 also achieves less loss of kinetic energy.

As a preferable design, the bottom surface of the fruits/vegetables flowing and staging zone 3004 is provided with a slope, such that when the fruits/vegetables flow out of the brush washing zone 3005 into the fruits/vegetables flowing and staging zone, they flow from the higher portion of the slope towards the lower portion of the slope, whereby flowing of the fruits/vegetables is accelerated to prevent jam of the fruits/vegetables in the fruits/vegetables flowing and staging zone.

To actuate the scrubber 3002 to rotate, the rotary shaft or the scrubber may be gripped by hand to rotate, whereby the scrubber 3002 is rotated. Of course, a preferable manner is to connect the scrubber rotary shaft 3010 to a drive mechanism driving it to rotate, such that the drive mechanism drives the scrubber rotary shaft 3010 to rotate, thereby bringing the scrubber to rotate. The drive mechanism may be an electric drive mechanism or a manual drive mechanism. The electric drive mechanism adopts for example an electric motor, where the output end of the electric motor is connected to the rotary shaft. The manual drive mechanism adopts for example a crank handle, where the terminal end of the crank handle is connected to the rotary shaft.

In FIGS. 62-65 and 71-73, to support the drive mechanism, a supporting mechanism may be provided on the container, the drive mechanism being supported on the supporting mechanism. The supporting mechanism may take on a form of support plate or the like. FIGS. 62-65 illustrate that the supporting mechanism is an anti-splash cover 3015 as will be described later; and FIGS. 71-73 illustrate that the supporting mechanism is a support plate. In FIGS. 62-65, the crank handle is supported on the anti-splash cover 3015, and the shaft sleeve 3018 penetrates into the anti-splash cover 3015. In FIGS. 71-73, the supporting mechanism acting as a drive mechanism is a support plate, without the anti-splash cover. The output end of the drive mechanism is connected to the scrubber rotary shaft 3010, in which case the scrubber rotary shaft 3010 may penetrate into the supporting mechanism or may not penetrate into the supporting mechanism. If the scrubber rotary shaft 3010 and the drive mechanism are detachably connected, detachability between the scrubber 2002 and the drive mechanism may be realized, where the detachable connection manner between the drive mechanism and the scrubber rotary shaft 3010 will be described below.

The drive mechanism is preferably detachably connected onto the container, such that when packaging, the drive mechanism and the scrubber 3002 are disassembled together to package, whereby packaging space is saved.

In the case that the drive mechanism is an electric drive mechanism, the detachable connection manner between the electric drive mechanism and the container 3001 may include, but is not limited to, snap-fitting, or screw-fastening; or, a slide groove is provided on the container, and a slide fin is provided on the drive mechanism, the slide fin sliding into the slide groove.

In the case that the drive mechanism is a manual drive mechanism, the detachable structure between the drive mechanism and the container 3001 may be snap-fitting or screw-fastening or the like; or, a slide groove may be provided on the container, and a slide fin is provided on the drive mechanism, where the slide fin slides into the slide groove.

Another detachable connection manner between the drive mechanism and the container 3001 is such that since the drive mechanism is connected to the scrubber rotary shaft 3010, it is only needed to implement the detachable connection between the scrubber rotary shaft 3010 and the container 3001, where the detachable connection manner between the scrubber rotary shaft 3010 and the container 3001 has been described above.

The detachable connection may also be applied between the drive mechanism and the scrubber rotary shaft 3010, which enables separate removal of the drive mechanism. A simplest detachable connection manner between the drive mechanism and the scrubber rotary shaft 3010 is such that the cross section of the terminal end of the scrubber rotary shaft 3010 is polygonal, and a drive block is provided at an output end of the drive mechanism, where the drive block is a sleeve with a shape adapted to the terminal end of the rotary shaft, and by inserting the terminal end of the rotary shaft into the drive block, detachable connection between the rotary shaft and the drive mechanism is realized; in addition, the drive mechanism may smoothly drive the scrubber rotary shaft to rotate.

Alternative connection mechanisms between the drive mechanism and the scrubber rotary shaft 3010 may include, but are not limited to, screw-fastening, snap-fitting, tight sleeve joint, etc., as well as those connecting manners as illustrated in FIGS. 62-67. The drive mechanism is a manual drive mechanism, specifically in a form of crank handle. The crank handle comprises a handle body 3022 and a grip 3023 disposed on the handle body 3022, where the handle body 3022 may have a disc shape, or have a strip or plate shape. A shaft stud 3019 is provided at an upper end of the scrubber rotary shaft 3010 and a connecting portion 3017 is provided on the handle body 3022, where the connecting portion 3017 is connected to the shaft stud 3019, whereby the drive mechanism brings the shaft stud 3019 to rotate via the connecting portion 3017 and then drives the scrubber rotary shaft 3010 to rotate. The connecting portion 3017 takes on a form of a shaft sleeve 3018, which is generally disposed on the backside of the handle body 3022 and sleeved over the shaft stud 3019. In this example, the shaft sleeve 3018 brings the shaft stud 3019 to rotate in such a manner that: a driven protrusion rib 3020 is provided at an outer sidewall of the shaft stud 3019 and a driving protrusion rib 3021 is provided on an inner sidewall of the shaft sleeve 3018, where the shaft sleeve 3018, after having been sleeved over the shaft stud 3019, rotates till the driving protrusion rib 3021 engages the driven protrusion rib 3020; in this way, the shaft stud 3019 may be brought to rotate, whereby the scrubber rotary shaft 3010 is brought to rotate. Of course, the shaft sleeve 3018 and the shaft stud 3019 may also be connected in other manners such that the shaft sleeve 3018 drives the shaft stud 3019 to rotate to further drive the scrubber rotary shaft 3010 to rotate, e.g., screw-fastening therebetween. As to the connection manner between the shaft sleeve 3018 and the handle body 3022, they may be secured via a screw or other fitting elements; or, a drive block 3024 is provided on the handle body 3022, and a drive groove 3025 is provided on the shaft sleeve 3018, such that by inserting the drive block 3024 into the drive groove, the crank handle may drive the shaft sleeve 3018 to rotate and further drive the entire scrubber rotary shaft 3010 to rotate; of course, the drive groove 3025 cannot take on a round form, but can take on a runway form or a square form; the form of the drive block 3024 is adapted to the drive groove 3025. In this example embodiment, a screw may be additionally provided, which penetrates through the drive block and the drive groove to realize further secure connection.

Of course, a shaft sleeve may also be provided at the upper portion of the scrubber rotary shaft 3010, and the connecting portion 3017 is a shaft stud, where the shaft sleeve is sleeved over the shaft stud; a driving protrusion rib is provided at an outer sidewall of the shaft stud, and a driven protrusion rib is provided at the inner sidewall of the shaft sleeve, such that by rotating the shaft sleeve, the driving protrusion rib abuts against the driven protrusion rib.

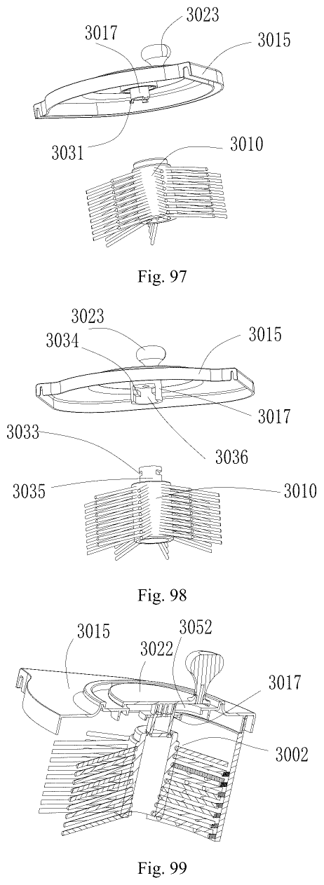

With provision of the drive mechanism and the supporting mechanism, another manner of mounting the rotary shaft is such that: no support shaft is provided on the bottom surface of the container 3001; as illustrated in FIGS. 95-98, the scrubber rotary shaft 3010 having been connected to the drive mechanism is suspended on the supporting mechanism. In the case that the drive mechanism takes on a crank handle form, the connecting portion on the handle body 3022 and the scrubber rotary shaft 3010 are integrally connected to implement suspension of the scrubber rotary shaft 3010; the scrubber rotary shaft 3010 and the connecting portion 3017 on the handle body 3022 may be connected via a screw or other type of fastening elements; or, the scrubber rotary shaft 3010 and the connecting portion 3017 may be detachably connected. For example, as illustrated in FIGS. 96 and 97, a snap hook 3031 is provided on the connecting portion 3017, and a mount 3032 is provided on the upper end of the scrubber rotary shaft 3010, where the snap hook 3031 is snapped into the mount 3032; the mount 3032 has a wide portion and a narrow portion, where the snap hook 3031 first accesses via the wide portion of the mount 3032, and after rotating a certain angle, the snap hook 3031 is positioned below the narrow portion of the mount 3032, whereby the positioning is achieved; or, as illustrated in FIG. 98, an insert-fitting stud 3035 is provided on the upper end of the scrubber rotary shaft 3010, the connecting portion 3017 is an insert-fitting sleeve, a slot 3033 is provided on the insert-fitting stud 3035, an insert-fitting block 3034 is provided in the insert-fitting sleeve, and a slide-in opening 3036 is provided on the insert-fitting sleeve, such that the insert-fitting stud 3035 slides into the insert-fitting sleeve via the slide-in opening 3036 and meanwhile the insert-fitting block 3034 slides into the insert-fitting sleeve 3035, thereby realizing tight fitting.

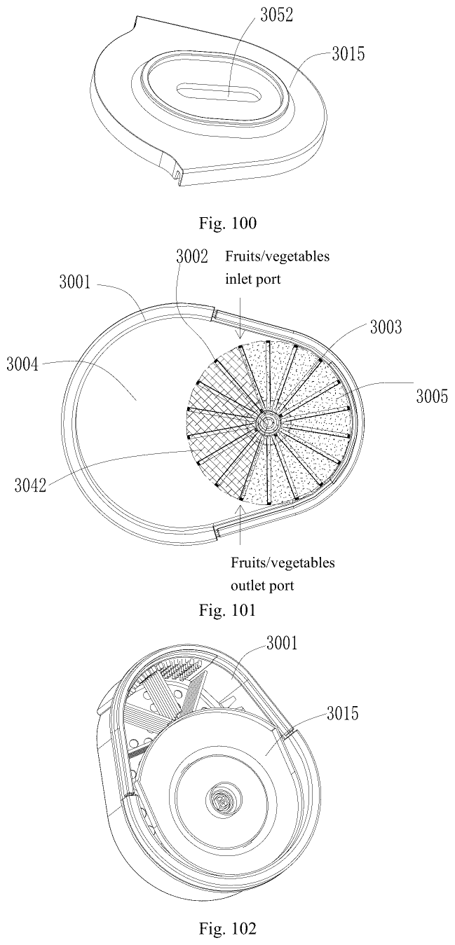

As illustrated in FIGS. 99 and 100, when the scrubber rotary shaft 3010 is suspended on the supporting mechanism, the scrubber may be set as such: the scrubber 302 is adjustably distant from or closer to a sidewall of the container 3001 so as to be adapted to different sizes of fruits/vegetables, where for fruits/vegetables of smaller sizes, the scrubber is adjusted to be closer to the sidewall of the container 3001; while for fruits/vegetables of larger sizes, the scrubber 3002 is adjusted to be distant from the sidewall of the container 3001. A specific structural form to perform such adjustments may be: providing a strip-shaped slide groove 3052 on the anti-splash cover 3015, the connecting portion 3017 on the handle body is snapped into the slide groove 3052 so as to slide reciprocally; therefore, the scrubber 3002 may slide at least closer to or away from the sidewall of the container.

As illustrated in FIGS. 83 and 83, in the case that the drive mechanism is a manual drive mechanism, a friction reducing mechanism may be provided between the manual drive mechanism and the supporting mechanism to reduce friction therebetween. The friction reducing mechanism may be a rolling mechanism (e.g., a rolling body) or a lubricating mechanism (e.g., lubricating grease), etc., preferably the rolling mechanism; a plane bearing 3037 is preferably adopted in the rolling mechanism. Of course, a rolling mechanism such as a ball may also be adopted. In the case that the supporting mechanism is an anti-splash cover 3015, the friction reducing mechanism is disposed between the anti-splash cover 3015 and the front surface of the handle body 3022; in the case that the friction reducing mechanism selects the plane bearing 3037, a receiving groove 3038 is provided on the anti-splash cover 3015, and the plane bearing 3037 is disposed in the receiving groove 3038; this avoids displacement of the plane bearing 3037, and meanwhile the handle body 3022 may also be disposed in the receiving groove 3038 so as to keep in flush with the anti-splash cover 3015.

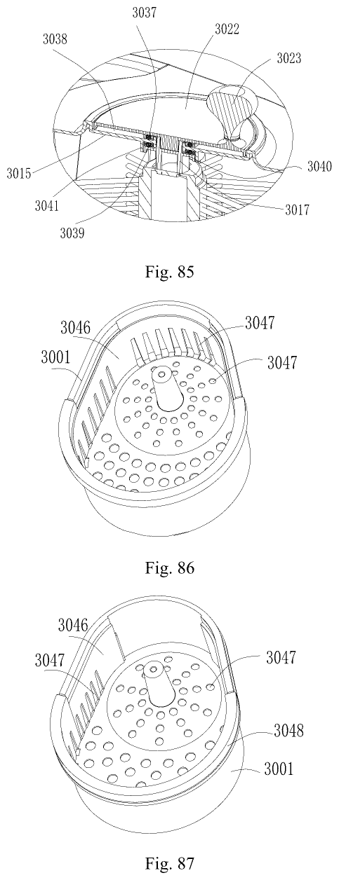

As illustrated in FIGS. 84 and 85, to better avoid friction, a plane bearing 3039 may be disposed between the connecting portion 3017 and the backside of the handle body 3022.

To make the mounted plane bearing 3037 more secure, in this example embodiment, the connecting portion 3017 has a shoulder 3040; on mounting, the plane bearing 3037 is first placed in the receiving groove 3038, and then the handle body 3022 is placed above the anti-splash cover 3015, followed by securely connecting (via a screw or other fitting elements) the connecting portion 3017 to the handle body 3022 from below the anti-splash cover 3015; after the assembly is complete, the shoulder 3040 of the connecting portion 3017 abuts against the backside of the anti-splash cover 3015, whereby the plane bearing 3037 is held between the anti-splash cover 3015 and the handle body 3022.

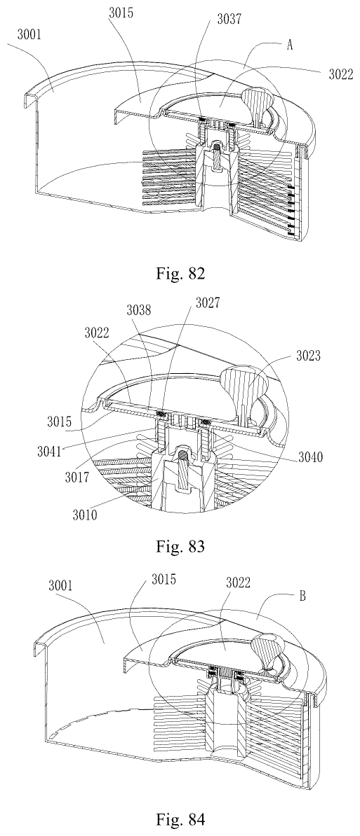

When the grip 3023 of the crank handle is gripped by hand to turn the crank handle, the crank handle likely sways. To prevent sway of the crank handle, a limiting mechanism for limiting sway of the handle crank may be provided on the supporting mechanism. As illustrated in FIGS. 82-85, the supporting mechanism refers to the anti-splash cover 3015, the limiting mechanism refers to a stop sleeve 3041 disposed on the anti-splash cover 3015, the connecting portion 3017 is adapted to the stop sleeve 3041, and the stop sleeve 3041 is sleeved outside the connecting portion 3017 to thereby limit the connecting portion 3017. In the case that the connecting portion 3017 takes on a form of shaft sleeve, the stop sleeve 3041 is sleeved outside the shaft sleeve. A stop sleeve 3051 may be provided at the front surface and the back surface of the anti-splash cover 3015, respectively, to limit the connecting portion 3017, whereby sway of the crank handle is better prevented.

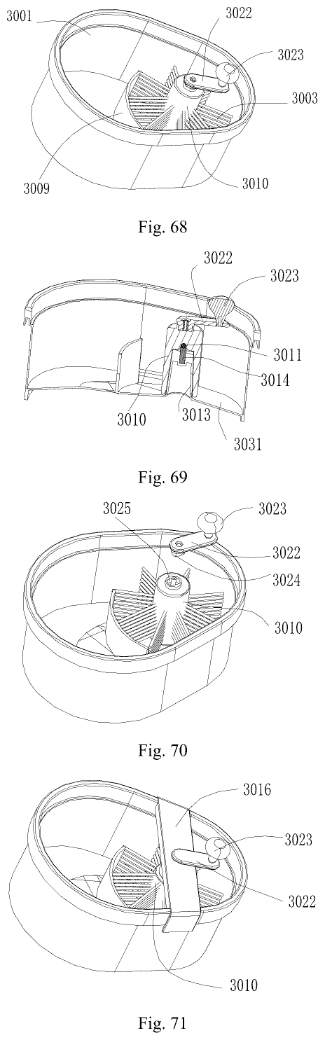

In FIGS. 68-70, no supporting mechanism for supporting the drive mechanism is provided, where the drive mechanism is directly connected to the rotary shaft, i.e., the drive mechanism is a manual drive mechanism in the form of crank handle. The crank handle comprises a handle body 3022, and a grip 3023 disposed on the handle body 3022; the handle body 3022 may have a disc shape, or have a strip or plate shape; the handle body 3022 has a drive block 3024, and a drive groove 3025 is provided on the driving rotary shaft 3010, such that by inserting the drive block 3024 into the drive groove, the crank handle may drive the scrubber rotary shaft 3010 to rotate; of course, the drive groove 3025 cannot take on a round form, but can take on a runway form or a square form; the form of the drive block 3024 is adapted to the drive groove 3025.

Of course, the detachable connection manner between the scrubber rotary shaft and the drive mechanism may also include: thread-fastening, screw-fastening, and gear-engaging between the rotary shaft and the output end of the drive mechanism.

A speed regulating mechanism may be disposed between the drive mechanism and the scrubber rotary shaft. The speed regulating mechanism may be a speed-up mechanism (e.g., a gear train speed-up mechanism, as shown in the figure). In the case that the speed regulating mechanism is a speed-up mechanism, the rotational speed of the rotary shaft may increase to enhance brushing efficiency.

The speed regulating mechanism may be a speed reduction mechanism (e.g., a gear train speed reduction mechanism), in which case the rotational speed of the scrubber rotary shaft may be decelerated to facilitate rotation of the scrubber.

The speed regulating mechanism may be a gearbox (which enables speed regulation by shifting gears to yield different gear outputs, thereby implementing speed regulation), in which case speed increase or speed reduction of the scrubber rotary shaft is performed dependent on actual use.

When the scrubber brushes the fruits/vegetables, the fruits/vegetables enter the brush washing zone 3005 between the brushing portion 3003 and a side surface of the container 3001. The position where the fruits/vegetables access the brush washing zone from between the brushing portion 3003 and a side surface of the container 3001 is referred to a fruits/vegetables inlet port; the fruits/vegetables, after entering the brush washing zone 3005 via the fruits/vegetables inlet port, sequentially pass through the brush washing zone 3005 and then flow out of the brush washing zone 3005 from between the brushing portion 3003 and the side surface of the container 3001; the position where the fruits/vegetables flowing out of the brush washing zone 3005 from between the brushing portion 3003 and a side surface of the container 3001 is referred to as a fruits/vegetables outlet port. Therefore, in the case that the scrubber 3002 comprises a scrubber rotary shaft and a brushing portion disposed on the scrubber rotary shaft, the space corresponding to the scrubber between the fruits/vegetables inlet port and the fruits/vegetables outlet port in the container, after deducting the space occupied by the scrubber, is referred to as the brush washing zone 3005, as shown in the right-side shadowed section of FIG. 100, while the opposite side of the container unoccupied by the scrubber is referred to as fruits/vegetables staging zone 3004. In addition, in an exceptional circumstance, there are always a few fruits/vegetables failing to access the brush washing zone 3005, but access the space outside the brush washing zone 3005 occupied by the scrubber 3002; this part of space may be referred to as an internal circulation zone 3042, where after the fruits/vegetables enter the internal circulation zone 3042, most of them would be pushed towards the fruits/vegetables inlet port from which they re-enter the brush washing zone 3005 to be brushed.

The scrubber 3002 is preferably proximal to one end of the container 1 to facilitate formation of circulation of the wash water and formation of circulation of the fruits/vegetables. A size relationship between the brush washing zone 3005 and the fruits/vegetables flowing and staging zone 3004 may be such that the volume of the brush washing zone 3005 is smaller than that of the fruits/vegetables flowing and staging zone 3004, such that more fruits/vegetables may be placed in the fruits/vegetables flowing and staging zone 3004, and meanwhile the fruits/vegetables in the brush washing zone 3005 may also be controlled within a certain extent, which ensures that the fruits/vegetables pass smoothly through the brush washing zone 3005 while preventing jam caused by excessive fruits/vegetables passing through the brush washing zone 3005.

When the scrubber 302 is rotating to bring the wash water to circulate, the wash water preferably flows along a sidewall formation direction of the container 3001 such that the flowing wash water does not obliquely impact the sidewalls of the container 3001, without causing dynamic loss of forward movement. Therefore, the axial direction of the scrubber rotary shaft 3010 is preferably substantially vertical to the horizontal plane. The “vertical” here refers to substantially vertical engineeringly, not absolutely vertical in the geometric sense; a reasonable angle falls within the concept of “vertical.” The scrubber rotary shaft 3010 is not absolutely vertical to the horizontal plane, and the rotating scrubber rotary shaft 3010 obliquely oriented may still bring the wash water in the container to flow in the circulation passage, with the flow direction of the wash water substantially along sidewalls of the container. In the case that the scrubber rotary shaft 3010 is not absolutely vertical to the horizontal plane, the scrubber rotary shaft 3010 and the crank handle may be connected in the following two manners: in one manner, a bevel gear is provided at an output end of the crank handle, a driven gear is provided on the scrubber rotary shaft, and the bevel gear is engaged with the driven gear, such that turning of the crank handle brings the scrubber to rotate, in which case the rotation axis of the output end of the crank handle is still parallel to the horizontal plane, offering a comfort manipulation when turning the crank handle; in the other manner, the crank handle is directly connected to the scrubber rotary shaft, in which case the rotation axis of the output end of the crank handle is coaxial with the scrubber rotary shaft, offering a simple and convenient installation but a somewhat inconvenience in manipulation.

The brushing portion 3003 comprises a plurality of columns of first flexible cleaning elements distributed along the axial direction of the rotary shaft, the first flexible cleaning elements referring to plastic flexible cleaning elements, or soft plastic flexible cleaning elements, or fabric strip flexible cleaning elements. The “distributed along the axial direction of the rotary shaft” refers to substantially distributing along the axial direction of the rotary shaft, which encompasses the scenarios of vertically or spirally disposing along the rotary shaft direction; such regular distribution manners may achieve a better cleaning effect. Of course, the first flexible cleaning elements may also be distributed in other irregular or regular manners. In the radio section of the scrubber, spacings between two adjacent columns of the first flexible cleaning elements are preferably substantially equal.

The first flexible cleaning elements are bendable upon touch. A first end of each first flexible brushing element is disposed on the scrubber rotary shaft 3010, while a second end thereof is a free end. When the fruits/vegetables pass through the brush washing zone 3005, the fruits/vegetables touch the first flexible cleaning elements, causing the first flexible cleaning elements bent, whereby the fruits/vegetables are brushed by the first flexible cleaning elements.

The first flexible cleaning elements are specifically formed as such: each column of the first flexible cleaning elements may be a column of monolithic flexible brushing element, e.g., a monolithic piece of plastic strip (e.g., nylon strip, TPR strip, etc.), a monolithic piece of soft plastic strip (e.g., silica gel strip, etc.), a monolithic piece of fabric strip, etc. The first flexible cleaning elements are preferably oriented to extend obliquely downward so as to better contact the washed fruits/vegetables during washing; in addition, the splash arising from agitation by the rotating scrubber will also be compressed by the obliquely, downward extending first flexible cleaning elements so as to reduce splashing-out of the water. Particularly, if a frustum 3031 is formed on the bottom surface of the container 3001 corresponding to the scrubber, on one hand, the obliquely, downward extending first flexible cleaning elements will press the fruits/vegetables downward, and on the other hand, the fruits/vegetables will flow outward along the frustum 3031, whereby flowing of the fruits/vegetables may be further facilitated.

Each column of first flexible cleaning elements may also be formed to comprise a plurality of rows of rod-shaped elements (the cross section of which may be round or square or of other shape), e.g., a plurality of plastic rods (e.g., nylon rods, TPR rods) which are arranged into a column of first flexible cleaning elements; or, a plurality of soft plastic rods (e.g., silica gel rods, etc.) which are arranged into a column of first flexible cleaning elements; or, a plurality of plastic filaments (e.g., nylon filaments, TPR filaments, etc.) form one piece of bristle brush and a plurality of pieces of bristle brushes are arranged into a column of first flexible cleaning elements; or, a plurality of soft plastic filaments (e.g., silica gel filaments, etc.) form one piece of soft bristle brush and a plurality of pieces of soft bristle brushes are arranged into a column of first soft brushing elements, etc. The rod-shaped elements may also take on a stripe or other shape, e.g., the helical shape in the figure.

After the scrubber 3002 is mounted on the container, a spacing between the brushing portion 3003 and a side surface of the container 3001 is preferably 0.5 mm-5 cm; in this case, without contact between the brushing portion 3003 and the side surface of the container 3001, the scrubber 3002 rotates more smoothly. Another option is that after the scrubber 3002 is mounted, the brushing portion 3003 contacts the side surface of the container 3001, whereby dirt deposited on the side surface of the container may be cleaned, which realizes self-cleaning of the bottom surface of the container.

As to distribution of the brushing portions 3003, a preferable option is that the brushing portions 3003 are substantially distributed in the vertical height direction of the brush washing zone 3005, such that all fruits/vegetables passing through the brush washing zone 3005 may be substantially brushed by the brushing portions, yielding a better cleaning effect.

As a more preferable setting, a wipe part 3026 is provided at an inner side surface of the container, where the wipe part 3026 may take on a form of a flexible cleaning element (e.g., plastic bristles, a plastic brushing column, a soft plastic strip, soft plastic bristles, and a flexible fabric strip, etc.), a protruding bar, or a protruding point, etc. As illustrated in FIG. 80, the wipe part 3026 is a bristle brush; in FIG. 81, the wiper part 3026 is a sponge. In the flow direction of the wash water, the wipe part may be provided in front of the scrubber 3002, or rear to the scrubber 3002, or directly facing the scrubber 3002; or, a wiper may be provided respectively in front of, rear to, and directly facing the scrubber 3002; or, a wiper is provided at two orientations of in front of, rear to, and directly facing the scrubber 3002. Provision of the wiper part 3026 has the following purposes: by providing the wipe part 3026 in front of the scrubber 3002, the fruits/vegetables are first wiped by the wipe part 3026 before entering the brush washing zone 3005; by providing the wipe part 3026 rear to the scrubber 3002, the fruits/vegetables are wiped again by the wipe part 3026 when flowing out of the brush washing zone 3005; by providing the wipe part 3026 directly facing the scrubber 3002, the fruits/vegetables are wiped and brushed by both of the brushing portion 3003 and the wipe part 3026 when flowing through the brush washing zone 3005. Therefore, with provision of the wipe part 3026, the fruits/vegetables may not only be brushed by the brushing portion 3003, but also may be wiped by the wipe part 3026, whereby a better cleaning effect is achieved. Of course, the wipe part 3026 may also be provided at two or three orientations of in front of, rear to, and directly facing the scrubber 3002.

The end of the brushing portion preferably contacts the wipe part 3026, such that the brushing portion can clean the wipe part 3026, which also facilitates tumbling of the being washed fruits/vegetables.

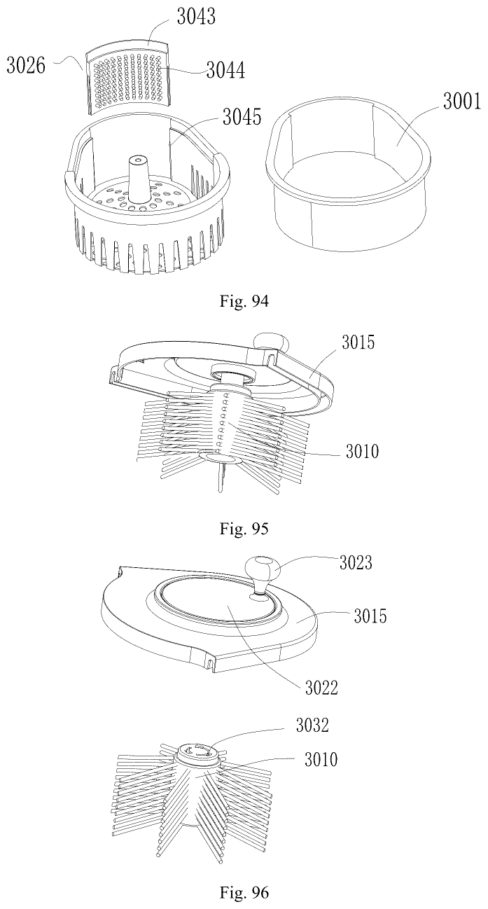

As illustrated in FIG. 93, the wipe part 3026 may be directly disposed on the container 3001; as illustrated in FIG. 94, the wipe part 3026 may also be configured such that the wipe part 3026 comprises a backplate 3043 and a third flexible cleaning element 3044 disposed on a side of the backplate 3043, the third flexible cleaning element 3044 being bendable upon touch; the third flexible cleaning element 3044 is preferably oriented to face the inner cavity of the container. The wipe part is detachably mounted on an inner sidewall of the container. A specific detachable connection manner may be such that a slide rail 3045 is provided at an inner wall of the container 3001, and the backplate 3043 slides into the slide rail.

In addition, a plurality of wipe parts 3026 may be provided, where third flexible cleaning elements of the plurality of wipe parts have different lengths, such that they can be mounted on the inner sidewall of the container alternatively, i.e., the wipe parts may be replaced with each so as to be adapted to the size of the to-be-washed fruits/vegetables.

A cleaning part may also be provided on the bottom surface of the container, where the cleaning part may take on a form such as protrusion point, soft plastic strip, or bristle brush, such that the flowing fruits/vegetables may also be wiped and cleaned by the cleaning part, whereby the fruits/vegetables are washed more cleanly.

Since there exists a gap between two adjacent columns of first flexible cleaning elements, smaller fruits/vegetables easily access between the two adjacent columns of first flexible cleaning elements, a consequence of which is that when the scrubber is rotating, the fruits/vegetables held between the two adjacent columns of first flexible cleaning elements are only rotating with the scrubber but cannot get through the first flexible cleaning elements, such that the fruits/vegetables cannot be brushed by the first flexible cleaning elements. Therefore, as illustrated in FIG. 77, the brushing portion 3003 may further comprise a plurality of columns of second flexible brushing elements 3027, each column of the second flexible brushing elements 3027 being disposed between two adjacent columns of first flexible cleaning elements 3028, where the height of the second flexible brushing elements 3027 is lower than that of the first flexible cleaning elements 3028 such that smaller fruits/vegetables will not get deeply between the two adjacent columns of first flexible cleaning elements 3028 and thus can be brushed by the second flexible brushing elements 3027 and/or first flexible cleaning elements 3028. The material, distribution, and structure of the second flexible brushing 3027 elements may refer to those of the first flexible cleaning elements 3028 as described above.

One or more columns of the second flexible brushing elements 3027 may be disposed between two adjacent columns of first flexible cleaning elements 3028.

Driven by the circulation-driving mechanism, the wash water mainly circulates along wall surfaces of the container; therefore, a dead water zone (where the wash water substantially stands still) likely exists between the parallel arranged brush washing zone 3005 and fruits/vegetables flowing and staging zone 3004; once the fruits/vegetables enter the dead water zone, they cannot circulate with the circulating wash water and thus cannot be brushed by the scrubber. To solve this problem, a baffle part 3009 is optionally provided in the container 3001, where the circulation passage extends surrounding the baffle part 3009. The baffle part 3009 may substantially eliminate the dead water zone; even not completely eliminating the dead water zone, the baffle part 3009 may at least significantly reduce the extent of the dead water zone. Generally, the height of the baffle plate 3009 should be greater than or equal to ⅕ of the height of the container 1. It is preferred that the baffle part 3009 has an arc surface facing and protruding above the fruits/vegetables flowing and staging zone, which may not only further reduce the extent of the dead water zone, but also may urge the flowing fruits/vegetables outward to prevent stranding of the fruits/vegetables.

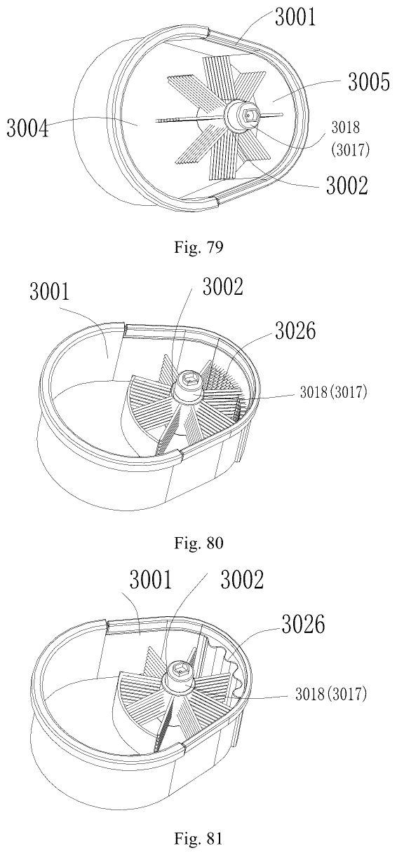

The baffle part 3009 may be generally provided as a baffle plate as illustrated in FIG. 78; of course, the baffle block illustrated in FIG. 74 may also be adopted. It is understood that the baffle part may also take on other forms. Of course, as illustrated in FIG. 79, even without provision of the baffle plate, the scope of the disclosure is not affected; but it likely occurs that the fruits/vegetables would dwell in the dead water zone and thus cannot be efficiently cleaned.

The baffle part 3009 may be separately formed from the container 3001 or may be one-piece formed with the container 3001. In the case that the baffle part 3009 and the container 3001 are separately formed, the baffle part 3009 and the container 3001 may be secured via a snap. Of course, they may also be secured via a screw; or, a guide rail is provided on the container, such that the baffle part is inserted into the guide rail so as to be fixed. This detachable connection manner enables detachment of the baffle part 3009 to increase the capacity inside the container; the container itself may be used as a washing container for other purposes. FIGS. 74 and 75 illustrates an example detachable connection manner, where a slide rail groove 3029 is provided at the bottom surface of the baffle part 3009 and a slide rail is provided at the bottom of the container 3001; to mount the baffle part 3009, the slide rail simply slides into the slide rail groove 3029. Or, a socket is provided at the lower end of the baffle part, and an insert-fitting column is provided on the bottom surface of the container, such that the insert-fitting column is inserted into the socket. Alternative manners of mounting the baffle part 3009 may comprise: inserting a clamp protrusion provided at the lower portion of the baffle part into a slot provided in a recessed groove on the bottom of the container, whereby the baffle part is mounted; or, applying a screw rod to connect the baffle part and the container, where the screw rod penetrates into the baffle part through the container, and to achieve this, a penetration may be provided in the baffle part to penetrate into the screw rod. In the case that the baffle part 3009 and the container 3001 are one-piece formed, a preferred forming manner comprises: forming a hollow raised portion at the bottom surface of the container 3001, which is easily formed, where the raised portion acts as the baffle part 3009.

As noted above, although provision of the baffle part 3009 may eliminate the dead water zone to a certain extent, it cannot fully eliminate the impact of dead water zone, or the flow rate of the wash water proximal to the baffle part 3009 is still lower than that in the periphery of the container, such that the fruits/vegetables proximal to the baffle part 3009 are still likely stranded around the baffle part 3009; therefore, a slope 3030 may be provided at the interface between the baffle part 3009 and the bottom surface of the container 3001, where the slope 3030 tilts outwardly from the baffle part 3009 from top to down; in this way, the fruits/vegetables at the interface between the baffle part 3009 and the container 3001 flow outward along the slope and re-enter the wash water with a relatively high flow rate.

In the case that the baffle part 3009 is provided, a fruits/vegetables inlet port is formed between the downstream end of the baffle part 3009 and a sidewall of the container in the wash water flow direction. To prevent jam of the fruits/vegetables at the fruits/vegetables inlet port, an inwardly shrunk guide surface is provided at the downstream end of the baffle part 3009 so as to form a relatively wide fruits/vegetables guide opening between the guide surface and the sidewall of the container.

Another measure for preventing jam of the fruits/vegetables is that the scrubber rotary shaft 3010 is disposed on the container in a bi-directionally rotatable manner, i.e., the scrubber rotary shaft 3010 may rotate clockwise or counterclockwise, where no unidirectional mechanism is provided between the scrubber rotary shaft 3010 and the container. The scrubber rotary shafts 3010 with settings described above are all bidirectionally rotatable. With the bidirectional rotation design of the scrubber rotary shaft 3010, once the fruits/vegetables are jammed in the container 3001, the scrubber rotary shaft 300 may rotate reversely, bringing the scrubber 3002 to rotate reversely, whereby the wash water flows reversely to disperse the jammed fruits/vegetables, clearing jam of the fruits/vegetables.

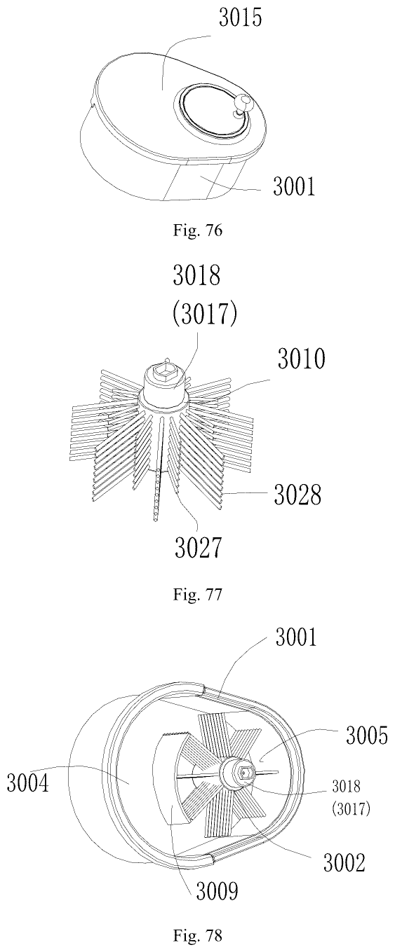

Since the wash water in the container 3001 is likely spun out to cause splash of the wash water while the scrubber 3002 is rotating. Therefore, an anti-splash cover 3015 may be provided to fit over the brush washing zone 3005, where the anti-splash cover 3015 is generally mounted on the container 3001 to prevent the wash water from being spun out. The anti-splash cover is generally made of plastic, preferably transparent plastic so as to observe the washing status in the brush washing zone 3005. The anti-splash cover 3015 may only cover the brush washing zone, or may cover an area beyond the brush washing zone 3005 so as to close the upper end opening of the container 3001, as illustrated in FIG. 76, whereby a better splash-baffling effect is achieved. The anti-splash cover 3015 is generally provided to fit over the container 3001, and a detachable connection, preferably snap-fitting, is usually applied between the container 3001 and the anti-splash cover 3015, for example, a snap hook being provided on the anti-splash cover 3015 and snapped to the upper edge of the container 3001. Another manner of mounting is that the anti-splash cover 3015 is directly propped up in the container 3001, without other connection relationship with the container 3001; in this case, to operate the fruit and vegetable washing apparatus according to the disclosure, it is needed to press a hand on the anti-splash cover 3015, while to prevent displacement of the anti-splash cover 3015, the anti-splash cover 3015 may be flanged, where the flange is fitted to the outer edge of the container 3001, so that displacement of the anti-splash cover 3015 may be prevented.

With the detachable connection manner between the anti-splash cover 3015 and the container 3001 and by directly propping up the anti-splash cover 3015 on the container 3001, the anti-splash cover 3015 is detachable; in this case, the anti-splash cover 3015 may take on such a form that it may be placed in the container 3001 when being removed, as illustrated in FIG. 102, whereby an objective of shrinking its packaging size is achieved. Particularly, in the case that the crank handle is supported on the anti-splash cover 3015, since the grip 3023 protrudes on the anti-splash cover, the removed anti-splash cover 3015 may be placed into the container 3001 in such a manner that the backside of the anti-splash cover 3015 faces upward; in this way, the grip 3023 is also accommodated in the container, which further reduces the packaging size and also prevents the grip 3023 from being broken during transportation.

To further suppress splashing of the wash water, a water baffle mechanism may be provided between the anti-splash cover 3015 and the container 3001 so as to block the water spun out by the brushing portion 3003, thereby preventing the water spun out by the brushing portion 3003 from leaking out of the container. A specific structural form of the water baffle mechanism may be such that the water baffle mechanism comprises an anti-splash groove provided on an upper end surface of the container 3015 and an anti-splash rib disposed on the anti-splash cover 3015, whereby when the anti-splash cover 3015 covers the brush washing zone, the anti-splash rib provided on the anti-splash cover 3015 can be inserted into the anti-splash groove; or, the water baffle mechanism comprises an anti-splash rib disposed on the upper end surface of the container 3001 and an anti-splash groove provided on the anti-splash cover 3015, whereby when the anti-splash cover 3015 covers the brush washing zone, the anti-splash rib can be inserted in the anti-splash groove. The anti-splash rib may baffle the wash water, and the anti-splash groove may receive the baffled wash water.

Another specific structural form of the water baffle mechanism may be such that the water baffle mechanism comprises a seal ring disposed between the anti-splash cover 3015 and the container 3001, where the seal ring enables water tightness, substantially eliminating splashing of the wash water.

The anti-splash cover 3015 and the container 3001 are generally detachably connected, such that removal of the anti-splash cover 3015 facilitates cleaning of the brush washing zone and replacement of the scrubber. Usually, the anti-splash cover 3015 is just propped up on the container 1; to further secure the propping, a detachable connection manner such as snap-fitting or screw-fastening may be adopted between the anti-splash cover 3015 and the container 3001.

With the anti-splash cover 3015 provided, the “baffle part” may also be disposed on the anti-splash cover 3015, i.e., a baffle plate is disposed on the anti-splash cover 30115; when the anti-splash cover 3015 covers the brush washing zone 3005, the baffle plate can project into the container 3001, whereby the circulation passage extends surrounding the baffle plate.

With the anti-splash cover 3015 provided, the drive mechanism may be supported on the anti-splash cover 3015, whereby the anti-splash cover 3015 forms the supporting mechanism for supporting the drive mechanism.

As a preferred structure, a water discharge port may be provided on a sidewall of the container 3001. After washing of the fruits/vegetables is complete, the wash water may be drained via the water discharge port, while the fruits/vegetables are retained in the container without falling out from the water discharge port.

As a preferred structure, a drain basket 3046 is provided in the container 3001, and drain holes 3047 are provided on the drain basket 3046, the scrubber 3002 being disposed in the drain basket 3046; of course, in this case, no drain holes are provided in the sidewalls and bottom of the container 3001. FIG. 86 illustrates that the drain basket 3046 is completely disposed in the container 3001; FIG. 87 illustrates that the upper edge of the drain basket 3046 is overlaid above the container 1, a common manner of which is that the upper end of the drain basket 3046 has a flange 3048, the flange 3048 being supported by the upper end of the container 3001; in this case, the anti-splash cover 3015 may also be mounted on the drain basket 3046. On washing, the fruits/vegetables are held in the drain basket 3046, and after the washing is complete, it is only needed to lift up the drain basket 3046. For a detachable scrubber 3002, the scrubber 3002 is first removed, and then the drain basket 3046 is lifted up; for an undetachable scrubber, a notch corresponding to the scrubber 3002 needs to be provided on the bottom of the drain basket 3046. It is preferable that the bottom of the drain basket 3046 can substantially fit the bottom surface of the container 3001 so as to avoid spatial loss of the container 3001. The “substantially fit” means that the bottom of the drain basket 3046 can completely fit with the bottom surface of the container 3001 or only a very narrow gap is present therebetween.

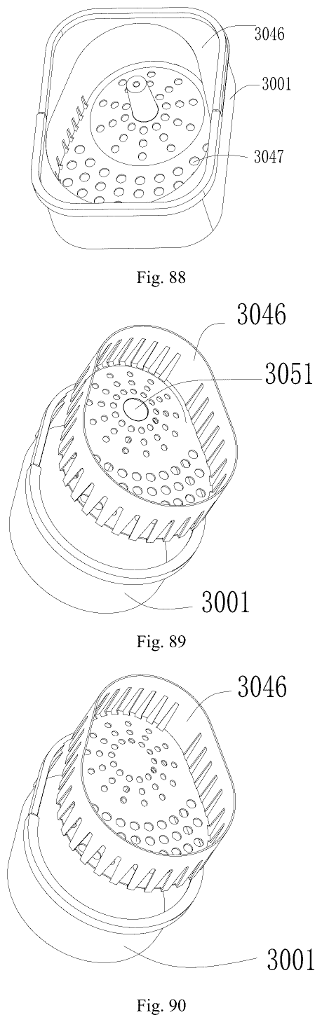

Another advantageous effect of the drain basket 3046 is such that the sidewalls and bottom of the drain basket 3046 form an outer contour of the circulation passage, as illustrated in FIG. 88, which ensures that the circulation passage formed during operation may facilitate circulation of the wash water and fruits/vegetables, such that the shape of the container 3001 may be designed flexibly, so as long it can accommodate the drain basket 3046. The container 3001 may be designed in various possibilities, for example, the shape of the drain basket 3046 may not be adapted to that of the container 3001, in which case the volume of the container 3001 may be designed to be relatively large so as to increase the water volume in the container 3001. Of course, the shape of the drain basket 3046 may also be adapted to that of the container 3001.

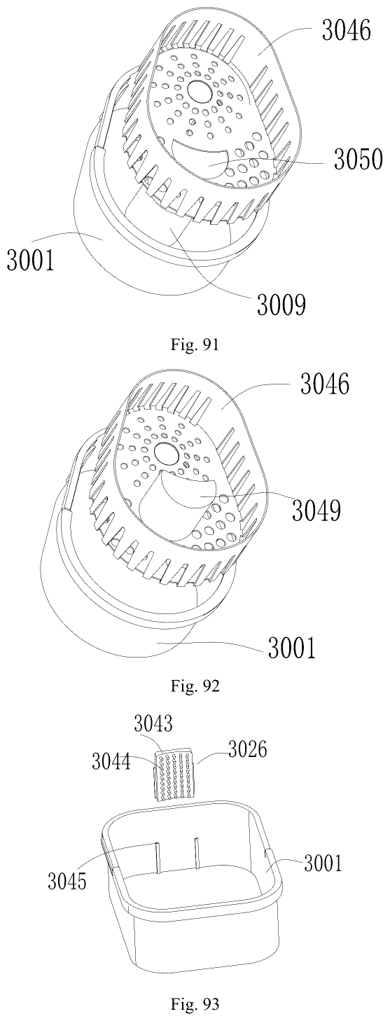

As illustrated in FIG. 92, with provision of the drain basket 3046, a partition part 3049 is provided on the drain basket 3046, the circulation passage surrounding the partition part 3049, where the partition part 3049 has a function equivalent to the baffle part 3009 noted above. As illustrated in FIG. 91, with provision of the baffle part 3009 in the container 3001, a baffle part notch 3050 corresponding to the baffle part 3009 needs to be provided on the drain basket 3046, a consequence of which is that when the drain basket 3046 is lifted up after washing of the fruits/vegetables is complete, some fruits/vegetables would fall out from the baffle part notch 3050. However, if the partition part 3079 is provided on the drain basket, there would be no need to provide a notch at the bottom of the drain basket 3046 corresponding to the baffle part, which prevents the fruits/vegetables from falling out via the notch when lifting up the drain basket 3046.

As illustrated in FIG. 89, with provision of the drain basket 3046, in the case that the scrubber rotary shaft 3010 is supported on the support shaft and the rotary shaft is detachable, a support shaft notch 3051 corresponding to the support shaft needs to be provided on the drain basket 3046, a consequence of which is that some fruits/vegetables would fall out via the support shaft notch 3051 when lifting up the drain basket 3046; as illustrated in FIG. 90, in the case that the scrubber rotary shaft 3010 is suspended on the supporting mechanism, a need to provide the support shaft notch corresponding to the support shaft on the drain basket 3046 would be eliminated.

With provision of the drain basket 3046, the wipe part 3026 noted above may also be disposed on a sidewall of the drain basket, which may refer to the manner of providing a wipe part on the container as previously described. The wipe part 3026 may be directly disposed on the drain basket 3046. The wipe part 3026 may also be configured such that the wipe part 3026 comprises a backplate 3043 and a third flexible cleaning element 3044 disposed on a side of the backplate 3043, the third flexible cleaning element 3044 being bendable upon touch; the third flexible cleaning element 3044 is preferably oriented to face the inner cavity of the container 3001. The wipe part is detachably mounted on an inner sidewall of the drain basket. A specific detachable connection manner may be such that a slide rail 3045 is provided at an inner wall of the drain basket, and the backplate 3043 slides into the slide rail.

With provision of the drain basket 3046, in the case that the wipe part 3026 is provided on the container, a through-hole needs to be provided on a side wall of the drain basket 3046 for the third flexible cleaning element 3044 to pass through.

### Example Embodiment 4

Referring to FIGS. 104-119, this example embodiment provides a fruits and vegetable washing apparatus, comprising a container 4001 for holding fruits/vegetables, a scrubber 4002, a manual drive mechanism 4003, and an anti-splash cover 4004 fitting over the container 4001.

The container 4001 is configured to hold fruits/vegetables and wash water, i.e., no drain holes are provided in the sidewalls and bottom of the container 4001. In use, the wash water may be filled in the container 4001. Of course, decorative holes, mounting holes, or a water discharge port, which do not affect the water holding function of the container 4001, may be provided on the upper edge of a sidewall of the container 4001; such holes/ports are also deemed as “no drain holes are provided in in the sidewalls and bottom of the container 4001.” Of course, drain holes may also be provided in the bottom wall or sidewalls of the container 4001, or the drain holes may also be provided in the bottom wall and sidewalls of the container 4001. In use, the container 4001 needs to be placed in wash water holding receptable, where the wash water is filled into the wash water holding receptacle, and the wash water enters the container 4001 via the drain holes such that the fruits/vegetables are soaked in the wash water. The shape of the wash water holding receptacle may be adapted to the container 4001 or not adapted to the container 4001. Optionally, the wash water holding receptacle may be a common household container such as a sink or a basin. Optionally, the wash water holding receptacle may also be an accessory mated to the container; in this case, the wash water holding receptacle is flexible in designing, i.e., it may be designed into various shapes, enriching designs of the fruit and vegetable washing apparatus to meet aesthetic appreciation of different users.

A drain basket 4032 may be provided in the container 4001, the drain basket 4032 being provided with drain holes, the scrubber 4002 being disposed in the drain basket 4032. Of course, in this case, no drain holes are provided in sidewalls and bottom of the container 4001. On washing, the fruits/vegetables are held in the drain basket 4032; after the washing is complete, the drain basket 4032 is simply lifted up.

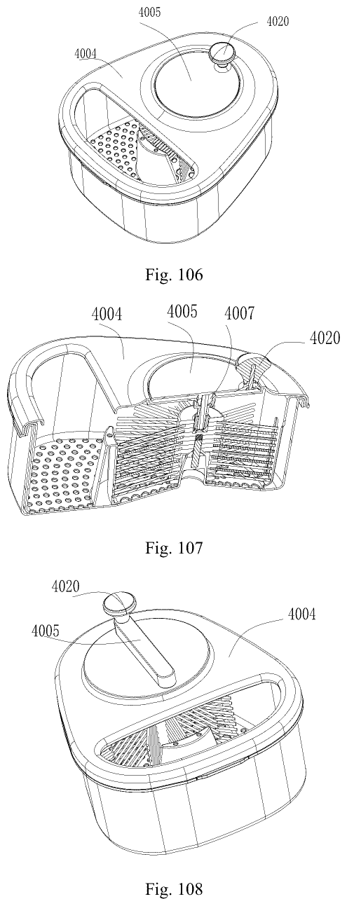

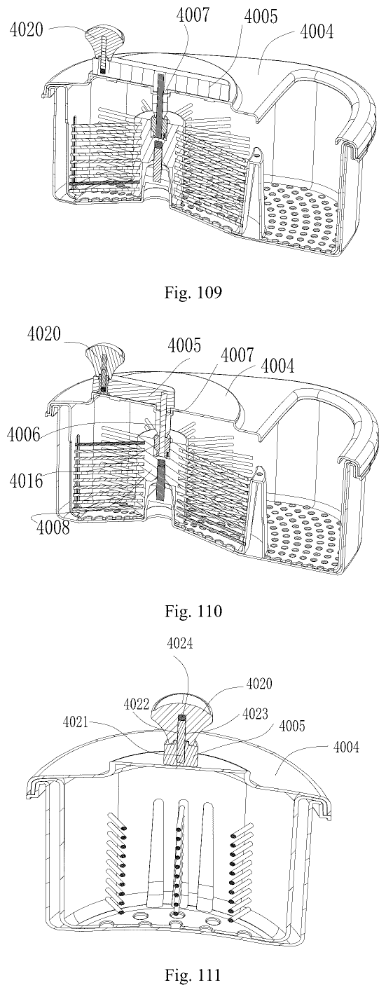

The manual drive mechanism comprises a crank handle, the crank handle comprising a handle body 4005 disposed outside the anti-splash cover 4004 and a crank handle rotary shaft 4066 vertically disposed, the handle body 4005 being disposed above the anti-splash cover 4004, the handle body 4005 comprising a connecting portion 4007, the crank handle rotary shaft 4006 being connected to the connecting portion 4007 of the handle body, a gap existing between the portion of the handle body 4005 other than the connecting portion 4007 and the anti-splash cover 4004, where the handle body 4005 is turned to bring the crank handle rotary shaft 4006 to rotate. Since there exists a gap between the handle body 4005 and the anti-splash cover 4004, the handle body 4005 is smoothly turned with a significant noise reduction. In FIGS. 104, 105, 108-119, the handle body 4005 is a transverse rod, which is illustrated relatively short in FIGS. 104, 105, and 110-119, where the connecting portion 4007 of the handle body is disposed at an inner end of the transverse rod, the crank handle rotary shaft 4006 being connected to the inner end of the transverse rod; in FIGS. 108 and 109, the transverse rod is relatively long, where the connecting portion 4007 of the handle body is disposed in the middle portion of the transverse beam, and the crank handle rotary shaft 4006 is disposed in the middle portion of the transverse beam; in FIGS. 106 and 107, the handle body 4005 has a disc shape, the crank handle rotary shaft 4006 being connected to the center of the disc-shaped handle body 4005.

The scrubber 4002 is disposed in the container 4001. The scrubber 4002 comprises a scrubber rotary shaft 4008 and a brushing portion 4009 disposed on the scrubber rotary shaft 4008. The scrubber 4002 is disposed in the container 4001 with the scrubber rotary shaft 4008 being vertically disposed, where the brushing portion 4009 extending towards a side surface of the container 4001. The “vertically disposed” manner of the scrubber rotary shaft refers to the scrubber rotary shaft 4008 being substantially vertically disposed so as to be substantially vertical to the horizontal plane, which does not require being absolutely vertical, and an appropriate inclination also falls within the scope of “being vertical.”

The crank handle rotary shaft 4006 is in drive-enabled connection to the scrubber rotary shaft 4008, where the “drive-enabled connection” means rotation of the crank handle rotary shaft 4006 may drive the scrubber rotary shaft 4007 to rotate, whereby the manual drive mechanism 4003 may drive the scrubber rotary shaft 4008 to bring rotation of the brushing portion 4009 to thereby brush the fruits/vegetables.

The scrubber 4002 may be mounted in such a manner that after the scrubber rotary shaft 4008 is connected to the crank handle rotary shaft 4006, the connecting portion 4007 of the handle body abuts against the anti-splash cover 4004, where the scrubber 4002 is suspended on the anti-splash cover 4004. In this case, the scrubber rotary shaft 4008 and the crank handle rotary shaft 4006 may be of an integral structure so as to implement that the scrubber 402 is suspended on the anti-splash cover. Of course, the scrubber rotary shaft 4008 and the crank handle rotary shaft 4006 may be of a separate structure, where the scrubber rotary shaft 4008 and the crank handle rotary shaft 4006 are securely connected so as to implement that the scrubber 4002 is suspended on the anti-splash cover 4004; in this case, the scrubber rotary shaft 4008 and the crank handle rotary shaft 4006 may be connected via snap-fitting, threaded-fastening, riveting, screw-fastening, and interference sleeve coupling, etc.

When the connecting portion 4007 of the handle body abuts against the anti-splash cover 4004, in order to form a gap between the portion of the handle body other than the connecting portion 4007 and the anti-splash cover 4004, the handle body 4005 is raised downwardly to form the connecting portion 4007. Since the connecting portion 4007 abuts against the anti-splash cover 4004, a gap is naturally formed between the portion of the handle body other than the connecting portion 4007 and the anti-splash cover 4004. Or, a boss protruding upward is provided on the anti-splash cover 4004, the boss being urged against the connecting portion of the handle body; in this case, a gap may also be formed between the portion of the handle body other than the connecting portion and the anti-splash cover.

The scrubber 4002 may also be mounted in such a manner that the scrubber rotary shaft 4008 is rotatably supported in the container 4001. The scrubber rotary shaft 4008 and the crank handle rotary shaft 4006 are of a separate structure, where the crank handle rotary shaft 4006 abuts against the upper end of the scrubber rotary shaft 4008 so as to limit the crank handle, and a gap is formed between the handle body 4007 and the anti-splash cover 4004; in this case, a gap is also formed between the connecting portion 4007 of the handle body and the anti-splash cover 4004. A specific structural form of the scrubber rotary shaft 4008 being rotatably supported in the container 4001 may be such that a support shaft 4010 is provided on the bottom surface of the container 4001, where the scrubber rotary shaft 4008 is sleeved outside the support shaft 4010 and supported on the support shaft 4010. To facilitate smooth rotation of the scrubber rotary shaft 4008 with less resistance, a first ball body 4011 is disposed between the support shaft 4010 and the scrubber rotary shaft 4008, where the first ball body 4011 may be specifically disposed such that an abutting base 4012 is provided in the scrubber rotary shaft 4008, the first ball body 4011 being disposed between the upper end of the support shaft 4010 and the abutting base 4012. To position the first ball body 4011 more securely and prevent escaping of the first ball body 4011, an extending post 4013 is provided at the upper end of the support shaft 4010, the extending post 4013 projecting into the abutting base 4012, where the first ball body 4011 is disposed between the upper end of the extending post 4013 and the abutting base 4012.

The crank handle rotary shaft 4006 abuts against the upper end of the scrubber rotary shaft 4008 in such a manner that an abutting portion 4014, which is provided at the lower end of the crank handle rotary shaft 4006, abuts against the upper end face of the scrubber rotary shaft 4008. The abutting portion 4014 may refer to a lower end surface of the crank handle rotary shaft 4006; optionally, the abutting portion 4014 may protrude from a side portion of the crank handle rotary shaft 4006. In this case, the abutting portion 4014 may be formed as the lower end surface of the crank handle rotary shaft 4006 itself or formed by protrusion a side portion of the crank handle rotary shaft 4006; in addition, the abutting portion 4014 may be formed in such a manner that the abutting portion 4014 may be formed at the lower end of an adapter sleeve sleeved over the lower end of the crank handle rotary shaft 4006, where in the case that a ring-shaped protrusion is provided on the adapter sleeve, the ring-shaped protrusion forms the abutting portion.

To enable the crank handle rotary shaft 4006 to drive the scrubber rotary shaft 4008, a driving protrusion rib may be provided at a lower surface of the abutting portion, and a driven protrusion rib may be provided on an upper end surface of the scrubber rotary shaft, where the crank handle rotates to bring the driving protrusion rib to abut against the driven protrusion rib, thereby bringing the scrubber rotary shaft to rotate.

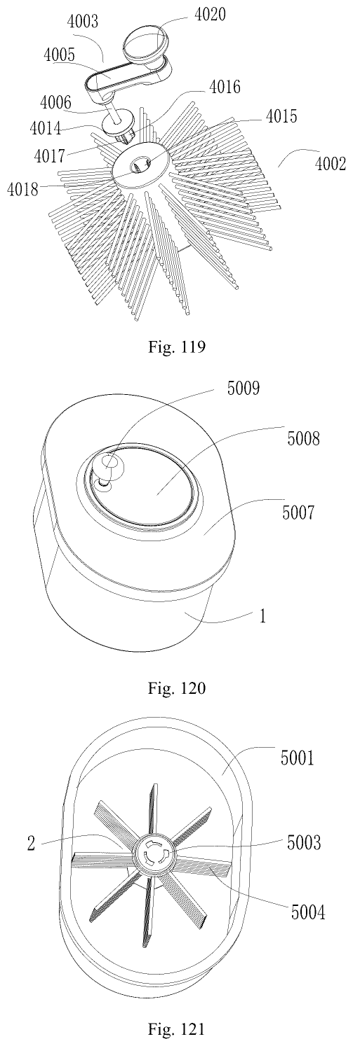

Another manner for the crank handle rotary shaft 4006 abutting against the upper end of the scrubber rotary shaft 4008 may be such that a recessed groove 4015 is provided at the upper end of the scrubber rotary shaft 4010, and a connecting head 4016 is provided at the lower end of the crank handle rotary shaft 4006, where the connecting head 4016 abuts against the bottom of the recessed groove 4015. As illustrated in FIG. 119, to enable the crank handle rotary shaft 4006 to drive the scrubber rotary shaft 4008, a driving protrusion rib 4017 is provided on the connecting head 4016, and a driven protrusion rib 4018 is provided in the recessed groove 4015, where the crank handle rotates to cause the driving protrusion rib 4017 to abut against the driven protrusion rib 4018, thereby bringing the scrubber rotary shaft 4008 to rotate; the driving protrusion rib 4017 is generally provided on a sidewall of the connecting head 4016, and the driven protrusion rib 4018 is generally provided on an inner sidewall of the recessed groove 4015.

The brusher may also be mounted in such a manner that after the scrubber rotary shaft and the crank rotary shaft are connected, the brusher is suspended on the anti-splash cover. Meanwhile, the scrubber rotary shaft and the crank handle rotary shaft are of a separate structure, where the crank handle rotary shaft abuts against the upper end of the scrubber rotary shaft so as to limit the crank handle, and a gap is formed between the handle body and the anti-splash cover. That is, the scrubber is suspended on the anti-splash cover, and meanwhile the crank handle rotary shaft also abuts against the scrubber rotary shaft. The specific implementation manner may be identical to the example embodiments described previously, which will not be detailed here.

As a preferred structure, a stopper sleeve 4019 is provided on the anti-splash cover 4004; in the case that the crank handle rotary shaft 4006 and the scrubber rotary shaft 4008 are of a separate structure, the crank handle rotary shaft 4006 pass downwardly through the stopper sleeve 4019 and is then connected to the scrubber rotary shaft 4008, i.e., the crank handle rotary shaft 4006 can be at least partially accommodated in the stopper sleeve 4019, such that the crank handle rotary shaft 4006, after passing through the stopper sleeve 4019, is limited by the stopper sleeve 4019, whereby the crank handle, when being turned, does not sway or only sways in a limited extent. The stopper sleeve 4019 is generally provided on the lower surface of the anti-splash cover 4004. In the case that the crank handle rotary shaft 4006 and the scrubber rotary shaft 4008 are of an integral structure, it may also be deemed that the scrubber rotary shaft 4008 is at least partially disposed in the stopper sleeve 4019. Generally, the stopper sleeve 4019 protrudes on the lower surface of the anti-splash cover 4004; of course, it is also possible that the stopper sleeve 4019 protrudes on the upper surface of the anti-splash cover 4004.

A grip 4020 configured to be gripped by hand is provided on the handle body 4005, such that the grip 4020 is gripped by hand to turn the handle body, which facilitates manipulation. Of course, in the case that no grip is provided, the handle body may be turned by turning the handle body.

The grip 4040 may be secured on the handle body 4005 or is rotatably disposed above the handle body 4005. It is preferrable that the grip 4020 is rotatably disposed on the handle 4005, so as to offer a comfortable manipulation when the grip 4020 is gripped by hand to turn the handle body. In an example implementation, the grip 4020 is rotatably connected to the handle body 4005 in such a specific manner that a grip rotary shaft 40201 is provided on the grip 4020, and the grip rotary shaft 4021 is parallel to a crank handle rotary shaft 4006, the grip rotary shaft 4021 and the crank handle rotary shaft 4006 being disposed on the handle body 4005 with an interval; generally, the grip rotary shaft 4021 is disposed at the outer end of the handle body 4005. The grip rotary shaft 4021 penetrates into the handle body 4005, such that the grip 4020 rotates about the grip handle rotary shaft 4021 as the axis; the grip rotary shaft 4021 is axially disposed on the grip 4020, i.e., the grip rotary shaft 4021 is vertically disposed.

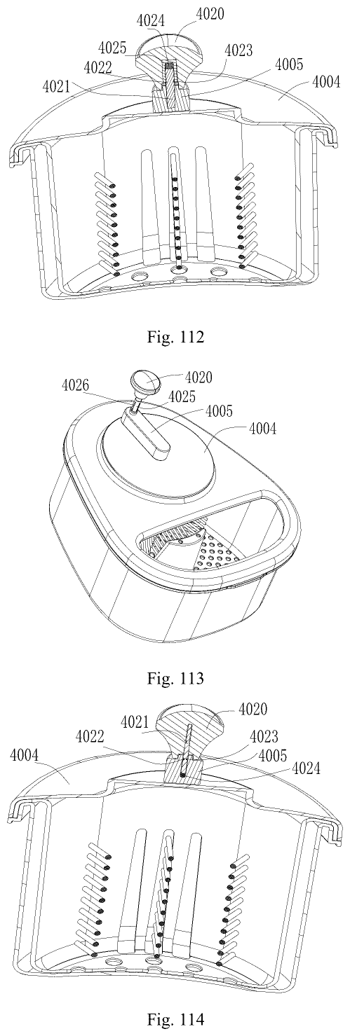

The grip rotary shaft 4021 and the handle body 4005 may be fixed with each other, or the grip rotary shaft 4021 and the grip 4020 may be rotatable relative to each other. As illustrated in FIG. 111, a lower portion of the grip rotary shaft 4021 is inserted into the handle body 4005 and tightly fitted therewith, where a toothed pattern may be provided at the lower portion of the grip rotary shaft 4021, such that the grip rotary shaft 4021 and the handle body 4005 are securely engaged via the toothed pattern; the upper portion of the grip rotary shaft 4021 penetrates into the grip 4020 which is rotatable, and serves also to axially limit the grip 4020 from being disengaged from the grip rotary shaft 4021. In FIG. 111, the axial positioning of the grip 4020 is implemented as such: an axially positioning groove 4022 is provided on the grip rotary shaft 4021, and a protruding axially positioning shoulder 4023 is provided in the grip 4020, where the axially positioning shoulder 4023 is disposed in the axially positioning groove 4022. A second ball body 4024 may be further provided between the upper end of the grip rotary shaft 4021 and the grip 4020 so as to facilitate rotation of the grip. Or, as illustrated in FIGS. 112 and 113, the lower portion of the grip rotary shaft 4021 is inserted into the handle body 4005 and tightly fitted therewith, where a toothed pattern may be provided at the lower portion of the grip rotary shaft 4021, such that the grip rotary shaft 4021 and the handle body 4005 are securely engaged via the toothed pattern; a shaft sleeve 4025 is provided in the grip 4020, where the upper portion of the grip rotary shaft 4021 is inserted in the shaft sleeve 4025, and since the grip 4020 is rotatable, the shaft sleeve 4025 may also limit the grip 4020 axially, preventing the grip 4020 from being disengaged from the shaft sleeve 4025. In FIGS. 112 and 113, the axial positioning of the grip 4020 is implemented as such: an axially positioning groove 4022 is provided on the grip rotary shaft 4021, and a protruding axially positioning shoulder 4023 is provided in the shaft sleeve 4025, where the axially positioning shoulder 4023 is disposed in the axially positioning groove 4022. In FIGS. 112 and 113, the shaft sleeve 4025 is fixed in such a manner that a protrusion rib 4026 is provided on the outer side portion of the shaft sleeve 4025, and the shaft sleeve 4025 is inserted into the grip, whereby the shaft sleeve 4025 is secured via friction between the protrusion rib 4026 and the grip 4020; the protrusion rib 4026 is preferably axially disposed, and the upper end of the protrusion rib 4026 is preferably provided with a slope to facilitate insertion into the shaft sleeve 4025. A second ball body 4024 may also be provided between the upper end of the grip rotary shaft 4021 and the shaft sleeve 4025 so as to facilitate rotation of the grip 4020.

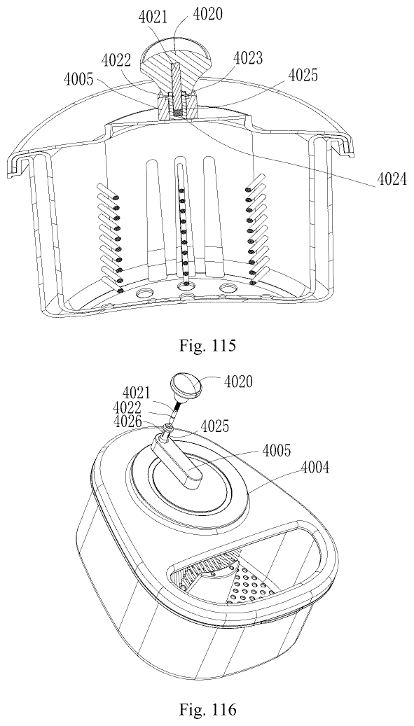

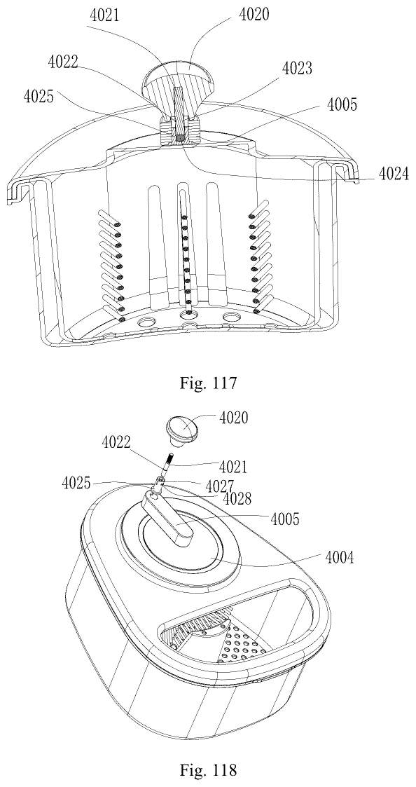

The grip rotary shaft 4021 and the grip 4020 may also be fixed with each other; and the grip rotary shaft 4021 and the handle body 4005 are rotatable relative to each other. As illustrated in FIG. 114, the upper portion of the grip rotary shaft 4021 is inserted into the grip 4020 so as to be tightly fitted therewith, where a toothed pattern may be provided at the upper portion of the grip rotary shaft 4021 such that the grip rotary shaft 4021 and the grip 4020 are securely engaged via the toothed pattern; the lower portion of the grip rotary shaft 4021 penetrates into the handle body 4005 and the grip rotary shaft 4021 is rotatable, whereby the grip rotary shaft 4021 is axially limited from being disengaged. In FIG. 114, the axial positioning of the grip rotary shaft 4021 is implemented as such: an axially positioning groove 4022 is provided on the grip rotary shaft 4021, and a protruding axially positioning shoulder 4023 is provided in the grip 4020, where the axially positioning shoulder 4023 is disposed in the axially positioning groove 4022. A second ball body 4024 may be further provided between the lower end of the grip rotary shaft 4021 and the handle body 4005 so as to facilitate rotation of the grip 4020. Or, as illustrated in FIGS. 12, 13, 14, and 15, the upper portion of the grip rotary shaft 21 is inserted into grip 20 and tightly fitted therewith, where a toothed pattern may be provided at the upper portion of the grip rotary shaft 21, such that the grip rotary shaft 21 and the grip 20 are securely engaged via the toothed pattern; a shaft sleeve 25 is provided in the handle 5, where the lower portion of the grip rotary shaft 21 is inserted in the shaft sleeve 25, and since the grip rotary shaft 21 is rotatable, the grip rotary shaft 21 may also be limited axially, preventing the grip rotary shaft from being disengaged. In FIGS. 115, 116, 117 and 118, the axial positioning of the grip rotary shaft 4021 is implemented as such: an axially positioning groove 4022 is provided on the grip rotary shaft 4021, and a protruding axially positioning shoulder 4023 is provided in the shaft sleeve 4025, where the axially positioning shoulder 4023 is disposed in the axially positioning groove 4022. In FIGS. 115 and 116, the shaft sleeve 4025 is fixed in such a manner that a protrusion rib 4026 is provided on the outer side portion of the shaft sleeve 4025, and the shaft sleeve 4025 is inserted into the handle body 4005, whereby the shaft sleeve 4025 is secured via friction between the protrusion rib 4026 and the handle body 4005; the protrusion rib 4026 is preferably axially disposed, and the lower end of the protrusion rib 4026 is preferably provided with a slope to facilitate insertion into the shaft sleeve 4025. In FIGS. 117 and 118, the shaft sleeve 4025 is fixed in such a manner that a crevice is provided on a sidewall of the shaft sleeve 4025 such that a flexible flap 4027 is formed at the upper portion of the shaft sleeve 4025, where a snap 4028 is provided at an outer side of the flexible flap 4027, and a mount is provided in the handle body 4005, such that after the shaft sleeve 4025 is inserted into the handle body 4005, the snap 4028 is snapped into the mount, whereby the shaft sleeve 4025 is secured. A second ball body 4024 may also be provided between the upper end of the grip rotary shaft 4021 and the shaft sleeve 4025 so as to facilitate rotation of the grip 4020.

A circulation passage is formed in the container 4001, which, on washing fruits/vegetables, can provide a passageway for the wash water and the fruits/vegetables to circulate; on washing the fruits/vegetables, the brushing portion rotates to provide a driving force so as to drive the wash water to flow, where the flowing wash water carries the fruits/vegetables to circulate in the circulation passage, whereby the fruits/vegetables are brushed by a brushing portion 4009, yielding a better brushing effect. The circulation passage comprises a fruits/vegetables flowing and staging zone 4029 and a brush washing zone 4030 which are in communication, where a scrubber 4002 is disposed in the brush washing zone 4030 such that the fruits/vegetables can sequentially pass through the brush washing zone 4030 from between the brushing portion 4009 and a side surface of the container 4001 so as to be brushed by the brushing portion 4009. The volume of the brush washing zone 4030 is generally smaller than that of the fruits/vegetables flowing and staging zone 4029, or the scrubber 4002 is disposed proximal to one end of the container 4001.

As a preferable structural form, the fruit and vegetable washing apparatus further comprises a baffle part 4031, the baffle part 4031 being disposed in the container 4001, the circulation passage surrounding the baffle part 4031. The baffle part 4031 mainly serves to eliminate a dead water zone of the wash water circulating in the container; with elimination of the dead water zone, the fruits/vegetables will not be stranded and may circulate smoothly. In the case that a drain basket 4032 is provided, the baffle part 4031 is disposed on the drain basket 4031. If the baffle plate 4031 is provided on the drain basket, no baffle part is provided on the container, such that no notch for an inexistent baffle part on the container to pass through is necessarily provided on the drain basket 4031; in this case, no fruits/vegetables would fall out via the inexistent notch after the drain basket 4032 is lifted up.

The brushing portion 4009 may comprise a plurality of columns of flexible brushing elements, the flexible brushing elements being bendable upon touch, where a first end of each flexible cleaning element is disposed on the scrubber rotary shaft, and a second thereof is a free end. The flexible cleaning element may refer to brush bristles or soft plastic filaments, etc. Of course, the flexible cleaning element may also be a soft plastic sheet, etc.

The implementation manners of the manual drive mechanism and the connecting and fitting manners between the manual drive mechanism and the scrubber, as described in this example embodiment, may also be applied in Example Embodiment 3.

### Example Embodiment 5

FIGS. 120-130 illustrate a fruit and vegetable washing apparatus, comprising a container 5001 and a scrubber 5002 disposed in the container 5001, where the scrubber 5002 comprises a scrubber rotary shaft 5003 and a brushing portion 504 disposed on the scrubber rotary shaft 5003, the scrubber rotary shaft 5003 being vertically disposed in the container 5001; the brushing portion 5004 extends towards at least an inner sidewall of the container 5001, an end portion of the scrubber 5004 is at least proximal to two inner sidewalls of the container 5001, forming a plurality of pairs of fruits/vegetables flowing and staging zones 5005 and brush washing zones 5006, the fruits/vegetables flowing and staging zones 5005 being in communication with the brush washing zones 5006, such that a circulation passage for wash water and the fruits/vegetables to circulate during washing the fruits/vegetables is provided.

The fruit and vegetable washing apparatus further comprises a drive mechanism, the drive mechanism being connected to the scrubber rotary shaft 5003 so as to drive the scrubber 5002 to rotate.

A circulation-driving mechanism is formed in the scrubber, where the rotating scrubber 5002 is configured to provide a driving force such that the wash water can be driven to flow on washing fruits/vegetables, where the flowing wash water carries the fruits/vegetables to circulate in the container 5001, and the fruits/vegetables pass from between the scrubber 5004 and the inner sidewall of the container 5001 proximal to an end portion of the scrubber, whereby the fruits/vegetables are brush washed by the scrubber 5004.

In use, the fruits/vegetables are fed into the container, and the rotating scrubber 5002 brings the wash water and the fruits/vegetables to flow; when the fruits/vegetables are circulating in the circulation passage, they pass from between the scrubber 5004 and the inner sidewall of the container 5001 proximal to an end portion of the scrubber, whereby the fruits/vegetables are brush washed by the scrubber 5004.

Charging and discharging of the fruits generally occur in the fruits/vegetables flowing and staging zone 3004. After the fruits/vegetables are placed in the container 5001, the scrubber 5002 rotates to drive the wash water to carry the fruits/vegetables to flow from the fruits/vegetables flowing and staging zone 5005 to the brush washing zone 5006 and then flow back from the brush washing zone 5006 to the fruits/vegetables flowing and staging zone 5005; such back and forth circulation forms a circulation path featuring a journey from the fruits/vegetables flowing and staging zone to the brush washing zone and then back from the brush washing zone again to the fruits/vegetables flowing and staging zone; since circulation of the wash water can carry the fruits/vegetables to flow, the scrubber 5002 can repeatedly brush the fruits/vegetables flowing through the brush washing zone; soaking of the fruits/vegetables in the wash water may facilitate removal of the dirt on the surfaces of the fruits/vegetables; In the case that the fruits/vegetables flow at a speed different from that of the wash water, the wash water may flush the surfaces of the fruit/vegetable. It is noted that to increase the quantity of the washed fruits/vegetables, it is only needed to increase the capacity of the fruits/vegetables flowing and staging zone 5005 such that it can accommodate and soak more to-be-washed fruits/vegetables, without a need to vary the brush washing zone 5006 or the structure of the brush washing zone.

The brush washing zone 5006 and the fruits/vegetables flowing and staging zone 5005 are defined such that the fruits/vegetables enter the flushing zone from between the brushing portion 5004 and an inner sidewall of the container 5001; the position where the fruits/vegetables access the brush washing zone 5006 from between the brushing portion 5004 and an inner sidewall of the container 5001 is referred to a fruits/vegetables inlet port; the fruits/vegetables, after entering the brush washing zone 5006 via the fruits/vegetables inlet port, flow through the brush washing zone 5006 and then flow out the brush washing zone; the position where the fruits/vegetables flowing out of the brush washing zone 5006 from between the brushing portion 5004 and an inner sidewall of the container 5001 is referred to as a fruits/vegetables outlet port. The space corresponding to the scrubber 5002 between the fruits/vegetables inlet port and the fruits/vegetables outlet port in the container, after deducting the space occupied by the scrubber 5002, is referred to as the brush washing zone, as shown in the shadowed sections at two sides of FIG. 129, while a space unoccupied by the scrubber 5002 in the container is referred to as a fruits/vegetables staging zone 5005; therefore, in FIG. 129, the upper-side fruits/vegetables staging zone and the right-side brush washing zone form a fruits/vegetables flowing and staging zone—brush washing zone pair which are in communication, and the lower-side fruits/vegetables staging zone and the left-side brush washing zone form a fruits flowing and staging zone—brush washing zone pair which are in communication.

The container 5001 may be a water holding container; the container 5001 may also be a drain basket, where drain holes are provided in the bottom wall and/or sidewalls of the container 5001, in which case when the fruits/vegetables cleaning apparatus is in use, the container 5001 is placed in a water holding receptacle (e.g., a basin or a sink), and after washing of the fruits/vegetables is complete, the drain basket is lifted up with the water being drained.

In this example embodiment, a supporting mechanism is provided on the container 5001, where the drive mechanism is supported on the supporting mechanism; the supporting mechanism usually takes on a form of supporting plate 5007, in which case the supporting plate 5007 also serves as an anti-splash cover to prevent the water from splashing out when the scrubber 5002 is rotating. Of course, the supporting mechanism may not be provided; instead, the drive mechanism is directly connected onto the scrubber rotary shaft 5003, whereby the drive mechanism is supported by the scrubber rotary shaft 5003.

The drive mechanism may be an electric drive mechanism or a manual drive mechanism; the electric drive mechanism usually adopts a motor, where the output end of the motor is connected to the rotary shaft; and the manual drive mechanism usually takes on a form of crank handle.

In this example embodiment, the crank handle comprises a handle body 5008 and a grip 5009 disposed on the handle body 5008, where the scrubber rotary shaft 5003 is connected to the handle body 5008; the handle body 5008 usually takes on a disc shape; of course, other shapes of handle bodies such as strip shape may also be adopted.

In this example embodiment, a connecting portion 5010 is provided on the handle body 5008, the connecting portion 5010 being connected to the scrubber rotary shaft 5003, the handle body 5008 bringing the scrubber rotary shaft 5003 to rotate via the connecting portion 5010.

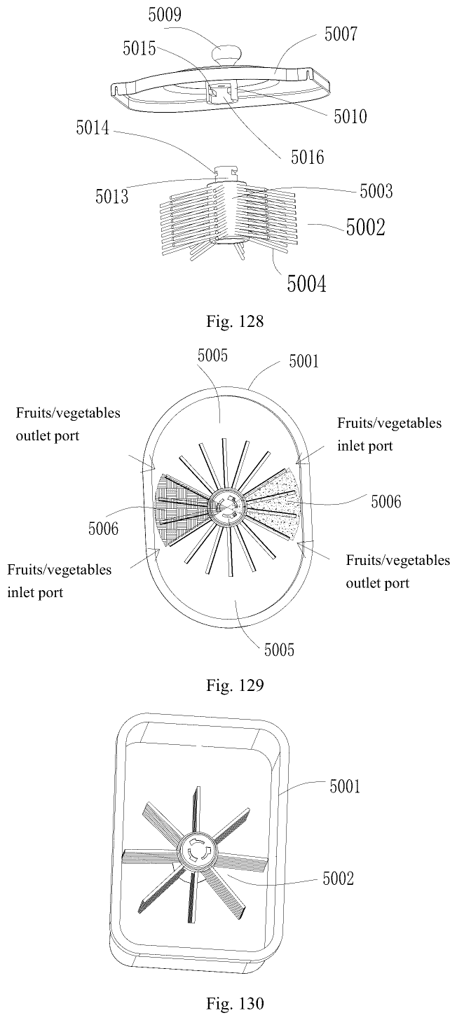

A connecting manner between the scrubber rotary shaft 4003 and the handle body 5008 is such that the scrubber rotary shaft 5003 is connected to the handle body 5008 and then suspended on the supporting plate. For example, the connecting portion on the handle body and the rotary shaft are integrally connected to implement suspending of the rotary shaft. The rotary shaft and the connecting portion on the handle body may be connected via a screw or other fixing element, which may also be connected in a detachable manner. For example, as illustrated in FIGS. 126-127, a snap hook 5001 is provided on the connecting portion 5010, and a mount 5012 is provided on the upper end of the scrubber rotary shaft 5003, where the snap hook 5011 is snapped into the mount 5012; the mount 5012 has a wide portion and a narrow portion, where the snap hook 5011 first accesses via the wide portion of the mount 5012, and after rotating a certain angle, the snap hook 5011 is positioned below the narrow portion of the mount 5012, whereby the positioning is achieved; or, as illustrated in FIG. 128, an insert-fitting stud 5013 is provided on the upper end of the scrubber rotary shaft 5003, the connecting portion 5010 is an insert-fitting sleeve, a slot 5014 is provided on the insert-fitting stud 5013, an insert-fitting block 5015 is provided in the insert-fitting sleeve, and a slide-in opening 5016 is provided on the insert-fitting sleeve, such that the insert-fitting stud 5013 slides into the insert-fitting sleeve via the slide-in opening 5016 and meanwhile the insert-fitting block 5015 slides into the insert-fitting sleeve 5014, thereby realizing tight fitting.

Another connecting manner between the scrubber rotary shaft 5003 and the handle body 5008 is such that a support shaft 5017 is provided in the container 5001, and the scrubber rotary shaft 5003 is sleeved over the support shaft 5017. A specific connecting manner may be such that a shaft stud 5018 is provided at the upper portion of the scrubber rotary shaft 5003, the connecting portion 5010 is a shaft sleeve, the shaft sleeve being sleeved over the shaft stud 5018; a driven protrusion rib 5019 is provided at an outer sidewall of the shaft stud 5018 and a driving protrusion rib 5020 is provided on an inner sidewall of the shaft sleeve, where the shaft sleeve rotates till the driving protrusion rib 5020 engages the driven protrusion rib 5019; in this way, the driving protrusion rib 5020 pushes the driven protrusion rib 5019 to implement rotation of the scrubber rotary shaft 5003. Or, a shaft sleeve is provided at the upper portion of the scrubber rotary shaft 5003, and the connecting portion 5010 has a shaft stud, the shaft sleeve being sleeved over the shaft stud, where a driving protrusion rib is provided at an outer sidewall of the shaft stud, and a driven protrusion rib is provided at an inner sidewall of the shaft sleeve, the shaft sleeve rotating to cause the driving protrusion rib to abut against the driven protrusion rib; in this way, the driving protrusion rib pushes the driven protrusion rib to implement rotation of the scrubber rotary shaft 5003.

When the manual drive mechanism takes on a form of crank handle, friction occurs between the handle body 5008 and the supporting plate 5007 when the crank handle is rotating, such that a friction reducing mechanism may be provided between the handle body 5008 and the supporting plate 5007 to reduce the friction therebetween. The friction reducing mechanism may be a rolling mechanism or a lubricating mechanism. The rolling mechanism may adopt a ball, preferably a plane bearing 5021. The lubricating mechanism may adopt a lubricating grease, etc. In addition, a gap may be provided between the handle body 5008 and the supporting plate 5007 to reduce friction therebetween.

In this example embodiment, a receiving groove 5022 is provided on the supporting plate 5007, and the plane bearing 5021 is disposed in the receiving groove 5022 to prevent displacement of the plane bearing 5021; meanwhile, the handle body 5008 may be disposed in the receiving groove 5022 such that the handle body 5008 is substantially in flush with the supporting plate 5007.

In the case that the manual drive mechanism takes on a form of crank handle, the crank handle likely sways when rotating; therefore, a limiting mechanism for limiting sway of the crank handle may be provided on the supporting plate 5007, facilitating smooth rotation of the crank handle. In this example embodiment, the limiting mechanism in this example embodiment comprises a stop sleeve 5023 adapted to the connecting portion 5010, where the stop sleeve 5023 is sleeved outside the connecting portion 5010, thereby limiting sway of the handle body 5008.

In this example embodiment, a frustum is formed on the bottom surface of the container 5001 corresponding to the scrubber 5002; in this way, during washing of the fruits/vegetables, the fruits/vegetables at the bottom will flow outward along the frustum, preventing jam of the fruits/vegetables at the bottom of the container 5001. A slope 5024 may also be provided at the bottom surface of the container 5001, the slope 5024 facing the scrubber 5002, whereby the fruits/vegetables may be relatively concentrated, preventing chaotically scattering of the fruits/vegetables.

In this example embodiment, the brushing portion 5002 comprises a plurality of columns of flexible cleaning elements; the flexible cleaning elements are bendable upon touching. A first end of the flexible cleaning element is disposed on the scrubber rotary shaft 5003, and a second end thereof is a free end. The flexible cleaning elements are preferably disposed to extend obliquely downwardly so as to better contact the to-be-washed fruits/vegetables during washing, and when the scrubber 5002 is rotating, the agitated splash will be suppressed by the obliquely downwardly extending flexible cleaning elements, whereby outward splashing of water is reduced. Particularly, with a frustum formed on the bottom surface of the container 5001 corresponding to the scrubber, on one hand, the obliquely downwardly extending flexible cleaning elements will compress the fruits/vegetables downward, and on the other hand, the fruits/vegetables flow outward along the frustum, further facilitating flowing of the fruits/vegetables.

In this example embodiment, the cross section of the container 5001 has a rectangular shape (FIG. 130) or a runway shape (FIG. 129); a pair of opposite sidewalls of the container proximal to an end portion of the brushing portion 5004 are referred to as a first pair of sidewalls, where the distances from the end portion of the scrubber 5004 to the two sidewalls of the first pair of sidewalls are substantially identical. A pair of opposite sidewalls of the container away from the end portion of the brushing portion 5004 are referred to as a second pair of sidewalls. On washing the fruits/vegetables, the fruits/vegetables sequentially pass from between the brushing portion 5004 and the inner sidewalls of the first pair of sidewalls. The cross section of the container 5001 is provided as a rectangular shape or a runway shape; on washing the fruits/vegetables, the fruits/vegetables sequentially pass from between the brushing portion 5004 and the inner sidewalls of the first pair of sidewalls, thereby achieving a better cleaning effect.

I/We claim:

1. A fruit and vegetable washing apparatus, comprising a container, a circulation-driving mechanism, and a scrubber;
wherein the container has a circulation passage formed therein, the circulation passage comprising a fruits/vegetables flowing and staging zone and a brush washing zone, wherein when washing fruits/vegetables, the circulation passage provides a passageway for wash water and the fruits/vegetables to circulate between the fruits/vegetables flowing and staging zone and the brush washing zone;
wherein the scrubber is disposed in the brush washing zone, and when washing the fruits/vegetables, the scrubber brushes the fruits/vegetables passing through the brush washing zone;
and wherein the circulation-driving mechanism is configured to provide a driving force which, when washing the fruits/vegetables, drives the wash water and the fruits/vegetables to circulate in the circulation passage, wherein the fruits/vegetables are brushed when sequentially passing through the brush washing zone.

2. The fruit and vegetable washing apparatus of claim 1, wherein the scrubber is rotatably disposed in the container, and the scrubber serves as the circulation-driving mechanism.

3. The fruit and vegetable washing apparatus of claim 2, wherein the scrubber comprises a scrubber rotary shaft and a brushing portion disposed on the scrubber rotary shaft.

4. The fruit and vegetable washing apparatus of claim 3, wherein the scrubber is disposed in the container with the scrubber rotary shaft being vertically disposed, the brushing portion extends in a direction away from the scrubber rotary shaft, wherein when washing fruits/vegetables, the fruits and vegetables sequentially pass through the brush washing zone between the brushing portion and a side wall of the container.

5. The fruit and vegetable washing apparatus of claim 4, wherein an internal side surface of the container is provided with a wipe part corresponding to the scrubber.

6. The fruit and vegetable washing apparatus of claim 4, wherein the scrubber is proximal to one end or one side of the container to facilitate circulation formulation of the wash water and circulation formulation of the fruits/vegetables.

7. The fruit and vegetable washing apparatus of claim 4, wherein the scrubber rotary shaft being connected to a drive mechanism driving the scrubber rotary shaft to rotate.

8. The fruit and vegetable washing apparatus of claim 7, wherein the drive mechanism is a crank handle, the crank handle comprising a handle body, the handle body is connected to a vertical crank handle rotary shaft, the crank handle rotary shaft is in drive-enabled connection to the scrubber rotary shaft.

9. The fruit and vegetable washing apparatus of claim 8, wherein the crank body is further provided with a grip.

10. The fruit and vegetable washing apparatus of claim 9, wherein the grip is rotatably disposed above the handle body.

11. The fruit and vegetable washing apparatus of claim 8, wherein the crank handle rotary shaft and the scrubber rotary shaft are arranged separately.

12. The fruit and vegetable washing apparatus of claim 11, wherein a support shaft is provided in the container, the scrubber rotary shaft is sleeved outside the support shaft, the scrubber rotary shaft is supported on the support shaft.

13. The fruit and vegetable washing apparatus of claim 12, wherein a ball body is provided between the support shaft and the scrubber rotary shaft.

14. The fruit and vegetable washing apparatus of claim 11, wherein a recessed groove is provided at the upper end of the scrubber rotary shaft, and a connecting head is provided at the lower end of the crank handle rotary shaft, one or more driving protrusion ribs are provided on the connecting head, one or more driven protrusion ribs are provided in the recessed groove, and the crank handle rotates to bring the driving protrusion rib to abut against the driven protrusion rib, thereby bringing the scrubber rotary shaft to rotate.

15. The fruit and vegetable washing apparatus of claim 14, wherein the driving protrusion rib is provided on a sidewall of the connecting head, and the driven protrusion rib is provided on an inner sidewall of the recessed groove.

16. The fruit and vegetable washing apparatus of claim 1, further comprising a baffle part, wherein the baffle part is disposed in the container, and the circulation passage surrounds the baffle part.

17. The fruit and vegetable washing apparatus of claim 4, wherein an anti-splash cover is provided on an upper cover of the brush washing zone.

18. The fruit and vegetable washing apparatus of claim 8, wherein an anti-splash cover is provided on an upper cover of the brush washing zone, the handle body is provided above the anti-splash cover, and the scrubber rotary shaft passes through the anti-splash cover.

19. The fruit and vegetable washing apparatus of claim 1, wherein a drain basket is provided in the container, the drain basket is provided with drain holes, and the scrubber is disposed in the drain basket.
